(19) United States
(12) Patent Application Publication
(10) Pub. No.: US 2017/0265465 A1
(43) Pub. Date: Sep. 21, 2017

(54) BIORATIONAL TREATMENT PRODUCTS AND METHODS OF USING SAME

(71) Applicant: Board of Trustees of Michigan State University, East Lansing, MI (US)

(72) Inventors: A. Ronald Detweiler, Okemos, MI (US); Joseph Vargas, East Lansing, MI (US)

(21) Appl. No.: 15/614,556

(22) Filed: Jun. 5, 2017

Related U.S. Application Data
(63) Continuation-in-part of application No. PCT/US2015/064104, filed on Dec. 4, 2015.
(60) Provisional application No. 62/088,480, filed on Dec. 5, 2014.

(51) Int. Cl. A01N 37/06; A01N 43/00; A01N 25/02; A01N 37/18; A01N 31/02; A01N 25/32

(52) U.S. Cl. CPC A01N 37/06; A01N 31/02; A01N 25/32; A01N 25/02; A01N 37/18; A01N 43/00; A01N 2300/00; C05C 9/00

(57) ABSTRACT

A composition is provided comprising an effective treatment amount of a biorational treatment concentrate comprising one or more plant oils and/or glycerol in combination with a carrier, and one or more colorants and/or one or more active ingredients, wherein the composition is formulated to treat a target crop. Related products and methods of using same are also provided.

This application is a continuation-in-part under 35 U.S.C. 111(a) of International Application No. PCT/US2015/64104, which application was filed on Dec. 4, 2015 and published in English as WO 2016/090314 on Jun. 9, 2016, which application claims the benefit of U.S. Provisional Application Ser. No. 62/088,480, filed on Dec. 5, 2014, which applications and publications are hereby incorporated by reference herein in their entireties.

### BACKGROUND

Agricultural and horticultural crops are known to need periodic treatments to remain in or be returned to the desired condition. One such crop, turfgrass, which is commonly found on golf courses and other athletic fields, typically requires extensive maintenance to ensure high quality playing conditions. Such maintenance includes treatments to repel, control, prevent or eliminate target pests, canopy moisture and/or frost, as well as treatments to maintain or improve crop health.

### SUMMARY

The embodiments described herein provide various biorational treatment concentrates and biorational treatment products (i.e., “biorational treatment concentrates and products”) comprising one or more plant oils and/or glycerol and at least one additive, in an amount effective for use as a bio-adjuvant or a biorational ingredient, such as a biostimulant. In various embodiments, the additive can comprise a colorant, a synthetic or commercially available active ingredient and/or a surfactant. The biorational treatment concentrates and products described herein are useful for treating target crops, i.e., for repelling, controlling, preventing and/or eliminating target pests and/or canopy moisture and/or frost, as well as stimulating, maintaining, enhancing and regulating crop qualities, such as growth, density, rooting and color intensity, either alone (optionally including a carrier or surfactant) and/or in combination with one or more commercially available active ingredients.

The biorational treatment concentrates and products described herein are more environmentally and applicator friendly than conventional crop treatment concentrates and crop treatment products (i.e., “crop treatment concentrates and products”) and allow for reductions in use rates of these conventional concentrates and products, while still providing comparable, or better results.

### BRIEF DESCRIPTION OF THE FIGURES

FIG. 1 is a photographic image of a bentgrass (Agrostis palustris) fairway showing (I) an untreated portion infected with dollar spot disease (Sclerotinia homeocarpa) (#28) and two treated portions four days after being treated in the manner described in Table 1 and Example 1 with (II) commercial fungicide only (hereinafter “fungicide”) (#1) and (III) a pre-mixed commercial fungicide and a biorational treatment concentrate containing canola oil/surfactant/pigment (hereinafter “fungicide/canola oil bio-adjuvant”) (#2), according to an embodiment.

FIG. 2 is a photographic image of a treated dollar spot infected bentgrass fairway showing three portions four days after being treated in the manner described in Table 1 and Example 1 with (I) fungicide (#1), (II) fungicide/canola oil bio-adjuvant (#2) and (III) canola oil-containing biorational treatment concentrate (hereinafter “canola oil concentrate”) (#3) according to various embodiments.

FIG. 3 is a photographic image of a treated dollar spot infected bentgrass fairway showing three portions four days after being treated in the manner described in Table 1 and Example 1 with (I) fungicide/canola oil bio-adjuvant (#5), (II) fungicide (#6) and (III) fungicide/canola oil bio-adjuvant (#7) according to various embodiments.

FIG. 4 is a photographic image of a treated dollar spot infected bentgrass fairway showing three portions four days after being treated in the manner described in Table 1 and Example 1 with (I) fungicide (#6), (II) fungicide/canola oil bio-adjuvant (#7) and (III) fungicide (#8) according to an embodiment.

FIG. 5 is a photographic image of a treated dollar spot infected bentgrass fairway showing three portions four days after being treated in the manner described in Table 1 and Example 1 with (I) fungicide/canola oil bio-adjuvant (#7), (II) fungicide (#8) and (III) fungicide/canola oil bio-adjuvant (#9) according to various embodiments.

FIG. 6 is a photographic image of a treated dollar spot infected bentgrass fairway showing three portions four days after being treated in the manner described in Table 1 and Example 1 with (I) fungicide (#8), (II) fungicide/canola oil bio-adjuvant (#9) and (III) fungicide (#10) according to an embodiment.

FIG. 7 is a photographic image of a treated dollar spot infected bentgrass fairway showing three portions four days after being treated in the manner described in Table 1 and Example 1 with (I) fungicide/canola oil bio-adjuvant (#9), (II) fungicide (#10) and (III) fungicide/canola oil bio-adjuvant (#2) according to various embodiments.

FIG. 8 is a photographic image of a treated dollar spot infected bentgrass fairway showing three portions four days after being treated in the manner described in Table 1 and Example 1 with (I) fungicide (#12), (II) fungicide/canola oil bio-adjuvant (#11) and (III) fungicide/canola oil bio-adjuvant (#20) according to various embodiments.

FIG. 9 is a photographic image of a treated dollar spot infected bentgrass fairway showing three portions four days after being treated in the manner described in Table 1 and Example 1 with (I) fungicide/canola oil bio-adjuvant (#13), (II) fungicide (#12) and III) fungicide/canola oil bio-adjuvant (#11) according to various embodiments.

FIG. 10 is a photographic image of a treated dollar spot infected bentgrass fairway showing three portions four days after being treated in the manner described in Table 1 and Example 1 with (I) fungicide/mineral oil adjuvant (#14), (II) fungicide/canola oil bio-adjuvant (#13) and (III) fungicide (#12) according to an embodiment.

FIG. 11 is a photographic image of a treated dollar spot infected bentgrass fairway showing three portions four days after being treated in the manner described in Table 1 and Example 1 with (I) fungicide/canola oil bio-adjuvant (#20), (II) fungicide (#19) and (III) fungicide/mineral oil adjuvant (#18) according to an embodiment.

FIG. 12 is a photographic image of a bentgrass fairway showing (I) an untreated portion infected with dollar spot disease, and two treated portions four days after being treated in the manner described in Table 1 and Example 1 with (II) fungicide/canola oil bio-adjuvant (#20) and (III) fungicide (#19) according to various embodiments.

FIG. 13 is a photographic image of a treated dollar spot infected bentgrass fairway showing three portions four days after being treated in the manner described in Table 1 and Example 1 with (I) fungicide (#25), (II) fungicide (#26) and (III) fungicide/canola oil bio-adjuvant (#27) according to an embodiment.

FIG. 14 is a photographic image of a bentgrass fairway with two treated portions four days after being treated in the manner described in Table 1 and Example 1 with (I) fungicide (#26) and (II) fungicide/canola oil bio-adjuvant (#27), and (III) an untreated portion infected with dollar spot disease (#28) according to an embodiment.

FIG. 15 is a photographic image of a bentgrass fairway with two treated portions four days after being treated in the manner described in Table 1 and Example 1 with (I) fungicide/canola oil bio-adjuvant (#27) and (III) a fungicide/mineral oil adjuvant (#29) and (II) an untreated portion infected with dollar spot disease (#28) according to an embodiment.

FIG. 16 is a photographic image of a bentgrass fairway showing three portions four days after being treated in the manner described in Table 1 and Example 1 with (I) fungicide/canola oil bio-adjuvant (#2), (II) canola oil concentrate (#3) and (III) fungicide (#4) according to various embodiments.

FIG. 17 is a photographic image of a fairway showing (I) an untreated portion with dew (#35) and four portions four days after being treated in the manner described in Table 1 and Example 1 with (II) fungicide (#1), (III) fungicide/canola oil bio-adjuvant (#2), (IV) canola oil concentrate (#3) and (V) fungicide/mineral oil adjuvant (#17) according to various embodiments.

FIG. 18 is a photographic image of a healthy, dormant bentgrass fairway in April (East Lansing, Mich.) showing four portions 14 days after a second treatment (21 day interval) was applied in the manner described in Table 1 and Example 4 with (I) commercial fertilizer only (hereinafter “fertilizer”) (#36), (II) fertilizer/canola oil bio-adjuvant (#37) and (III) canola oil concentrate (#38) and (IV) an untreated (unfertilized since previous fall) portion (#39) according to various embodiments.

FIG. 19 is a photographic image of a bentgrass fairway partially covered in frost with five portions 11 days after being treated in the manner described in Table 1 and Example 5 with (I) fungicide/corn oil-containing adjuvant (hereinafter “corn oil adjuvant”) (#32), (II) fungicide/canola oil bio-adjuvant (#33), (III) fungicide/soybean oil-containing adjuvant (hereinafter soybean oil adjuvant”) (#34), (IV) fungicide (#30) and (V) fungicide (#1) according to various embodiments.

FIG. 20 is a photographic image of a frost-covered bentgrass fairway with five portions 11 days after being treated in the manner described in Table 1 and Example 5 with (I) fungicide/canola oil bio-adjuvant (#33), (II) fungicide/soybean oil adjuvant (#34), (III) fungicide (#30), (IV) fungicide (#1), and (V) mineral oil (#31) according to various embodiments.

FIG. 21 is a photographic image of a portion of dollar spot diseased bentgrass fairway showing additional dollar spot fungus growth five days after being treated with a canola oil concentrate (#40).

FIG. 22 is a photographic image of an irrigated, annual bluegrass (Poa annua) putting green showing (II) an untreated portion infected with crown rot anthracnose (Collectotrichum cereale) (#42) and two treated portions 14 days after being treated in the manner described in Table 1 and Example 13 with (I) fungicide/methylated canola oil bio-adjuvant “B” (#41) and (III) fungicide (#43) according to an embodiment.

FIG. 23 is a photographic image of a treated crown rot anthracnose infected putting green showing three portions 14 days after being treated in the manner described in Table 1 and Example 13 with (I) fungicide/canola oil bio-adjuvant (hereinafter canola oil bio-adjuvant “A”) (#44), (II) fungicide (#45), and (III) fungicide (#43) according to various embodiments.

FIG. 24 is a photographic image of a treated crown rot anthracnose infected putting green showing three portions 14 days after being treated in the manner described in Table 1 and Example 13 with (I) fungicide (#43), (II) fungicide/canola oil bio-adjuvant “A” (#46), and (III) fungicide/canola oil bio-adjuvant “A” (#47) according to various embodiments.

FIG. 25 is a photographic image of a treated crown rot anthracnose infected putting green showing two portions 14 days after being treated in the manner described in Table 1 and Example 13 with (I) fungicide/canola oil bio-adjuvant “A” (#48) and (II) fungicide/methylated canola oil bio-adjuvant “B” (#49) according to various embodiments

FIG. 26 is a photographic image of a treated crown rot anthracnose infected putting green showing two portions 14 days after being treated in the manner described in Table 1 and Example 13 with (I) fungicide/canola oil bio-adjuvant “A” (#48) and (II) fungicide/canola oil bio-adjuvant “A” (#50) according to various embodiments.

FIG. 27 is a photographic image of a treated crown rot anthracnose infected putting green showing one portion 14 days after being treated in the manner described in Table 1 and Example 13 with (II) fungicide/canola oil bio-adjuvant “A” (#51) according to various embodiments.

FIG. 28 is a photographic image of a treated crown rot anthracnose infected putting green showing one portion 14 days after being treated in the manner described in Table 1 and Example 13 with (II) fungicide (#52) according to various embodiments.

FIG. 29 is a photographic image of a treated dollar spot infected, irrigated bentgrass (Agrostis palustris)/annual bluegrass (Poa annua) fairway turf showing three portions 14 days after being treated in the manner described in Table 1 and Example 14 with (I) fungicide (#53), (II) fungicide/canola oil bio-adjuvant “B” (#54), and (III) fungicide/canola oil bio-adjuvant “A” (#55) according to various embodiments.

FIG. 30 is a photographic image of a treated dollar spot infected fairway turf showing three portions 14 days after being treated in the manner described in Table 1 and Example 14 with (I) fungicide/methylated canola oil bio-adjuvant “B” (#56), (II) fungicide (#57), and (III) fungicide/canola oil bio-adjuvant “B” (#58) according to various embodiments.

FIG. 31 is a photographic image of a treated dollar spot infected fairway turf showing three portions 14 days after being treated in the manner described in Table 1 and Example 14 with (I) methylated canola oil bio-adjuvant (#59), (II) fungicide (#60), and (III) canola oil bio-adjuvant “B” (#61) according to various embodiments.

FIG. 32 is a photographic image of a dollar spot infected fairway turf showing (II) an untreated portion infected with dollar spot disease (Rutstroemia floccosum, Sclerotinia homoeocarpa) (#28) and two treated portions 14 days after being treated in the manner described in Table 1 and Example 14 with (I) fungicide (#62) and (III) canola oil bio-adjuvant “B” (#63) according to an embodiment.

FIG. 33 is a photographic image of a dollar spot infected fairway turf showing (I) an untreated portion infected with dollar spot disease (Rutstroemia floccosum, Sclerotinia homoeocarpa) (#28) and two treated portions 14 days after being treated in the manner described in Table 1 and Example 14 with (II) canola oil bio-adjuvant “B” (#63) and (III) fungicide/canola oil bio-adjuvant “A” (#64) according to various embodiments.

FIG. 34 is a photographic image of a treated dollar spot infected fairway turf showing three portions 14 days after being treated in the manner described in Table 1 and Example 14 with (I) fungicide/canola oil bio-adjuvant “A” (#65), (II) fungicide/canola oil bio-adjuvant “B” (#58), and (III) fungicide (#62) according to various embodiments.

FIG. 35 is a photographic image of a treated dollar spot infected fairway turf showing three portions 14 days after being treated in the manner described in Table 1 and Example 14 with (I) fungicide/canola oil bio-adjuvant “B” (#66), (II) fungicide (#67), and (III) fungicide/canola oil bio-adjuvant “A” (#65) according to various embodiments.

FIG. 36 is a photographic image of a treated dollar spot infected fairway turf showing three portions 14 days after being treated in the manner described in Table 1 and Example 14 with (I) canola oil bio-adjuvant “A” (#68), (II) fungicide (#21), and (III) fungicide/canola oil bio-adjuvant “A” (#69) according to various embodiments.

FIG. 37 is a photographic image of a treated dollar spot infected fairway turf showing three portions 14 days after being treated in the manner described in Table 1 and Example 14 with (I) fungicide (#60), (II) fungicide/canola oil bio-adjuvant “B” (#61), and (III) fungicide/canola oil bio-adjuvant “A” (#70) according to various embodiments.

FIG. 38 is a photographic image of a treated dollar spot infected fairway turf showing three portions 14 days after being treated in the manner described in Table 1 and Example 14 with (I) fungicide/canola oil bio-adjuvant “A” (#70), (II) fungicide (#71), and (III) canola oil bio-adjuvant “A” (#72) according to various embodiments.

FIG. 39 is a photographic image of a treated dollar spot infected fairway turf showing three portions 14 days after being treated in the manner described in Table 1 and Example 14 with (I) fungicide/methylated canola oil bio-adjuvant “B” (#73), (II) fungicide (#53), and (III) fungicide/canola oil bio-adjuvant “B” (#54) according to various embodiments.

FIG. 40 is a photographic image of a treated dollar spot infected fairway turf showing three portions 14 days after being treated in the manner described in Table 1 and Example 14 with (I) fungicide/canola oil bio-adjuvant “A” (#69), (II) fungicide/canola oil bio-adjuvant “B” (#66), and (III) fungicide (#67) according to various embodiments.

FIG. 41 is a photographic image of a dollar spot infected fairway turf showing (III) an untreated portion infected with dollar spot disease (Rutstroemia floccosum, Sclerotinia homoeocarpa) (#28) and two treated portions 14 days after being treated in the manner described in Table 1 and Example 14 with (I) fungicide/canola oil bio-adjuvant “A” (#58) and (II) fungicide (#62) according to an embodiment.

FIG. 42 is a photographic image of a treated dollar spot infected fairway turf showing three portions 14 days after being treated in the manner described in Table 1 and Example 14 with (I) fungicide/canola oil bio-adjuvant “A” (#55), (II) fungicide (#22), and (III) fungicide/methylated canola oil bio-adjuvant “B” (#74) according to various embodiments.

FIG. 43 is a photographic image of a treated dollar spot infected, irrigated putting green showing two portions six days after being treated in the manner described in Table 1 and Example 15 with (I) canola oil bio-adjuvant “B” (#75) and (II) canola oil bio-adjuvant “B”/Treatments of sprayable urea (46-0-0) (The Andersons, Inc.) hereinafter “urea” (#76) according to various embodiments.

FIG. 44 is a photographic image of a treated dollar spot infected putting green showing three portions six days after being treated in the manner described in Table 1 and Example 15 with (I) canola oil bio-adjuvant “B” (#75), (II) canola oil bio-adjuvant “B”/urea (#76), and (III) canola oil bio-adjuvant “B”/urea (#77) according to various embodiments.

FIG. 45 is a photographic image of a treated dollar spot infected putting green showing three portions six days after being treated in the manner described in Table 1 and Example 15 with (I) canola oil bio-adjuvant “B”/urea (#76), (II) canola oil bio-adjuvant “B”/urea (#77), and (III) urea (#78) according to various embodiments.

FIG. 46 is a photographic image of a treated dollar spot infected putting green showing three portions six days after being treated in the manner described in Table 1 and Example 15 with (I) canola oil bio-adjuvant “B”/urea (#77), (II) urea (#78), and (III) urea (#79) according to various embodiments.

FIG. 47 is a photographic image of a treated dollar spot infected putting green showing three portions six days after being treated in the manner described in Table 1 and Example 15 with (I) urea (#78), (II) urea (#79), and (III) canola oil bio-adjuvant “B”/urea (#80) according to various embodiments.

FIG. 48 is a photographic image of a treated dollar spot infected putting green showing three portions six days after being treated in the manner described in Table 1 and Example 15 with (I) urea (#79), (II) canola oil bio-adjuvant/urea (#80), and (III) canola oil bio-adjuvant “B” (#81) according to various embodiments.

FIG. 49 is a photographic image of a treated dollar spot infected putting green showing three portions six days after being treated in the manner described in Table 1 and Example 15 with (I) canola oil bio-adjuvant “B”/urea (#80), (II) canola oil bio-adjuvant “B” (#81), and (III) canola oil bio-adjuvant “B”/urea (#82) according to various embodiments.

FIG. 50 is a photographic image of an irrigated putting green showing (III) an untreated portion infected with dollar spot disease (#28) and two treated portions six days after being treated in the manner described in Table 1 and Example 15 with (I) canola oil bio-adjuvant/urea (#81) and (II) canola oil bio-adjuvant “B”/urea (#82) according to one embodiment.

FIG. 51 is a photographic image of an irrigated putting green showing (II) an untreated portion infected with dollar spot disease (#28) and two treated portions six days after being treated in the manner described in Table 1 and Example 15 with (I) canola oil bio-adjuvant “B”/urea (#82) and (III) canola oil bio-adjuvant “B”/urea (#80) according to one embodiment.

### DESCRIPTION OF THE EMBODIMENTS

In the following detailed description, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized, and structural, logical, mechanical, electrical, and other changes may be made.

The various embodiments provided herein are biorational concentrates (i.e., “concentrate,” unless otherwise indicated) and products comprising one or more plant oils and/or glycerol and at least one additive in an amount effective for use as a bio-adjuvant or a biorational ingredient, such as a biostimulant. In various embodiments, the additive can comprise a colorant, a synthetic or commercially available active ingredient and/or a surfactant. The biorational concentrates and products described herein are useful for treating target crops, i.e., for controlling, repelling, preventing and/or eliminating target pests and/or canopy moisture and/or frost, as well as stimulating, maintaining, enhancing and regulating crop qualities, such as growth, density, rooting, and color intensity (with a darker color intensity generally indicating an improvement (e.g., a darker green for turfgrass)) either alone (optionally including a surfactant) or in combination with one or more commercially available active ingredients.

Various terms are defined herein. See also definitions in U.S. Pat. No. 8,028,928 (hereinafter “the '928 patent”) which patent is hereby incorporated by reference herein in its entirety. In case of a conflict in the meaning of various terms, the definitions provided herein should prevail.

The term “target crop” as used herein refers to any type of cultivated plant, including any type of genetically modified or cross-bred crop that can be harvested for food or used in place, such as for recreational purposes, including various types of monocots or dicots, as well as various types of vascular plants or non-vascular plants, further including any type of agricultural crop (e.g., oats, barley, wheat or rice cereals, corn, cotton, tobacco, maize, sorghum, hops, peanuts, soybeans, coffee) or horticulture crop, which can include, but is not limited to, any type of vegetable, fruit, ornamental or nursery crop, such as any type of tree (e.g., fruit, ornamental), bush, herb, grass (e.g., lawn, turfgrass, etc.), shrub, flower, vineyard, and the like. When being evaluated either subjectively or objectively post-treatment, the target crop may be referred to herein as “biomass.” A change in plant growth or plant growth rate of an individual plant in the target crop and/or a change to overall density of a given target crop area represents, therefore, a change in the biomass amount, such as an increase in biomass amount.

The term “turfgrass” or “turf” as used herein refers to a target crop or a specified target area containing grass plants of one or more species or cultivars of desirable grass plants which are maintained at a desired quality, as determined by color intensity and growth rate of individual plants, and overall density, for use in a variety of aesthetic and recreational activities. Turfgrass can also be harvested with the roots intact, together with a layer of topsoil, and shipped as sod. Turfgrass used on a golf course can include, but is not limited to, a putting green, fairway, rough area, tee and/or bunker. When coming out of winter conditions, the quality of a grass, such as turfgrass, is oftentimes referred to as “green-up” which is generally indicative of increased individual plant growth rate and overall density of a given area, as well as increased color intensity of individual plants.

The term “soil” as used herein, refers generally to Earth's thin upper layer capable of supporting plant growth. Soil includes topsoil, sand, and various layers of subsoil. The column of soil occupied by plant roots is called “root zone.”

The term “shoot” as used herein refs to stems, including their appendages, namely, leaves, lateral buds, flowering stems and flower buds.

The term “tiller” as used herein refers to a stem produced by grass plants and refers to all shoots that grow after an initial parent shoot grows from a seed.

The term “plant density” or “density,” as used herein refers to the number of plants per unit area. A grassy plant can include a parent shoot and one or more tillers Density can be increased through substantially vertical growth of a plant, through production of additional tillers on an individual plant and/or through production of rhizomes, which can produce new plants above ground.

The term “rhizome” as used herein refers to a modified subterranean stem of a plant this is usually found underground, often sending out roots and shoots from its nodes. Rhizomes can also be referred to as creeping rootstalks and rootstocks. Rhizomes develop from axillary buds (embryonic shoot) and are diageotropic (grow perpendicular to the force of gravity). A rhizome also retains the ability to allow new shoots to grow upwards.

The term “plant growth rate” or “growth rate” as used herein refers to the rate of growth of a substantially vertical leaf or shoot and/or production or extension of a stem extension, i.e., tillering/rhizome increase, which increases lateral density.

The term “treatment” as used herein refers to an agricultural or horticultural treatment that involves delivery of a crop treatment product to a target crop and/or to the surrounding soil to repel, control, prevent and/or eliminate diseases and/or canopy moisture and/or frost in the target crop. A treatment can additionally or alternatively be used to maintain and/or enhance crop qualities and/or to stimulate, maintain, enhance, regulate and/or enhance crop qualities, such as growth, density, rooting, and color intensity. The term “treatment” is often used interchangeably with the term “management” (e.g., turfgrass management). If delivered to one or more specific limited or small areas of a target crop, it may be referred to as “spot treatment.”

The term “foliage” as used herein refers to a leaf, such as a blade, or, more generally the green or living part of a plant.

The term “foliar feeding” as used herein refers to a technique of treating a target crop by applying the treatment directly to the foliage.

The term “canopy” as used herein refers to a layer of vegetation elevated above the ground.

The term “canopy moisture” as used herein refers to moisture, i.e., wetness on a crop canopy from any source, including, but not limited to, condensation of moisture from the surrounding air (i.e., dew), guttation, irrigation, and the like.

The term “formulation” as used herein refers to a composition of matter formulated to treat a target crop and containing at least one active ingredient or at least one biorational ingredient, and a carrier. A formulation may be in the form of a liquid, a solid, or both, such as a suspension. A formulation may be delivered to the target crop in a variety of manners, including, but not limited to, a spray, foam, mist, granular applications (e.g., baits, lures, etc.), and the like.

The term “moist formulation” as used herein refers to a formulation containing at least 1% liquid.

The term “liquid formulation” as used herein refers to a formulation that contains sufficient liquid properties such that it is flowable or sprayable. The liquid properties may be inherent or added in the form of heat and/or a solvent.

The term “carrier” as used herein refers to an additive which acts as a vehicle for an active ingredient or a biorational ingredient and which is suitable for administration to a target crop. A carrier can include, but is not limited to, a solid or liquid diluent, hydrotrope, encapsulating substances, and the like. A carrier can be an inert carrier or an active carrier. Water is one example of an inert carrier. A biorational concentrate, may, in certain applications, function as an active carrier.

The term “additive” as used herein refers to a component added to a concentrate or product other than the active ingredient or biorational ingredient, such as any type of adjuvant, colorant, surfactant, and the like. An additive may also be an inert additive. Examples of inert additives include, but are not limited to, a binding agent, a marker, or an inert carrier.

The term “surfactant” or “emulsifier” or “surface-active agent” as used herein refers to an additive which lowers the surface tension of a liquid. A surfactant may act as a detergent, wetting agent, emulsifier, foaming agent, or dispersant. A surfactant is amphiphilic and is typically, but not always, an organic compound. A surfactant can aid in the formation of an emulsion.

The term “emulsion” as used herein refers to a colloidal suspension of a first liquid distributed throughout a second liquid, with the first liquid typically present as droplets of microscopic or ultramicroscopic size. Examples of emulsions include oil-in-water emulsions and water-in-oil emulsions.

The term “foam” as used herein refers to a substance that is formed by trapping pockets of gas in a liquid or solid. A foam can be an open-cell foam or a closed-cell foam.

The term “active ingredient” or “agriculturally active ingredient” or “commercially available active ingredient” or “A.I.” as used herein refers to an ingredient used in a crop treatment concentrate which effects a desired result to a target crop and which are generally understood to be regulated, such as by the EPA. An active ingredient can be formulated with a carrier for delivery to the target crop and/or combined with other additives. The desired result for an active ingredient can include, but is not limited to, repelling, controlling, preventing and/or eliminating target pests and/or canopy moisture and/or frost, as well as stimulating, maintaining, enhancing and regulating crop qualities, such as growth, density, rooting, and color intensity.

The term “plant oil” or “plant oil fraction” as used herein refers to an oil or oils derived from a plant source, rather than an animal or petroleum source. A plant oil includes a triglyceride-based vegetable fat and oil, macerated oil (base oil to which parts of plants are added) and essential oil (comprised of volatile aromatic compounds). When used without qualification herein, the term “plant oil” is intended to refer to a triglyceride-based vegetable fat or oil or tree-derived oil

The term “glycerol” as used herein refers to a simple sugar alcohol made from the hydrolysis (saponification) or transesterification of triglycerides, such as a triglyceride-based vegetable fat or oil.

The term “crop treatment product” as used herein refers to a formulation or composition capable of treating a target crop. A crop treatment product can contain any type of commercially available active ingredient(s) and/or biorational concentrate(s). A crop treatment product may optionally further include additives as defined herein.

The term “crop treatment concentrate” as used herein refers to an active ingredient, a biorational concentrate or an adjuvant. When applied without a carrier a crop treatment concentrate can function as a crop treatment product.

The term “biorational treatment product” as used herein refers to a crop treatment product which is “natural” or otherwise contains natural ingredients, i.e., ingredients based on biological approaches, such as plant oil-containing products and glycerol-containing products, as opposed to a crop treatment product which contains only petroleum-based products and/or synthetic chemicals not based on any biologically-known compounds, e. g., DEET. The biorational treatment products described herein include biorational concentrates, such as biorational ingredients and bio-adjuvants, which are formulated for use as crop treatment products. A biorational treatment product is considered to be less toxic with fewer ecological side-effects, including to the target crop, as compared with a crop treatment product containing no natural ingredients.

The term “off-label” or “off-label use” as used herein refers to use of a crop treatment concentrate or product, such as an agriculturally active ingredient, in an amount and/or a rate (such as a reduced amount and/or rate) and/or for a purpose other than the purpose for which the crop treatment concentrate or product is labeled for commercially, i.e., treatment of different target pest(s) and/or different effect on the labeled target pest(s).

The term “plant oil-containing product” as used herein refers to a biorational treatment product containing an amount of one or more types of natural and/or modified plant oils.

The term “glycerol-containing product” as used herein refers to a biorational treatment product containing an amount of glycerol and/or modified glycerol.

The term “biorational concentrate” as used herein refers to a biorational ingredient or a bio-adjuvant. A biorational concentrate can further optionally include a colorant and/or surfactant and/or other additives. Although a biorational concentrate, by definition, does not include a carrier, in certain applications a biorational concentrate can function as an active carrier.

The term “biorational ingredient” as used herein refers to a biorational concentrate in a biorational treatment product which effects a desired result to a target crop. The desired result for a biorational ingredient includes at least the results obtained with a conventional active ingredient. A biostimulant is one type of biorational ingredient.

The term “biostimulant” as used herein refers to a biorational ingredient that can complement crop nutrition and protection by maintaining or improving crop health (e.g., improving vigor, growth, rotting, density, yield, quality and/or tolerance of abiotic stresses, etc.) and/or can cause regeneration of healthy soil, by, for example, enhancing soil fertility. Improved growth rate and density can also contribute to target pest reduction, such as disease reduction. As such, a biostimulant can also reduce disease and increase yield in a target crop.

The term “adjuvant” as used herein refers to an additive used in a crop treatment product containing an active ingredient, which enhances the efficacy of (i.e., assists in the action of) the active ingredient. An adjuvant is oftentimes referred to as being “synergistic.” As used herein, an adjuvant may be synergistic with another additive and/or with the active ingredient(s). The adjuvant may be either a bio-adjuvant, i.e., a biorational concentrate, or a conventional adjuvant.

The term “colorant” or “colorant fraction” as used herein refers to any component capable of altering the natural color of a plant, such as by maintaining or improving color intensity or otherwise providing visible color changes useful to users of a particular target crop. A colorant can include markers, paints, pigments and dyes.

The term “marker” as used herein, refers to a colorant included in a crop treatment product intended primarily to provide a visual reference to show where treatment has been applied to a target area. A marker may or may not be biodegradable.

The term “pigment” or “pigment fraction” as used herein refers to a colorant that does not necessarily penetrate a plant. A pigment is considered to be insoluble in water, as it will settle without agitation, but is more durable (i.e., longer lasting) than a dye. The term “pigment” is understood to include one or more pigments.

The term “pigmentation stimulant” as used herein refers to a crop treatment product intended to enhance or maximize the natural color intensity of a plant.

The term “pigmentation inhibitor” as used herein refers to a crop treatment product intended to reduce or minimize the natural color intensity of a plant.

The term “dye” or “dye fraction” as used herein refers to a colorant that has an affinity for the target crop to which it is being applied. A dye is reactive and water soluble. A dye will stay in solution, but is less durable than a pigment. The term “dye” is understood to include one or more dyes.

The term “paint” or “paint fraction” as used herein, refers to a colorant (pigment with resin) that does not have an affinity for the target crop to which it is being applied A paint tends to remain on the target crop longer than pigments and dyes. The term “paint” is understood to include one or more paints.

The term “synergy” as used herein refers to the action of an adjuvant, such as a bio-adjuvant, which action enhances the efficacy of an active ingredient and/or certain additives, such as a colorant, in a crop treatment product.

The term “effective amount” or “effective treatment amount” as used herein refers to an amount of a crop treatment concentrate sufficient to effect the desired result to the target crop. An effective amount can be delivered to the target crop as is or diluted in a carrier to form a crop treatment product. An effective amount can be delivered to the target crop in a single treatment or in multiple treatments, including over a period of time, which can be intermittently or continuously, and can include treatments at various dosages.

The term “rate” as used herein refers to an amount of a crop treatment product applied to a given area. When applied without a carrier, the rate can refer to an amount of a crop treatment concentrate applied to a given area.

The term “effective rate” as used herein refers to an effective amount of crop treatment concentrate applied to a given area which is capable of affecting the desired result. When applied without a carrier, the effective rate can refer to an effective amount of a crop treatment concentrate applied to a given area.

The term “delivering” as used herein, refers to dispensing, applying, placing and/or distributing a crop treatment product or crop treatment concentrate onto or near a target crop and/or the surrounding soil. Delivering can include, but is not limited to, hand broadcasting, machine spreading or broadcasting, brushing, spraying, irrigating, air blast spraying, particle (e.g., sand) coating, irrigation system injecting (e.g., in-ground irrigation, center pivot irrigation, etc.), and the like.

The term “delivery means” or “applying means” refers to a device or apparatus (including an irrigation system) for delivering a crop treatment concentrate or product to a target crop. The delivery means can include, but is not limited to a sprayer, such as a hydraulic sprayer (e.g., a boom sprayer) or a low volume sprayer (e.g., an air blast sprayer or electrostatic sprayer), a bucket, hand(s), a drop spreader, an irrigation system, or any delivery device which can be located on any type of vehicle capable of traveling over or near the desired target crop, including by air or boat.

The term “point-of-application” as used herein refers to a treatment delivered to a target crop in situ.

The term “tank-mixed” as used herein refers to use of a container to combine two or more ingredients prior to delivering to the target crop.

The term “natural growth cycle” as used herein, in reference to a target plant in a target area, refers to growth phases which occur naturally over the course of a growing season and include establishment of a root.

The term “pest” or “target pest” as used herein refers, with reference to a target crop, to any organism capable of causing stress, death or injury to one or more plants in the target crop through a disease (e.g., pathogenic fungus), by total or partial consumption of the plant (e.g., arthropods, including insects, arachnids (e.g., mites), myriapods and crustaceans), via bacteria or virus, or through competition with the plant (weeds). Pests can further include, but are not limited to animals (e.g., rodents) and nematodes.

The term “disease” as used herein refers to an undesirable interaction between a target crop and a pathogen which can cause abnormal growth increase or decrease and/or crop death and/or affect the appearance of the target crop.

The term “pathogen” as used herein refers to an organism, a microorganism, or an agent with the capacity to cause a plant disease including, but not limited to, viruses, bacteria, parasites (including, but not limited to, organisms within the phyla Protozoa, Platyhelminthes, Aschelminithes, Acanthocephala, and Arthropoda), and fungi, such as Sclerotinia homoeocarpa or Rutstroemia flocossum (Dollar Spot), Ectotrophic Root Infecting Fungi, Basidiomycete fungi (fairy ring), Colletotrichum graminicola (Anthracnose), Take-all patch (Gaeumannomyces graminis), and the like.

The term “patch disease” as used herein refers to a small or limited dead area caused by a pathogen, which is present in a live target crop, such as a turf grass plant area (green). Patch disease oftentimes occurs in a circular area within the target crop. Symptoms of patch disease may also include the appearance of dead rings of grass, such as “fairy rings” with live plants located inside and outside of the ring.

The term “pesticide” as used herein refers to a chemical or mixture of chemicals or biological agent(s) used to control any one of a microorganism, an arthropod, a plant or an animal pest in order to protect and/or preserve desirable plants in a target crop.

The term “fungus” or “fungi” as used herein refers to spore-producing eukaryotic organisms of the kingdom Fungi, which lack chlorophyll. Fungi can include, but are not limited to, mushrooms, mold, rust, and mildew, such as powdery mildew. Fungi which cause disease, stress and/or injury are known as “pathogenic” fungi.

The term “fungicide” as used herein refers to a crop treatment product that prevents/destroys fungal growth.

The term “fungistat” as used herein refers to a crop treatment product that inhibits fungal growth, but does not destroy the fungus.

The term “weed” as used herein, refers to an undesired, uncultivated plant growing in a manner so as to adversely compete with desirable plants for water, light and nutrients or to destroy desired qualities of a target crop.

The term “fertilizer” as used herein refers to a substance containing one or more of the following, which are capable of acting as a plant nutrient or micro-nutrient: nitrogen, phosphate, potassium, and can further include urea, sulfur-coated urea, isobutylidene diurea, ammonium nitrate, urea ammonium nitrate (UAN), ammonium sulfate, ammonium phosphate, triple super phosphate, phosphoric acid, potassium sulphate, potassium nitrate, potassium metaphosphate, potassium chloride, dipotassium carbonate, potassium oxide, urea ammonium sulfate, urea ammonium phosphate, boron, iron, proteins, amino acids, and any combination of these.

There is a need to maintain crops, such as turfgrass, in a manner which provides both aesthetic and functional properties, such as for use as a recreational playing surface, e.g., golf, football, baseball, rugby, soccer, and so forth. However, current crop treatment concentrates and crop treatment products (i.e., crop treatment concentrates and products) are not only petroleum-containing and/or 100% synthetic, and thus not environmentally friendly, but can also be costly and result in unwanted side effects, such as phytotoxicity, particularly under hot conditions. Additionally, the Environmental Protection Agency (EPA) is seeking to reduce synthetic inputs into the environment. Given the tight seasonal use limits which the EPA has already imposed on many conventional crop treatment concentrates and products, such as cholorthalonil, fluazinam, azoxystrobin, and tebuconazole fungicides, improved crop treatment concentrates and products are needed, including products which are more environmentally friendly. Additionally, conventional mineral oil-containing products are known to occasionally be too phytotoxic for use on golf courses, particularly on putting greens during warm weather.

In the various embodiments described herein, crop treatment concentrates and crop treatment products referred to herein as “biorational treatment concentrates” (or “biorational concentrates”) and “biorational treatment products” (or “biorational products”) respectively, are provided, which are more environmentally friendly than conventional crop treatment concentrates, including mineral oil-based products, and products not containing biorational components, while still providing comparable or improved results. In one embodiment, the biorational treatment products described herein contain biorational concentrates, such as biorational ingredients or bio-adjuvants. In some embodiments, at least a portion, up to a majority or all of the biorational treatment product comprises a biorational concentrate. In one embodiment, the biorational treatment concentrate or product includes no petroleum-based components. The biorational treatment concentrates and products described herein are useful alone as biorational ingredients (including biostimulants), or in combination with commercially available active ingredients for treating target crops as described herein and/or in combination with various additives.

The various biorational treatment concentrates and products are surprisingly useful for a wide variety of applications, including, but not limited to, disease treatments, canopy moisture treatments, frost treatments, fertilizing treatments, and so forth. In one embodiment, growth effects are less dramatic than with conventional mineral oil-containing concentrates or products, thus reducing problems associated with excessive growth on certain target crops, such as putting greens.

In various embodiments, one or more surfactants are used to form a stable emulsion with the biorational concentrate and, optionally, other components present. In one embodiment, the emulsified biorational concentrate is formulated with a suitable carrier to form the biorational treatment product which can be delivered to the target crop in a suitable manner, such as with a spray apparatus. In most embodiments described herein, the biorational treatment product is delivered as an oil-in-water emulsion. In one embodiment, the biorational treatment product is more concentrated, and is delivered as a water-in-oil emulsion with or without a carrier. In one embodiment, no carrier is used and the water-in-oil emulsion is a biorational treatment product comprising a plant oil/glycerol-only emulsion. In one embodiment, no carrier is used and the water-in-oil emulsion is a biorational treatment product comprising a plant oil/active ingredient-only emulsion. As with other embodiments containing a carrier, these undiluted biorational treatment products can also be delivered to the target with an appropriate spray apparatus directly to the target crop.

In one embodiment, the carrier is an inert carrier, such as, but not limited to, water. In one embodiment, the carrier is an active carrier, such as, but not limited to, any type of biorational treatment concentrate.

In one embodiment, the biorational concentrate or emulsified biorational concentrate is formulated with a liquid carrier in a biorational concentrate to liquid carrier ratio (biorational concentrate:liquid carrier) from about 1:10 to about 1:500, such as from about 1:100 to about 1:250, such as from about 1:10 to about 1:40, such as from about 1:34 to about 1:36, including any range there between, such as no more than about 1:40.

In one embodiment, the biorational concentrate or emulsified biorational concentrate is formulated with a liquid carrier for delivery to a target crop in amounts of from about one fl. oz. (0.03 L) to about 35 fl. oz. (1.04 L) (biorational concentrate) to about 1 gallon (3.79 L) (carrier), such as from about 1 oz. (0.03 L) to about 35 oz. (1.04 L), such as about 5 fl. oz. (0.15 L) to about 30 fl. oz. (0.89 L), such as about 10 fl. oz. (0.3 L) to about 25 fl. oz. (0.74 L), such as about 10 fl. oz. (0.3 L) to about 20 fl. oz. (0.59 L), such as about 10 oz. (0.3 L) to about 15 oz. (0.44 L), including any range there between, such as no more than 5 oz. (0.15 L), 10 oz. (0.3 L), 15 oz. (0.44 L), 20 oz. (0.59 L), 25 oz. (0.74 L), 30 oz. (0.89 L) or 35 oz. (1.04 L) to 1 gallon (3.79 L) of carrier or no more than about 3.2 oz. (0.09) in about 0.9 gal (3.41 L).

In one embodiment, the biorational treatment concentrate or product is a plant oil-containing treatment concentrate or product and/or a glycerol-containing treatment concentrate or product. Any suitable plant oil or combination of plant oils can be used in a plant oil-containing treatment product. In one embodiment, the plant oil in the product includes, but is not limited to any grade of, canola oil, neem oil, coconut oil, corn oil, cottonseed oil, olive oil, palm oil, peanut oil, rapeseed oil, safflower oil, sunflower oil, sesame oil, soybean oil, any type of nut oil, citrus oil, oils from melon and gourd seeds, and any combination thereof. In one embodiment, food grade oils are used.

In one embodiment, plant oil or a combination of plant oils is used in an amount of from about 1 vol % to about 99 vol % of the biorational treatment concentrate or product, including any value or range contained within the stated range.

In one embodiment, canola oil is used as the plant oil. Canola oil can be maintained as a liquid at colder temperatures, i.e., does not solidify in colder temperatures (i.e., <11.7° C. (53° F.)) down to about 4° C. (39.2° F.). In one embodiment, canola oil is used in combination with one or more additional plant oils and/or glycerol in any suitable amount to prevent solidification at colder temperatures or to provide other treatment benefits In one embodiment, canola oil and other biorational concentrates (e.g., plant oils and/or glycerol with or without added colorants and/or surfactants) may be used in any suitable combination, such as a canola oil to biorational concentrate ratio (canola oil:biorational concentrate ratio) from about 1:1 to about 4:1 or about 1:1 to about 1:4, including any range there between.

In one embodiment, about 1 to about 99 vol % canola oil is used in combination with one or more other biorational plant oils and/or glycerol in a range of from about 1 to about 99 vol %, such as from about 10 to about 90 vol %. In one embodiment, about 50 to 99 vol % of canola oil is used in combination with one or more other biorational plant oils and/or glycerol. In one embodiment, canola oil is used in combination with one or more other biorational plant oils and/or glycerol in a range from about 1 to about 50 vol %, such as from about 1 to about 25 vol %, such as from about 1 to about 10 vol %, such as about 5 vol % to about 15 vol %, including any ranges there between, or in an amount of no more than 1 vol %, 2 vol %, 3 vol %, 4 vol %, 5 vol % or higher, such as no more than 10 vol %, 15 vol %, 20 vol %, 25 vol %, 30 vol %, 33 vol %, 35 vol %, 40 vol %, 45 vol % or 50 vol %. Various combinations are possible depending on the economics, type and level of treatment desired and operating conditions (e.g., temperature).

In one embodiment, only canola oil is used as the plant oil in a range of about 1 to about 99 vol % of the biorational concentrate or composition with or without glycerol, such as from about 10 to about 95 vol %, such as from about 10 to about 90 vol % of the biorational concentrate. In one embodiment, about 50 to 99 vol % of canola oil is used in the biorational treatment product. In one embodiment, canola oil is used in a range of about 1 to about 50 vol % of the biorational treatment product, such as from about 1 to about 25 vol %, such as from about 1 to about 10 vol %, such as about 5 vol % to about 15 vol %, including any ranges there between, or in an amount of no more than 1 vol %, 2 vol %, 3 vol %, 4 vol %, 5 vol % or higher, such as no more than 10 vol %, 15 vol %, 20 vol %, 25 vol %, 30 vol %, 33 vol %, 35 vol %, 40 vol %, 45 vol % or 50 vol %. In one embodiment, about 40 to about 95 vol % canola oil is used in the biorational treatment product, such as about 40 to about 93 vol %, such as about 45 to about 93 vol %, such as about 50 to about 93 vol %, such as about 55 to about 93 vol %, such as about 58 to about 93 vol %, such as about 60 to about 90 vol %, such as about 65 to about 85 vol %, such as about 75 to about 80 vol %, including any ranges there between. In one embodiment, about 90 to about 95 vol % canola oil is used in the pretreatment product.

In one embodiment, the composition or biorational concentrate does not include plant oils other than canola oil and may or may not contain glycerol and/or a surfactant. In one embodiment, the composition or biorational concentrate comprises from about 10 to about 95 vol % canola oil (such as from about 40 to about 95%), about 1 to about 90 vol % pigment (such as from about 4.2 to about 5 vol %) and about 0.1 to about 25 vol % surfactant (such as from about 2.5 to about 3.3 vol %). In one embodiment, the composition or biorational concentrate contains from about 40 to about 95 vol %, such as from about 40 to about 95 vol % (such as from about 40 to about 93 vol %), about 3 to about 50% pigment, and about 0.1% to about 25% surfactant. In one embodiment, the composition or biorational concentrate contains from about 58 to about 93% canola oil, about 3.7 to about 41.7% pigment and about 0.25 to about 20.5% surfactant. In one embodiment, the composition or biorational concentrate comprises a canola oil, pigment and surfactant in a 1% v/v carrier solution. In one embodiment, a ratio of oil:pigment is at least or no more than 1:1, together with a surfactant amount of from about 0.1 to about 0.9, such as from about 0.1 to about 0.7, such as from about 0.3 to about 0.6, such as at least about 0.5.

In one embodiment, the plant oil is modified from its natural state to further enhance its effectiveness. In one embodiment, the plant oil is methylated. In one embodiment, methylated canola oil is used in the same manner and ranges as described herein for non-modified, e.g., non-methylated canola oil. As such, in various embodiments, methylated canola oil can be used on a target crop (e.g., turfgrass) to control a target pest (e.g., dollar spot). However, in various embodiments, lower amounts of surfactant are added when a methylated plant oil, such as methylated canola oil, is used, as compared to the amount used for a non-methylated or other non-modified plant oil. Use of higher amounts of surfactant (e.g., greater than 20 vol %, such as greater than 20.5 vol %) with a methylated plant oil or in a concentrate that contains at least some methylated plant oil, can cause the concentrate to become highly viscous, i.e., to become a sludge, such that it cannot be sprayed. In some embodiments, such higher amounts of surfactants become sufficiently hard and stiff within the mixing device as to be unusable. In various embodiments, the amount of surfactant in a concentrate (or composition) containing methylated plant oils, such as methylated canola oil, is less than 5 vol %, such as less than 4 vol %, such as less than 3 vol %, such as less than 2 vol %, such as less than 1 vol %. In one embodiment, the amount of surfactant is no more than 0.5 vol %.

In one embodiment, neem oil is used as the plant oil in the biorational treatment concentrate or product. In one embodiment, a combination of neem oil and canola oil is used. The neem and canola oils may be used in any suitable combination such as in a neem oil to canola oil ratio (neem oil:canola oil) from about 1:1 to about 4:1 or about 1:1 to about 1:4, including any range there between. In one embodiment, about 1 to about 99 vol % neem oil in combination with about 1 to about 99% canola oil. In one embodiment, neem oil and canola oil are used in the treatment concentrate or product, with the neem oil comprising from about 1 to about 99 vol % of the concentrate or product, such as from about 50 to 99 vol %, such as from about 1 to about 50 vol %, such as from about 1 to about 25 vol %, such as from about 1 to about 10 vol %, such as about 5 vol % to about 15 vol %, including any ranges there between, or in an amount of no more than 1 vol %, 2 vol %, 3 vol %, 4 vol %, 5 vol % or higher, such as no more than 10 vol %, 15 vol %, 20 vol %, 25 vol %, 30 vol %, 33 vol %, 35 vol %, 40 vol %, 45 vol % or 50 vol % of the two oils. As is true for all embodiments herein, various combinations are possible depending on a number of factors, including, but not limited to, the economics, type and level of treatment desired and operating conditions (e.g., temperature).

As noted above, in one embodiment, a surfactant is combined with one or more biorational concentrates, such as one or more plant oils, in any suitable amount, such as from about 0.1 to about 25%, such as about 0.25 to about 25%, such as about 0.25 to about 23%, such as about 0.25 to about 22%, such as about 0.25 to about 20.5%, including any ranges there between. In one embodiment, the surfactant is added in an amount from about 0.5 vol % to about 25 vol %, such as about 1 vol % to about 20 vol %, such as about 2% to about 15%, such as about 2% to about 10%, including any range there between, or in an amount no more than 1 vol %, 2 vol %, 3 vol %, 4 vol %, 5 vol % or higher, such as no more than 10 vol %, 15 vol %, 20 vol %, 25 vol %, 30 vol %, 33 vol %, 35 vol %, 40 vol %, 45 vol % or 50 vol %.

In one embodiment, the surfactant can include, but is not limited to, trisiloxane ethyoxylate, an alcohol alkoxylate, an alkylaryl ethoxylate, a fatty amine ethoxylate, an organo-silicate, a surfactant with more than one active constituent, an anionic surfactant, a cationic surfactant, a nonionic surfactant, an amphoteric surfactant, an inorganic salt, a natural surfactant such as an alkylated sugar, alkyl polyglucoside, plant sugar, crop oil, such as a plant oil, a fertilizer-based adjuvant, and the like.

In one embodiment, the biorational treatment concentrate or product is a glycerol-containing treatment concentrate or product. In one embodiment, glycerol is used with no added surfactant. In one embodiment, as noted above, glycerol is used in combination with one or more plant oils, including, but not limited to, canola oil and/or neem oil. In one embodiment, use of glycerol in combination with one or more plant oils, eliminates the need for a surfactant. In one embodiment, a reduced amount of surfactant (such as about 1 to about 30 vol % less, such as about 1 to 20 vol % less, such as about 1 to 10 vol % less, or any range there between) is used, as compared to an amount of surfactant used in a biorational treatment concentrate or product containing no glycerol.

In one embodiment, the biorational treatment concentrate or product further comprises a colorant selected from a pigment, dye and and/or paint. In one embodiment, the colorant is or includes an organic pigment, organic dye and/or organic paint. In one embodiment, the colorant is or includes an inorganic pigment, inorganic dye and/or inorganic paint. In one embodiment, the inorganic pigment is selected from a metal oxide, such as iron oxide, titanium oxide, and Prussian Blue.

In one embodiment, the pigment can be, but is not limited to, copper phthalocyanine, chlorinated copper phthalocyanine, copper monochlorophthalocyanine and/or other phthalocyanine derivatives (a compound derived from phthalocyanine) and/or analogs (having a structure similar to phthalocyanine, but differing in respect of a certain component, such as with one or more different atoms, molecules, functional groups and/or substructures).

In one embodiment, the paint is any suitable type of pigment combined with a resin. In one embodiment, the paint contains copper phthalocyanine, chlorinated copper phthalocyanine, copper monochlorophthalocyanine, and/or other phthalocyanine derivatives and/or analogs combined with any suitable polymeric resin (i.e., binder).

In one embodiment, any type of commercial dye, pigment or paint is utilized, including, but not limited to Foursome brand pigment, Par brand pigment, Par Plus brand pigment, Sarge brand pigment, Green Pig brand pigment, Green Lawnger brand paint, Match Play brand paint, and the like.

In one embodiment, one or more plant oils and/or glycerol are combined with a colorant, such as a pigment, paint or dye in any suitable proportions, such as a plant oil(s) and/or glycerol:colorant ratio of from about 1:1 to about 90:1, such as from about 10:1 to about 75:1, such as from about 25:1 to about 50:1, such as from about 15:1 to about 25:1, such as no more than about 20:1, including any range there between. In one embodiment, the colorant comprises from about 1 to about 99 vol % of the colorant/oil(s) and/or glycerol combination, such as from about 50 to 99 vol %, such as from about 1 to about 50 vol %, such as from about 3 to about 50%, such from about 3 to about 45%, such as from about 3.5 to about 43%, such as from about 3.7 to about 41.7%, or any rage there between. Ranges can further include from about 1 to about 25 vol %, such as from about 1 to about 10 vol %, such as about 5 vol % to about 15 vol %, including any ranges there between. In one embodiment, the colorant is added in an amount of no more than 1 vol %, 2 vol %, 3 vol %, 4 vol %, 5 vol % or higher, such as no more than 10 vol %, 15 vol %, 20 vol %, 25 vol %, 30 vol %, 33 vol %, 35 vol %, 40 vol %, 45 vol % or 50 vol % of the colorant/oil(s) and/or glycerol combination.

In one embodiment, the biorational treatment concentrate is used as a biorational ingredient with or without commercially available active ingredients, adjuvants and/or surfactants. In one embodiment, the biorational ingredient is a biostimulant.

In one embodiment, the biorational concentrate is combined with a commercially available active ingredient and used as a bio-adjuvant in a crop treatment concentrate or product. In this embodiment, the biorational concentrate can create a “synergistic” effect, i.e., enhance the efficacy of the active ingredient, such that a reduced amount of the active ingredient can be used as compared to the label rate, but with comparable or improved results. In one embodiment, the biorational concentrate includes one or more plant oils and/or glycerol and, optionally, a colorant, and/or a surfactant.

In one embodiment, the biorational treatment concentrate primarily contains a plant oil or combination of plant oils, such as neem oil, canola oil and/or glycerol and, optionally, a colorant (e.g., paint, dye and/or pigment).

In one embodiment, at least 1 vol % less of the commercially available active ingredient is required as compared to the full-labeled dose. In one embodiment, the reduced label rate (i.e., reduced rate) is at least 2 vol %, or at least 3 vol %, or at least 4 vol %, or at least 5 vol %, or at least 10%, or at least 15%, or at least 20%, or at least 25%, or at least 25%, or at least 30%, or at least 33 vol %, or at least 35 vol %, or at least 40 vol %, or at least 45 vol %, or at least 50 vol %, at least 55 vol %, at least 60 vol %, at least 65 vol %, at least 70 vol %, at least 75 vol %, at least 80 vol % below the full label rate, including any ranges there between. In one embodiment, the reduced label rate is from 10 to 80 vol % of the full label rate, such as from 10 to 75 vol %, such as from 25 to 75 vol %, such as from 33 to 75 vol %, such as from 33 to 67 vol %, such as from 50 to 75 vol %, and any range there between.

In one embodiment, the commercially active ingredient can include, but is not limited to, any type of herbicide (i.e., weed killer), plant growth regulator, fertilizer, nematicide, pesticide, fungicide, molluscicide, rotenticide, antidessicant, insecticide, dessicant, antitranspirant, frost prevention aid, inoculant, UV protectant, antioxidant, leaf polish, pigmentation stimulant, pigmentation inhibitor, animal repellent, bird repellent, arthropod repellent, moisture retention aid, humic acid, phosphite, humate, lignin, lignate, bitter flavorant, irritant, malodorous ingredient, defoliant, chemosterilant, plant defense booster (e.g., harpin protein, acibenzolar-s-methyl, chitosan, and the like), and/or stress reduction compound(s).

In one embodiment, a fertilizer and/or fungicide comprise the active ingredient in combination with any of the biorational concentrates noted herein to form the crop treatment concentrate or product.

In one embodiment, the fertilizer contains urea. In one embodiment, the urea is in the form of urea ammonium nitrate. In one embodiment, the fertilizer also contains potassium and/or phosphorous.

In one embodiment, the fungicide contains a systemic carboxamide (analide), a local penetrant, such as a strobilurin (e.g., pyraclostrobin, trifloxystrobin, and the like) and/or boscolid and/or one or more sterol biosynthesis inhibitors (SBIs), such as a demethylation inhibitor (DMI) (e.g., propiconazole, tebuconazole imidazole, etc.), dicarboximides, such as iprodione, chloronitriles (e.g., chlorothalonil), and one or more succinate dehydrogenase inhibitor (SDHI) fungicides, such as penthiopyrad and flutolanil. In one embodiment, the fungicide also provides defense-priming characteristics i.e., Daconil Action (Chlorothalonil+Acibenzolar-S-Methyl), Messenger (Harpin protein), Bayer brand fungicides, and Insignia (BASF) brand fungicides, and Syngenta brand fungicides and other crop treatment products. In one embodiment, the fungicide contains disease-antagonistic bacteria (e.g., Serenade biofungicide) and fungi (e.g., Bio-Trek biofungicide) and plant defense-priming weed extracts (e.g., Regalia biofungicide). In one embodiment, an Insignia brand fungicide and/or Compass, and/or Emerald, and/or Banner Maxx and/or Torque and/or Daconil Action and/or Daconil Weather Stik and/or Bayer brand fungicides are used.

In one embodiment, for every 1 gallon (3.8 L) of active ingredient, such as one or more of any of the aforementioned fungicides, from about 1 fl. oz. (0.03 L) to about 40 fl. oz. (1.2 L) of any suitable bio-adjuvant (e.g., canola oil-containing bio-adjuvant, such as a methylated canola oil-containing bio-adjuvant) is used, such as from about 1 (0.03 L) to about 15 fl. oz. (0.44 L), such as from about 5 (0.15 L) to about 15 fl. oz. (0.44 L), such as from about 5 (0.15 L) to about 10 fl. oz. (0.3 L), such as from about 10 (0.3 L) to about 15 fl. oz. (0.44 L), including any range there between.

In one embodiment, the crop treatment concentrate or product contains at least one additional adjuvant in addition to one or more bio-adjuvants.

In one embodiment, additional components (e.g., non-adjuvant additives) useful in the biorational concentrates and products described herein are added for various purposes. Such additives can include, but are not limited to, optical or β-fluorescent brighteners, herbicide safeners (known to improve selectivity between crop plants and weed species), trace nutrients, such as salts of iron, manganese, boron, copper, cobalt, molybdenum, and/or zinc, and other additives known in the art. In one embodiment, no pH adjuster is used.

A target crop can include any type of crop as defined herein. A target crop which is turfgrass may include, but is not limited to grasses selected from Kentucky bluegrass, bent grass, buffalo grass, Bermuda grass, carpet grass, Seashore Paspalum, St. Augustine grass, Zoysia grass, annual bluegrass, ryegrass, fescues, and the like.

As noted above, the biorational concentrates and products described herein are surprisingly useful for treating a variety of target crops, i.e., for repelling, controlling, preventing and/or eliminating target pests and/or canopy moisture and/or frost, as well as stimulating, maintaining, enhancing and regulating crop qualities, such as growth, density, rooting, and color intensity, either alone or in combination with one or more commercially available active ingredients.

In various embodiments, the target pest causes total or partial consumption of the target crop (e.g., arthropods, including insects, arachnids (e.g., mites), myriapods and crustaceans), or through competition with the plant (weeds). Target pests can further include, but are not limited to animals (e.g., rodents) and nematodes.

In one embodiment, the target pest is a disease. In various embodiments, the biorational concentrates and products described herein can control, prevent and/or eliminate disease(s) (i.e., undesirable interaction between a target crop and pathogen) by controlling, preventing and/or eliminating the specific pathogen(s).

Measurement of the effectiveness of a treatment can be determined by a number of methods, depending on the purpose of the treatment. For example, effectiveness can be determined by measuring a % area of a given plot containing a disease, performing a visual rating using a uniform scale (e.g., to evaluate quality, color intensity, dew formation, etc.), weighing the target crop (growth and density), measuring the dimensions of individual plants in a target crop (e.g., growth), and so forth. Treatment effects on rooting can be determined by testing sod strength and by harvesting, drying and weighing root mass. Generally a number of random samples are measured and an average or mean is calculated.

The acceptability of the effectiveness of a treatment will vary depending on the purpose of the treatment, i.e., whether it is to repel, control, prevent or eliminate one or more target pests, to treat canopy moisture and/or frost and/or to maintain or improve crop health. Acceptability of the effectiveness also depends on the target crop and the desired end result. For example, turfgrass on a golf course or professional playing field may need to be maintained at a higher standard as compared to turfgrass on an amateur playing field, a public park, a cemetery, and the like.

With respect to disease, in particular, effectiveness is typically measured as a % area of a given plot containing the disease. A mean value of zero (%) represents total absence of disease, meaning that either the disease was never present (preventative treatment) or was completely eradicated. Such a result from a treatment product is considered “highly effective” control, which is a desirable goal on all areas of a high-budget golf course (i.e., professional golf courses), including the putting greens, tees and fairways. Such a goal is also desirable on putting greens at low-budget golf courses (i.e., amateur golf courses). However, as those skilled in the art understand, in some instances, the desired result does not require a total eradication or continued absence of disease to still be considered “highly effective” control. Such instances can include, but are not limited to, turfgrass for use on golf course fairways. In one embodiment (e.g. low-budget golf course fairways and tees), up to a “1%” mean value, e.g., for dollar spot disease, is considered “highly effective” control, although such a level would only be considered, at best “moderately effective” on high-budget golf courses. “Moderately effective” control of dollar spot on a low-budget golf course fairway and tee turfgrass may be considered to be from greater than 1% mean value up to a 3% mean value. “Minimally effective” control of dollar spot on a low-budget golf course fairway and tee turfgrass may be considered to be greater than 3% up to a 5% mean value. “Unacceptable” control of dollar spot on fairway turfgrass may be considered to be above a 5% mean value.

In other embodiments (other target crops and/or other diseases), as high as about 2% up to about 5% mean values can still be considered “highly effective” control. For yet other applications, i.e., uses, a higher % mean value of disease may still be considered highly effective, such as up to 10% mean values. Such a higher level of acceptance generally also occurs, in instances where disease is hard to control, total eradication of disease is impractical/impossible and/or the disease has a minor impact on quality, yield, etc. (e.g., Leptosphaerulina leaf blight on turfgrasses or Physoderma brown spot on corn).

In one embodiment, with respect to pink snow mold on golf course fairway turfgrass, up to a lto 2% mean value is still considered “highly effective” control. “Moderately effective” control of pink snow mold on fairway turfgrass may be considered up to 2% or 3% mean value. “Minimally effective” control of pink snow mold on fairway turfgrass may be considered up to a 5% mean value. “Non-effective” control of pink snow mold on fairway turfgrass is generally considered to occur when the mean value is greater than 5%. Generally speaking, acceptable levels of pink snow mold are much lower on golf course putting greens, where no level of pink snow mold is tolerated and a pink snow mold-free turf is achievable.

In one embodiment, with respect to crown rot anthracnose on low-budget golf course fairway turfgrass, a 1 to 2% mean value is still considered “highly effective” control. “Moderately effective” control of crown rot on fairway turfgrass may be considered to be from greater than 2% mean value up to 5% mean value. “Minimally effective” control of crown rot on a low-budget fairway turfgrass may be considered to be from greater than 5% mean value up to 7% mean value. “Non-effective” control of crown rot on low-budget golf course fairway turfgrass is generally considered to occur when the mean value is greater than 7%. Generally speaking, acceptable levels of crown rot anthracnose are much lower on low-budget golf course putting greens, where a 2% to 3% mean value of disease is the minimally effective level of control. On high-budget golf course turf, a mean value of crown rot anthracnose of 1% or less is the minimally effective control level on putting greens, while the minimally effective level of disease control on fairways is greater than a 1% mean value up to a 3% mean value.

In one embodiment, addition of up to 1% v/v or up to 5% v/v or up to 10% v/v of a canola oil-containing bio-adjuvant (including a methylated, ethylated or butylated canola oil-containing bioadjuvant) to a reduced amount of commercial fungicide, such as a fungicide containing prodione and/or trifloxystrobin and/or urea or UAN fertilizer, together with a pigment (e.g., copper phthalocyanine) and a non-ionic organosilicone surfactant based on a trisiloxane ethyoxylate (e.g., Silwet L-77, Helena Chemical Co.) provides control of dollar spot on turfgrass at an effectiveness at least as much as or better than the label amount of the commercial fungicide. In one embodiment, the reduced amount of fungicide and/or fertilizer is reduced at any of the levels or ranges mentioned herein, including, but not limited to, at least a 25% v/v reduced amount, down to at least a 50% reduced amount, down to at least a 75% reduced amount of commercial fungicide and the effectiveness (measured as a mean value of % of disease in a given plot area) is 1 or less, such as 0.9 or less, 0.8 or less, 0.7 or less, 0.6 or less, 0.5 or less, 0.4 or less, 0.3 or less, 0.2 or less, 0.1 or less down to 0 (no disease). In one embodiment, plant density with such a treatment is at least as good, or better, than the plant density obtained using a label amount or higher amount of the commercial fungicide or fertilizer.

In various embodiments, levels of effectiveness are evaluated with respect to dew suppression (canopy moisture) frost control, plant quality, plant density and/or plant growth.

In one embodiment with respect to dew suppression on turfgrass, a mean value (based on a visual rating scale) up to 20% is still considered “highly effective” suppression. “Moderately effective” dew suppression on turfgrass may be considered up to 30 mean %, including up to a 35% mean value. “Minimally effective” dew suppression may be considered up to 40% mean value. “Non-effective” dew suppression on turfgrass is generally considered to occur when the mean value is greater than 50%. Dew suppression effectiveness levels on other target crops other than turfgrass may be similar, but depend on the desired suppression required for a particular use and/or a particular time period.

In one embodiment, with respect to frost control on turfgrass, a mean value (based on a visual rating scale) up to 20% is considered “highly effective.” “Moderately effective” frost control on turfgrass may be considered up to 30% mean value in some embodiments and up to a 35% mean value in other embodiments. “Minimally effective” frost suppression may be considered up to a 40% mean value. “Non-effective” frost control on turfgrass is generally considered to occur when the mean value is greater than 50%. Frost control effectiveness levels on other target crops other than turfgrass may be similar, but depend on the desired control required for a particular use and/or a particular time period.

In one embodiment, with respect to biomass increase through increased density and growth of turfgrass, a mean value (based on a dry weight measurement) up to 40% dry weight increase is considered “highly effective” density or “highly effective” biomass increase. “Moderately effective” biomass increase of turfgrass may be considered up to 20% or 30% dry weight increase. “Minimally effective” biomass increase may be considered up to 10% mean value. “Poor” biomass increase of turfgrass is generally considered to occur when the mean value is less than 10% dry weight increase over the untreated control or the individual bioconcentrate/bio-adjuvant components applied individually.

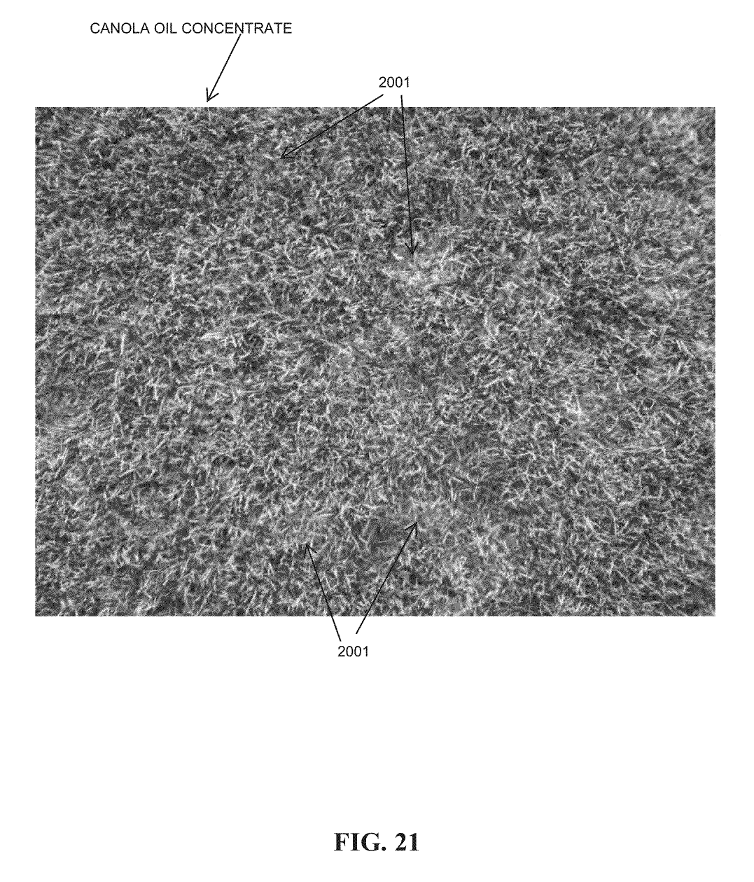

In some embodiments, delivery of a composition (e.g., biorational concentrate or biorational treatment product) comprising plant oils and/or glycerol optionally, with a surfactant) has minimal impact with respect to biomass increase and/or disease control of the target crop. Additionally, application of a biorational concentrate containing only plant oils and/or glycerol (and, optionally, a surfactant) without other additives (such as a colorant), to a dollar spot infected target crop, such as turf grass, can surprisingly cause a flare up in fungus growth. See, for example, FIG. 21 which shows areas 2001 of increased dollar spot fungus growth on a dollar spot infected turfgrass area treated five days earlier with a canola oil concentrate (food grade canola oil and a commercial surfactant). (See Table 1). As such, it is surprising that the addition of a biorational concentrate as a bio-adjuvant to a commercial pest control product, such as a commercial fungicide, allows for a reduced amount of the commercial product to be used, while retaining comparable or even improved results, as discussed further herein and in the Examples.

In one embodiment, delivery of a composition comprising a colorant and a plant oil and/or glycerol is useful as a growth promoter and/or as a target pest (e.g., disease) controller. In one embodiment, delivery of a composition containing the plant oil and/or glycerol in combination with the colorant provides better control of disease and promotes growth better than either component used individually. As such, in one embodiment, the plant oil fraction and/or glycerol fraction is synergistic with the colorant fraction, such that the plant oil fraction and/or glycerol fraction improves the efficacy of the colorant's growth promotion and disease control characteristics. In other embodiments, the plant oil fraction and/or glycerol fraction is additionally or alternatively synergistic with the active ingredient. While not wishing to be bound by this proposed theory, it is likely that the plant oil and/or glycerol improves the efficacy of components capable of providing treatment (e.g., active ingredients) through at least increased plant absorption, slower drying time, longer plant surface retention, or a combination thereof, including other mechanisms understood by those skilled in the art. Other factors for these surprising results may also be present.

In one embodiment, the biorational concentrates and products described herein allow for use of a conventional crop treatment concentrate or product, such as a commercially available active ingredient, to be used “off-label” as defined herein.

In one embodiment, the biorational concentrate or product provides control of a fungus, such as dollar spot, when used together with commercial fungicides not otherwise labeled for control of dollar spot. In one embodiment, the biorational concentrate or product and fungicide are tank-mixed.

As such, use of the biorational concentrates and products in this manner may broaden the pest control scope of a variety of fungicides, such that label modifications may be appropriate. For example, it is likely that a fungicide, such as a systemic carboxamide (analide) fungicide labelled only for use against dollar spot, when formulated with a suitable amount of the biorational concentrate as a bio-adjuvant, can become effective to control or reduce another target pest. In one embodiment, a strobilurin fungicide, which is not recommended in the art for dollar spot control, can, surprisingly, provide highly effective control against dollar spot when formulated with a biorational bio-adjuvant, such as a plant oil bio-adjuvant, including, for example, a canola oil or methylated canola oil-containing bio-adjuvant.

Similarly, a fungicide containing one or more sterol biosynthesis inhibitors (SBIs), such as a demethylation inhibitor (DMI) (e.g., propiconzoles, tebuconazoles imidazoles, dicarboximide, chloronitrile (e.g., chlorothalonil), when formulated with a suitable amount of a bio-adjuvant, may become even more effective in controlling or reducing dollar spot and/or other diseases and/or may exhibit less disease resistance.

In one embodiment, a biorational concentrate or product containing glycerol is useful for controlling target pests, such as dollar spot. In one embodiment, glycerol is used in a composition with no added surfactant.

In one embodiment, glycerol is formulated with a pigment (e.g., chlorinated copper phthalocyanine) in any suitable proportion, such as about 1:1 to about 50:1, 1:1 to about 25:1, including any range there between. In one embodiment, an agriculturally active ingredient, such as fungicide or fertilizer is also added, in lesser amounts than if used alone. In one embodiment, a biorational treatment product containing glycerol is useful for controlling target pests such as dollar spot.

In one embodiment, the colorant is a type of paint which causes faster biomass increase as compared to a pigment alone. In one embodiment, the colorant is a type of paint which may control target pests, such as dollar spot better than a pigment alone, due to the faster biomass increase. In one embodiment, the biorational concentrate or product contains neem oil and a paint, which may cause even faster crop biomass increase as compared to other plant oil/colorant or mineral oil/colorant combinations, when biomass increase acceleration is desirable.

In one embodiment, growth is slower than with conventional mineral oil-containing concentrates or products, thus reducing problems associated with excessive growth on putting greens (slow putting speeds, etc.). In one embodiment, growth effects are controlled, such as on putting greens, with use of a plant oil- or glycerol-containing product, such as a canola oil-containing concentrate or product.

In one embodiment, the biorational concentrates and products described herein surprisingly provide a longer growing season in a given geographical area, resulting in increased plant biomass (“biomass”), i.e., increased plant material as a result of vertical growth of a single plant through leaf elongation and/or lateral plant production (referred to generally herein as “individual plant growth”) and/or growth through tillering and rhizome production (referred to generally herein as “overall density increase”), as compared to the growing season and biomass increase currently expected with conventional concentrates and products. The mechanism or mechanisms which allow for such surprising results are not yet clearly understood.

Certain crops, such as vascular plants (e.g., grasses, such as turfgrass), are also at risk of harm as a result of canopy moisture, i.e., remaining too wet for extended periods. Wetness can be caused by guttation (e.g., exudation of drops of xylem sap on the tips or edges of leaves of grasses) or dew (which condenses from the atmosphere onto a plant's surface.

In various embodiments, droplet formation suppression is also possible with application of the crop treatment concentrate or product to a target crop, such as a vascular plant. When droplet formation from dew or guttation is suppressed, the vascular plant is able to dry sooner than an untreated vascular plant. In various embodiments, this effect is strongest immediately after application of the crop treatment concentrate or product and gradually subsides over the next week or so, such as up to 10 days. In one embodiment, this effect occurs with repeated application, such as a weekly or bi-weekly schedule. Since persistent canopy moisture, such as from dew, is known to be associated with an increased dollar spot incidence, treatments that reduce canopy moisture, such as from dew, reduce dollar spot pressure, as is known in the art. As such, in various embodiments, reduction of canopy moisture can contribute to improved target pest control.

In one embodiment, frost incidence can be suppressed with use of the various biorational concentrates and products described herein. Suppression of frost is particularly useful on athletic turfs used early in the morning, such as golf courses. Since morning frost delays golf play, treatments that reduce frost allow golf course managers to open their courses to play earlier in the day than on courses where frost accumulates normally.

The various biorational concentrates and products described herein may be delivered to the plant in any suitable manner, such as via spray, foam, mist, injection into irrigation, as granular treatment concentrates and products (baits, lures, etc.), dessicants, insecticides, antidessicants, and so forth, using any suitable delivery means, as defined herein. This includes application of the treatment as a soil drench. In one embodiment, the various plant oil and/or glycerol formulations are blended with water in a spray solution, together with one or more pigments, paints and/or dyes and a surfactant to aid the mixing of the plant oil with water in the spray solution, while also coloring the turfgrass green.

The biorational concentrates and products can be applied to the target crop at any suitable rate. In one embodiment, from about 1 ounce (oz.) (0.03 L) and about 10 oz. (0.3 L), such as from about 1 oz. (0.03 L). to about 8 oz. (0.24 L), such as from about 1 oz. (0.03 L) to about 6 oz. (0.18 L), such as from about 1 oz. (0.03 L) to about 5 oz. (0.15 L), such as from about 1 oz. (0.03 L) to about 3 oz. (0.09 L), including any range there between, such as less than about 10 oz. (0.3 L), less than about 9 oz. (0.27 L), less than about 8 oz. (0.24 L), less than about 7 oz. (0.21 L), less than about 6 oz. (0.18 L), less than about 5 oz. (0.15 L), less than about 4 oz. (0.12 L), less than about 3 oz. 0.09 L), or less than about 2 oz. (0.06 L), is combined with a carrier in an amount of from about 30 gal (113.6 L) to about 70 gal (265 L), such as from about 38 gal (143.9 L) to about 58 gal (219.6 L), such as from about 45 gal (170.3 L) to about 50 gal (189.3 L), including any range there between, to an area having a size of about 700 sq. ft. (65 m²) about 1300 sq. ft. (120.8 m²), such as from about 8 sq. ft. (0.74 m²) to about 1200 sq. ft. (111.5 m²), such as from about 900 sq. ft. (83.6 m²) to about 1100 sq. ft. (102.2 m²), such as at least 1000 sq. ft. (93 m²), such as no more than 1000 sq. ft. (93 m²), including any range there between.

In one embodiment, from about 30 gallons per acre (GPA) (or 1.1 gal/1000 sq. ft.) (244.2 liters per hectare (L/ha)) to about 100 GPA (or 2.2 gal/1000 sq. ft.) (934.67 L/ha), such as from about 40 GPA (373.87 L/ha) to about 100 GPA (934.67 L/ha), such as from about 48 GPA 448.64 L/ha to about 98 GPA (915.98), including any range there between. In these embodiments, each approximately 1.1 to 2.2 gal (4.17 to 8.3 L) of carrier is used with any suitable amount of biorational concentrate or bio-adjuvant, such as about 1 fl. oz. (29.6 ml) to less than 32 fl. oz. (0.95), such as from about 1 fl. oz. (29.6 ml) to about 30 fl. oz. (0.09 L), such as from about 5 fl. oz. (0.15 L) to about 15 fl. oz. (0.44 L), such as from about 8 fl. oz. (0.24 L) to about 12 fl. oz. (0.35 L), such as no more than or no less than 10 fl. oz. (0.3 L).

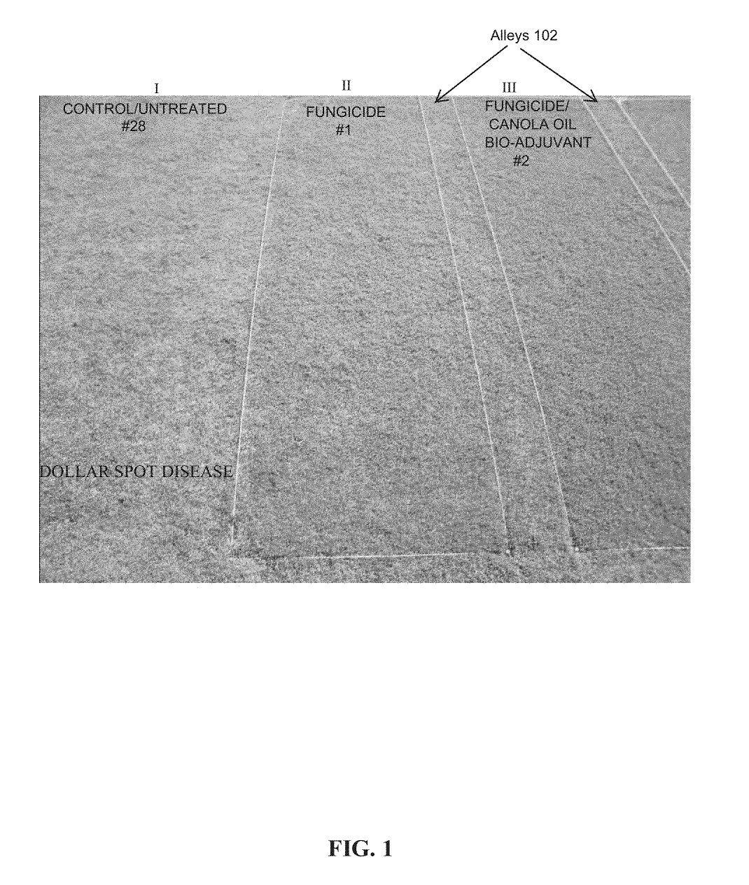

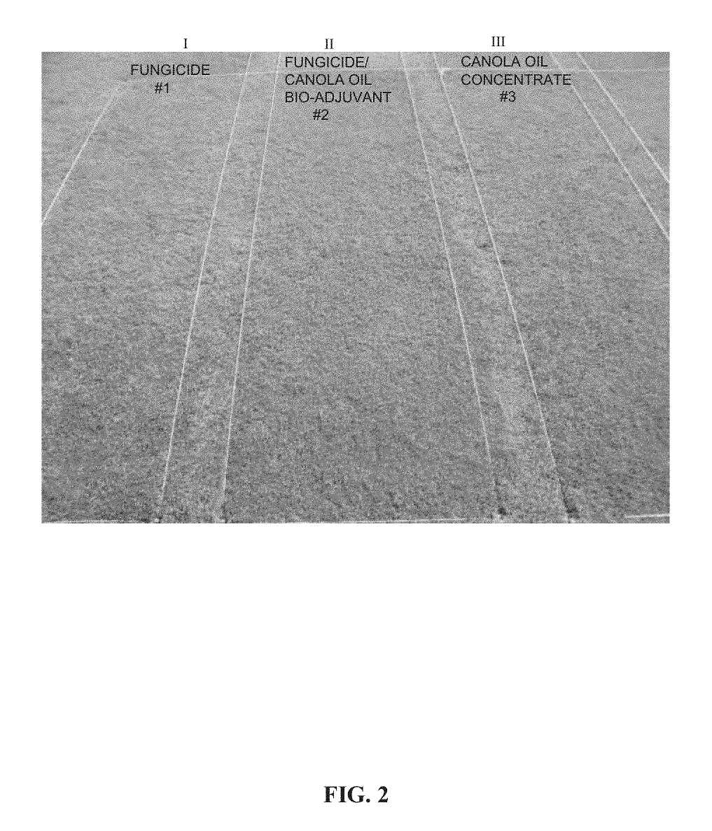

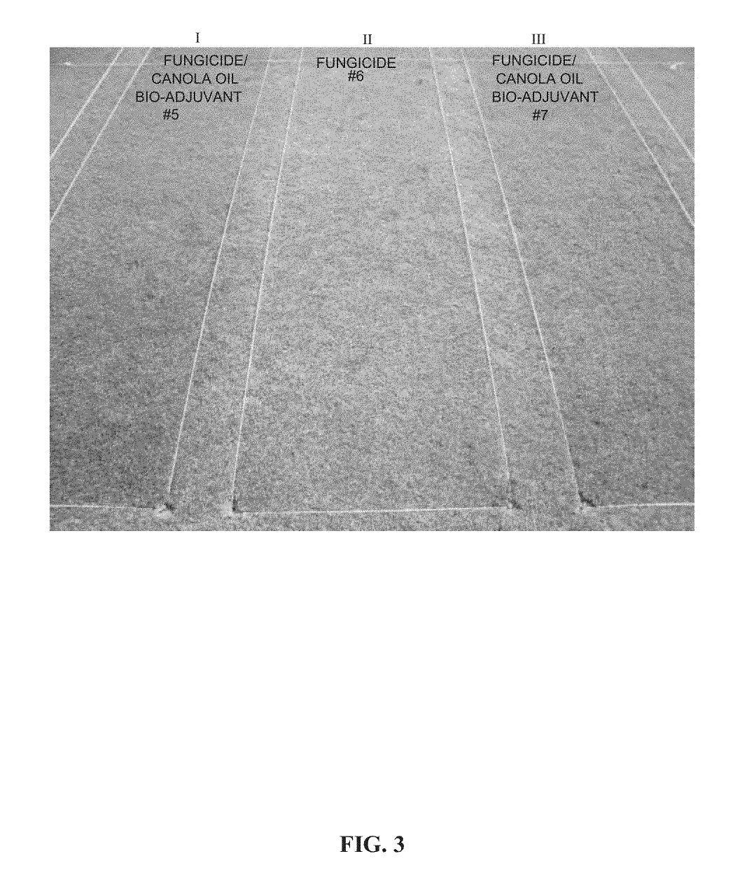

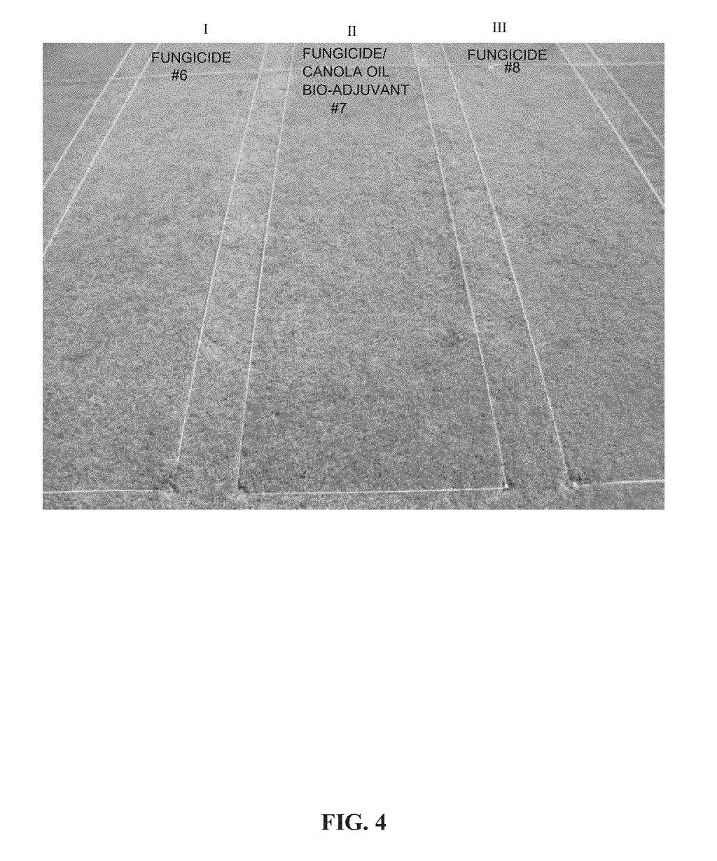

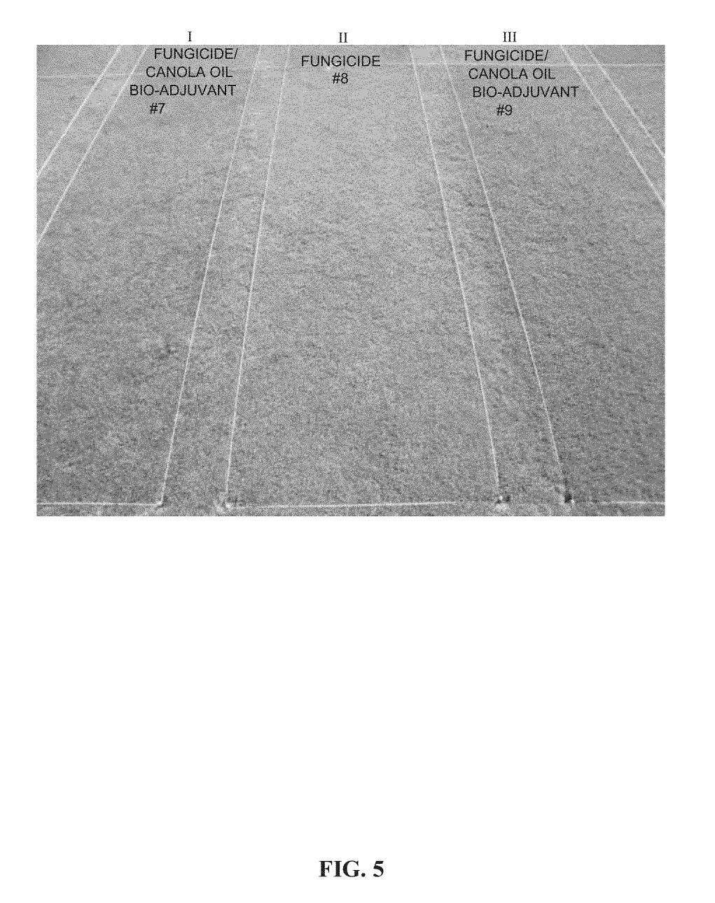

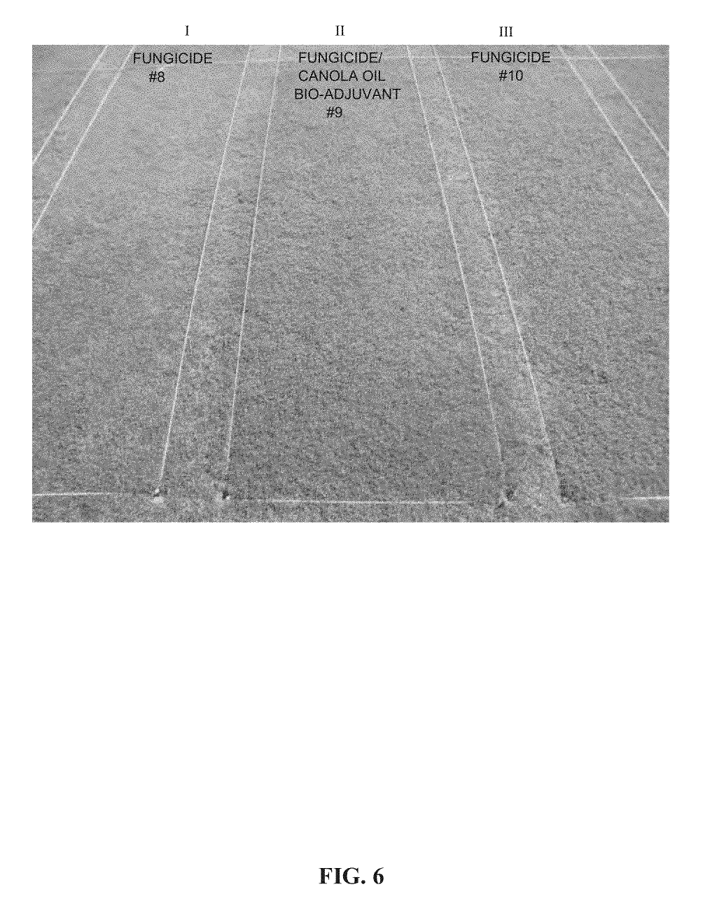

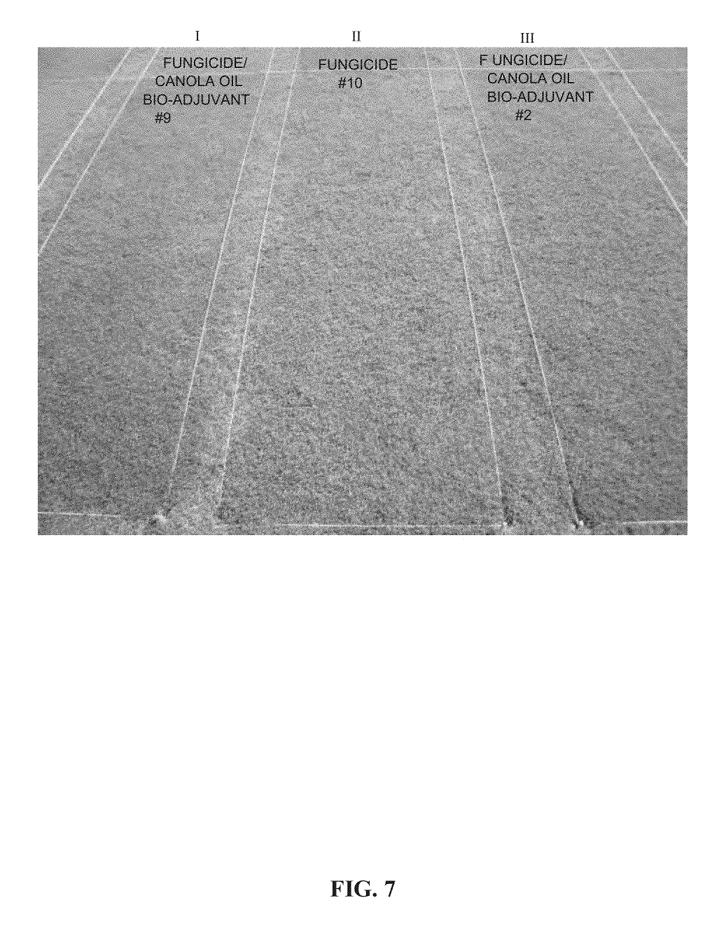

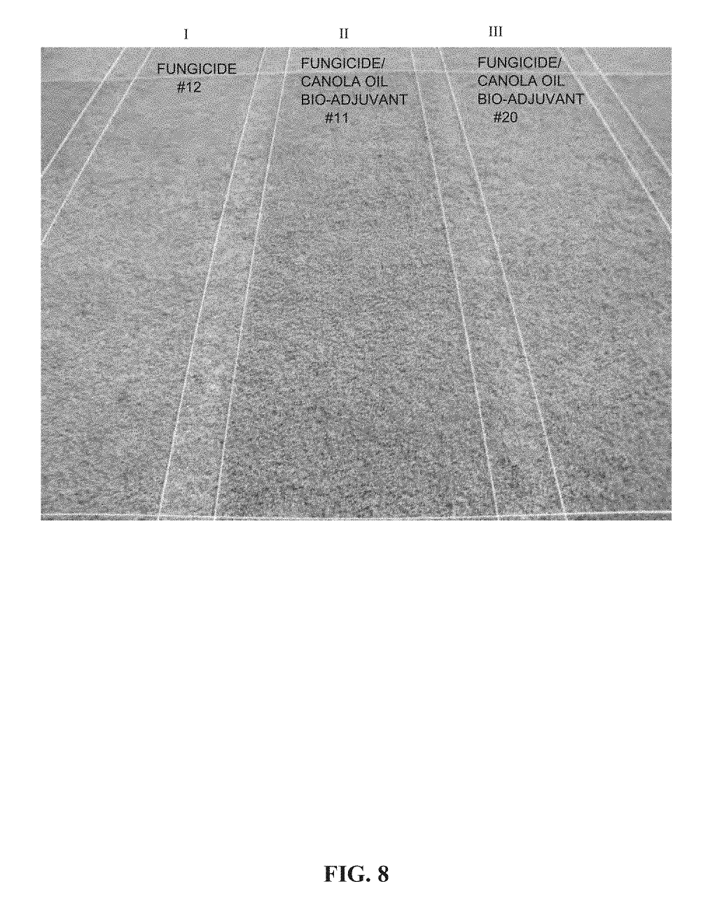

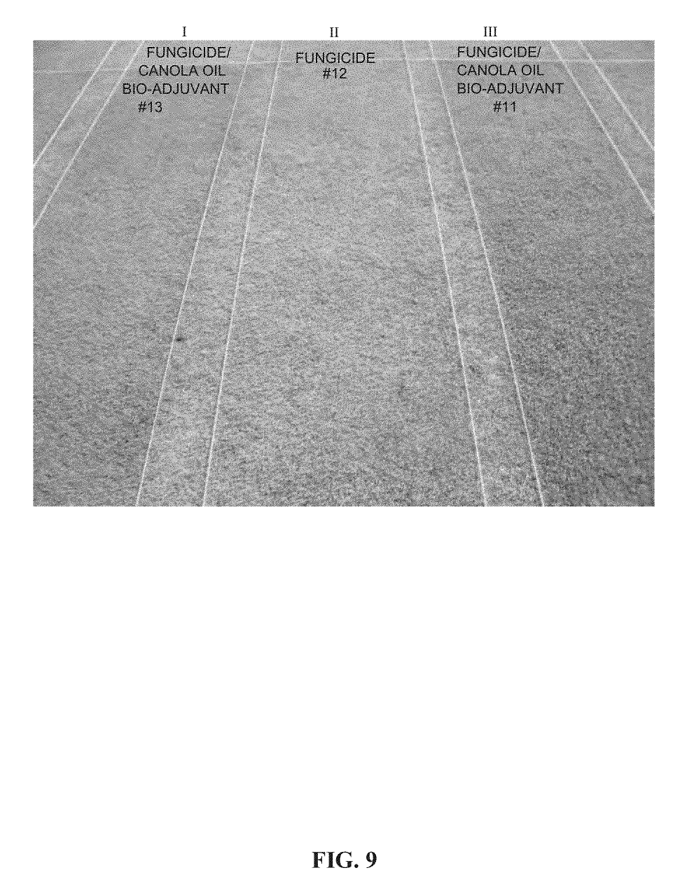

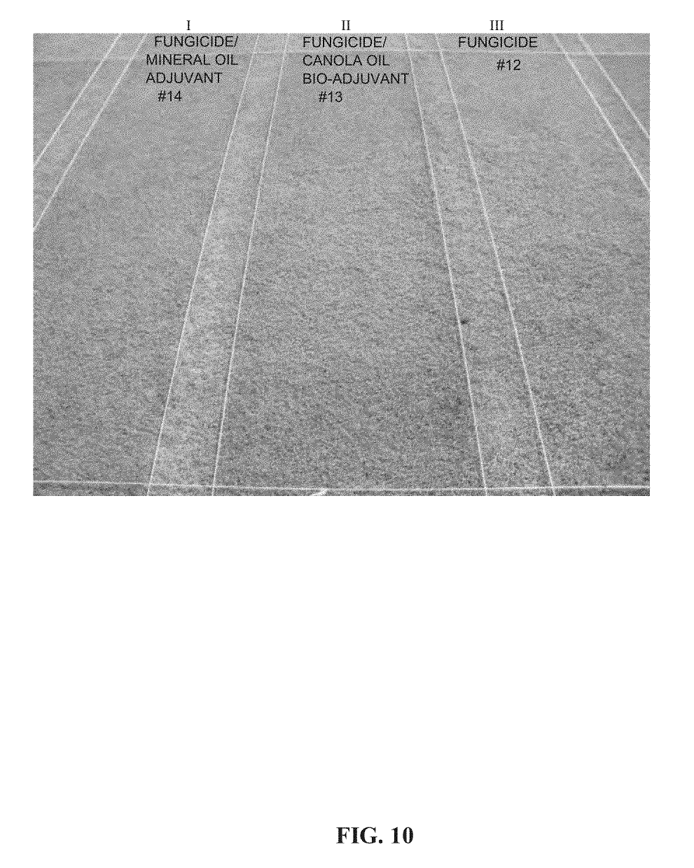

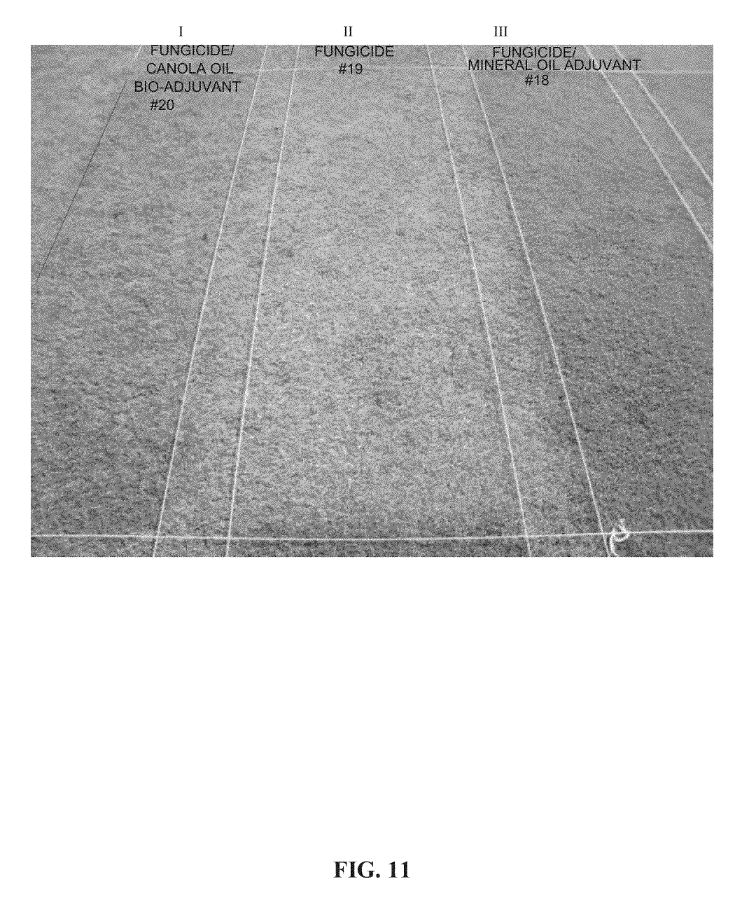

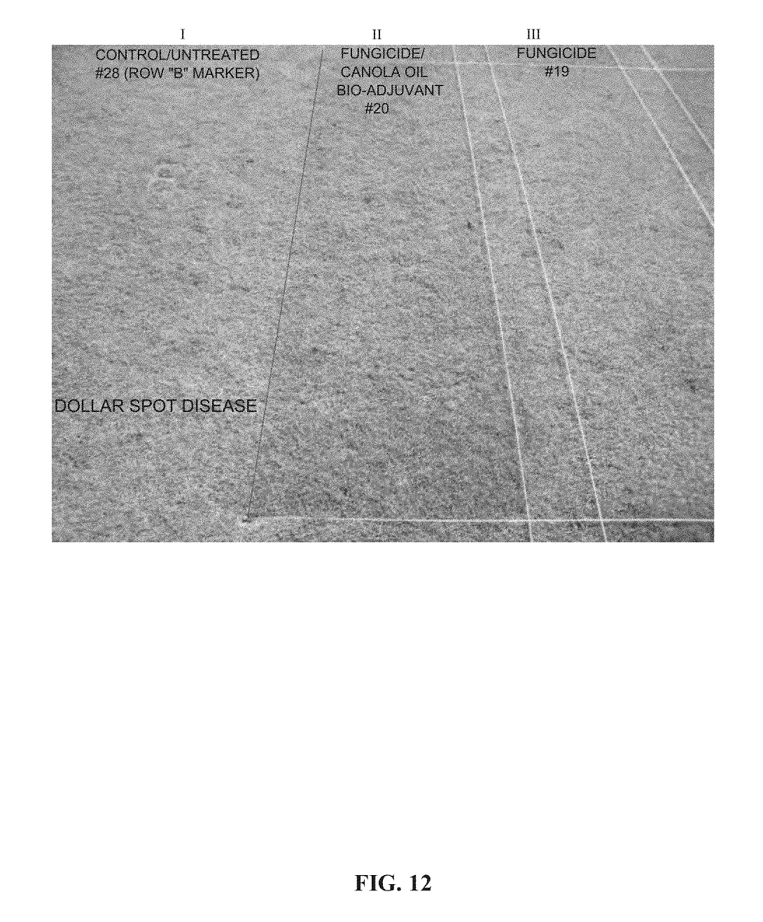

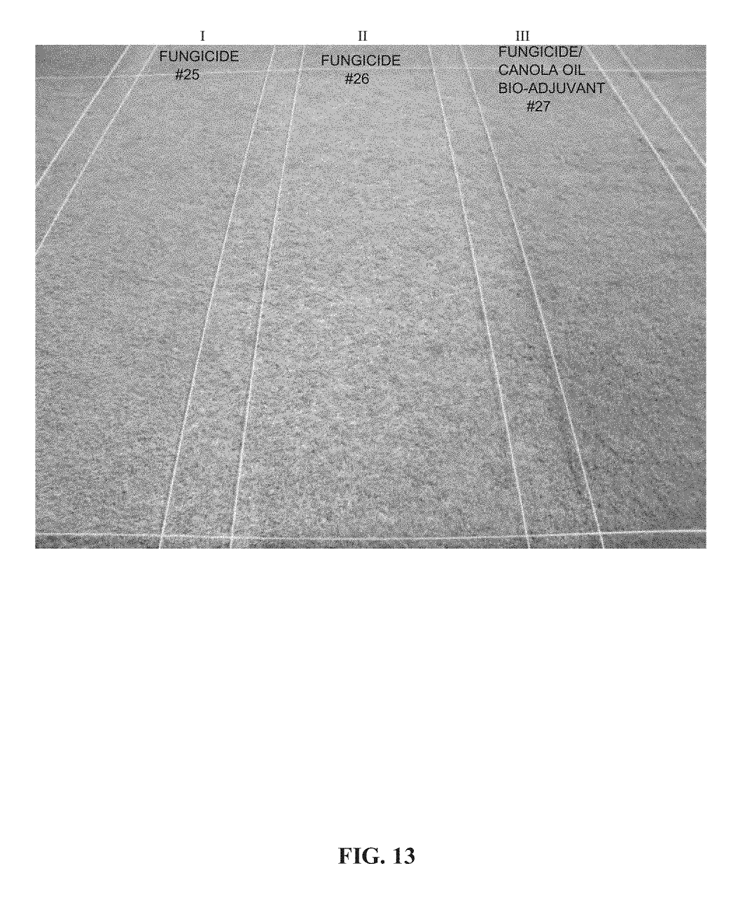

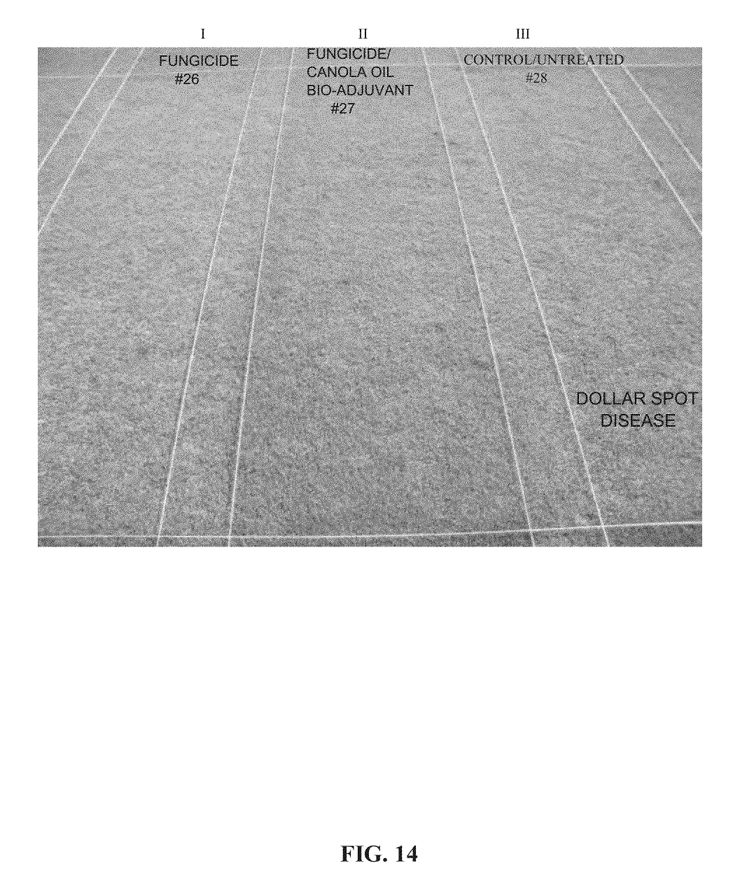

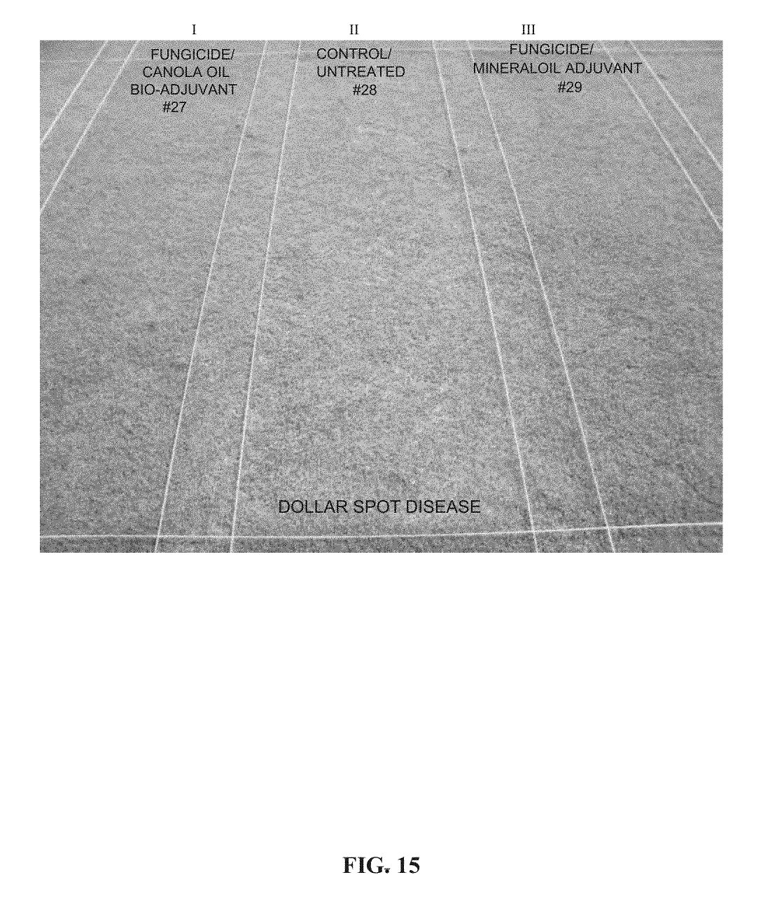

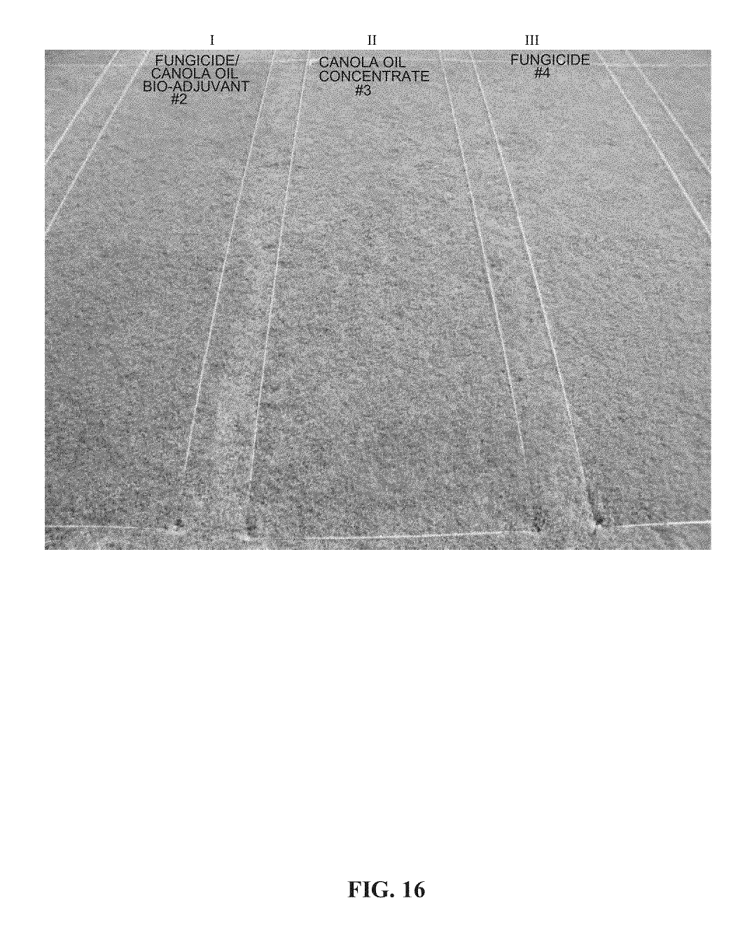

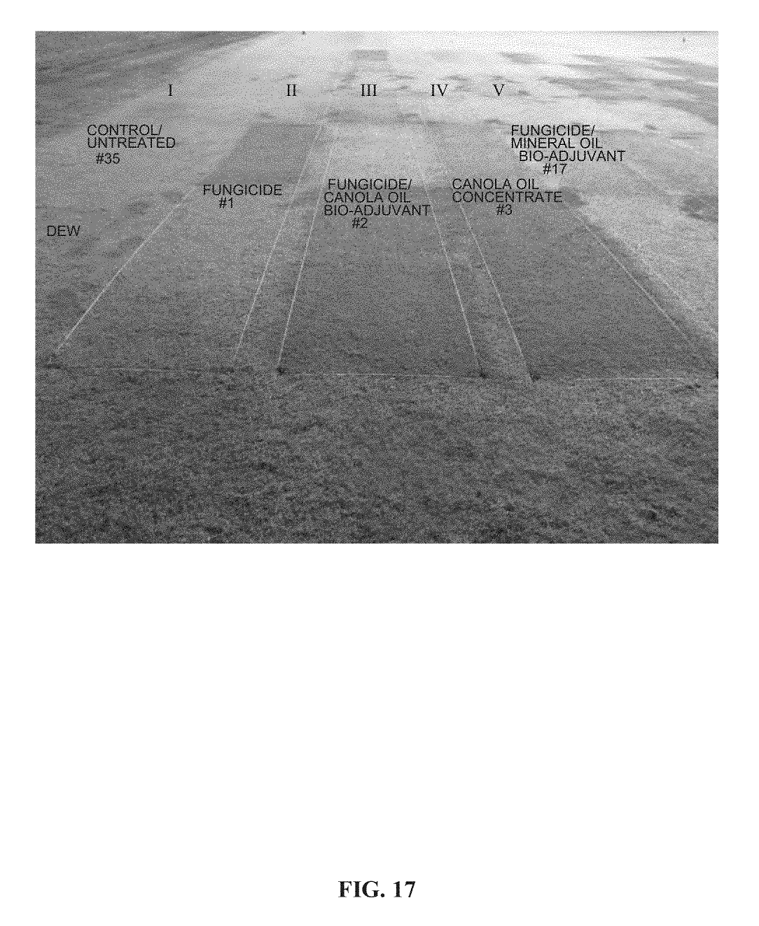

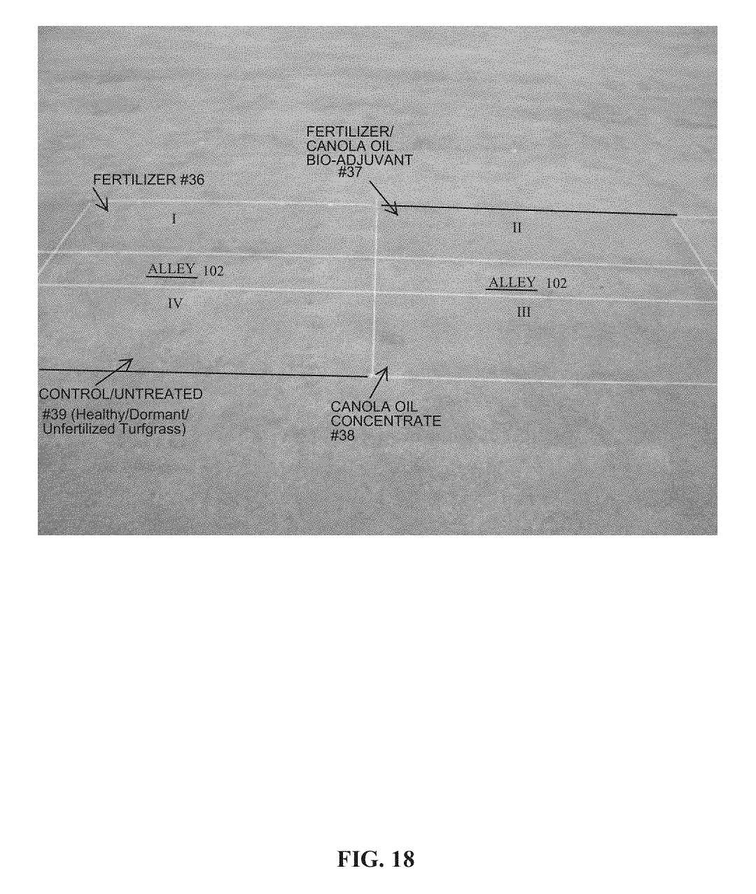

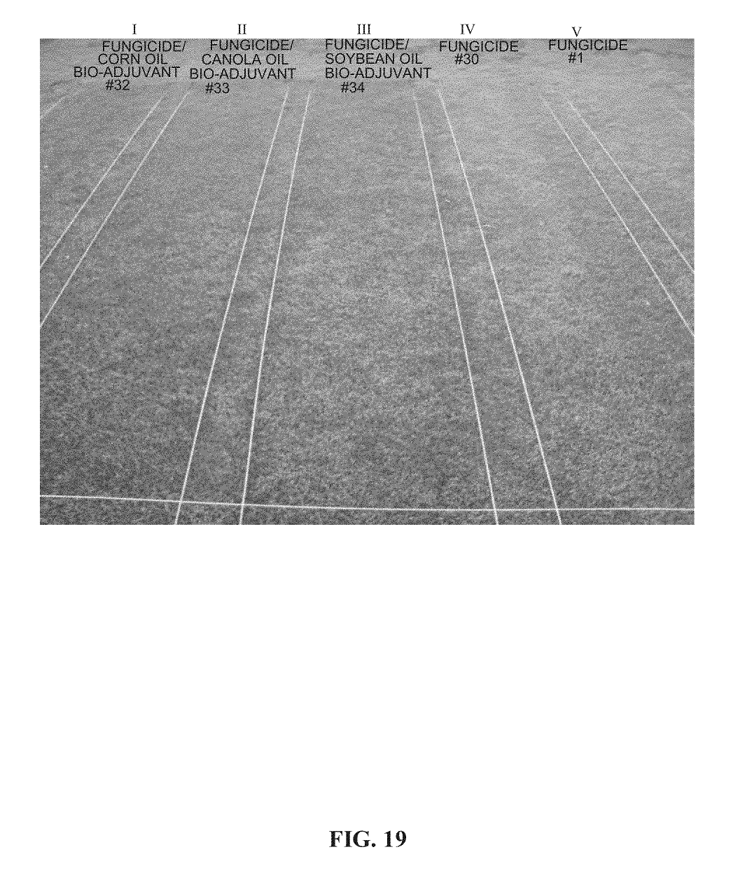

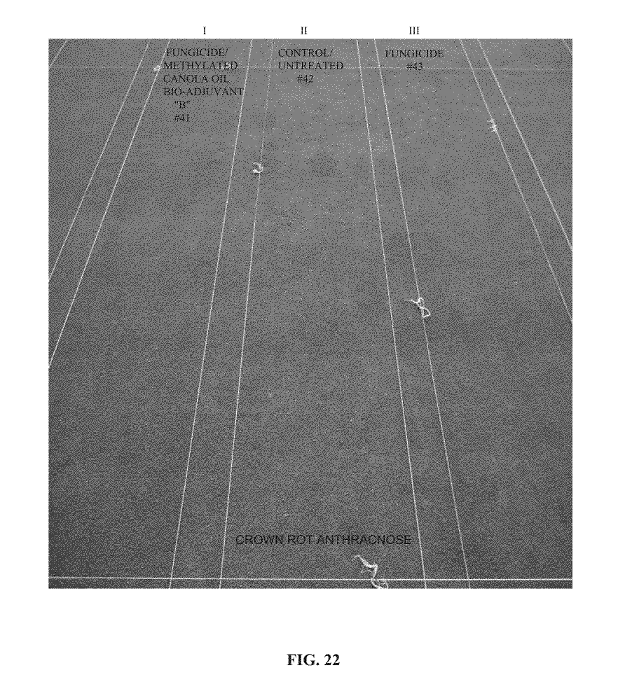

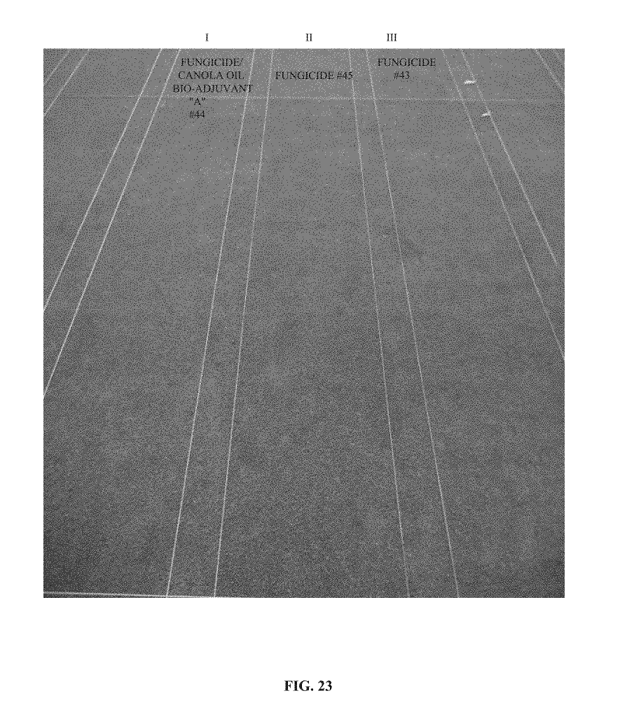

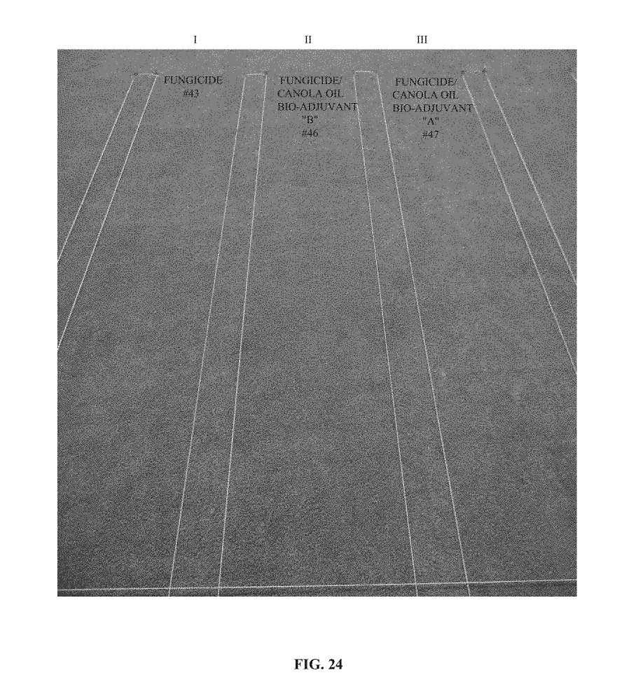

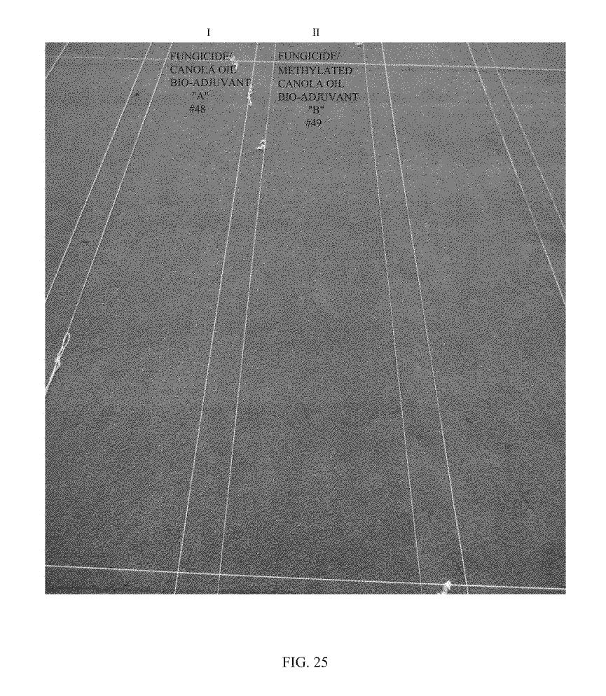

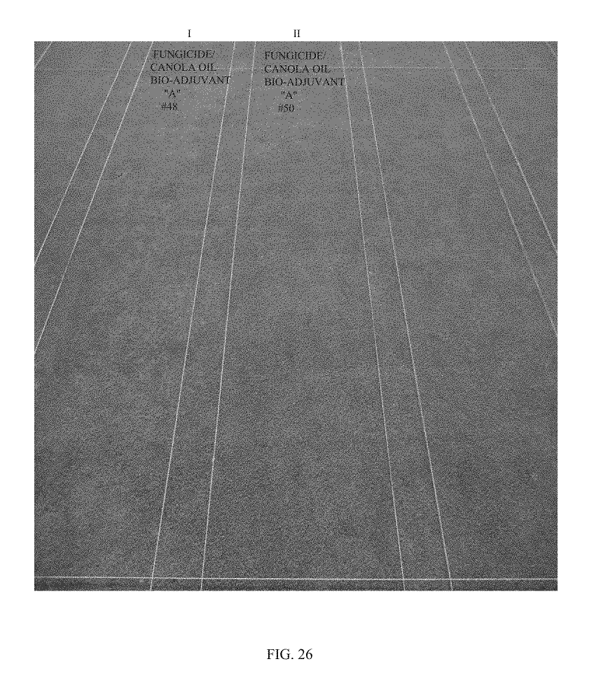

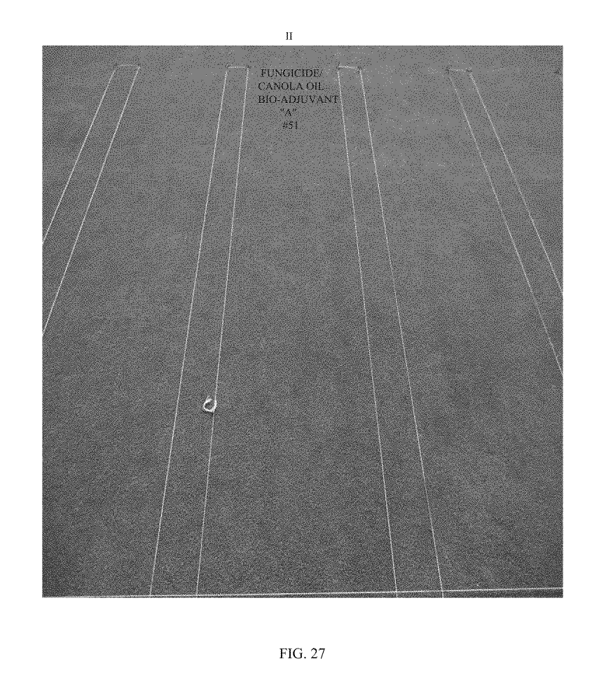

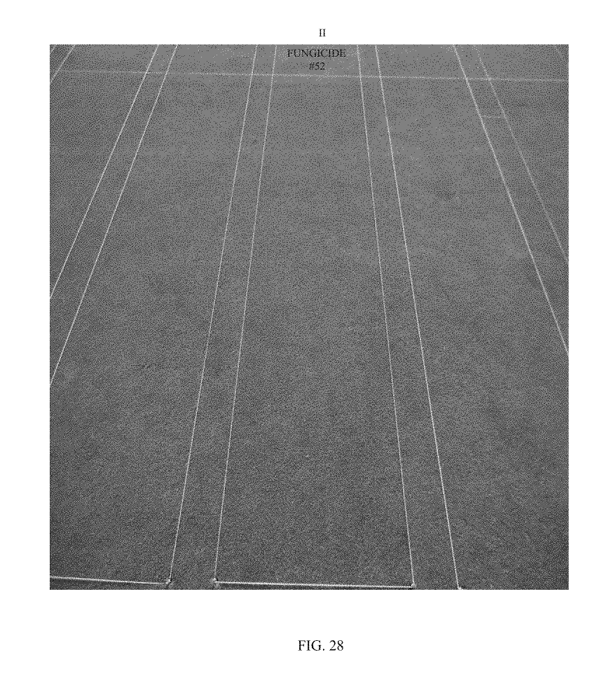

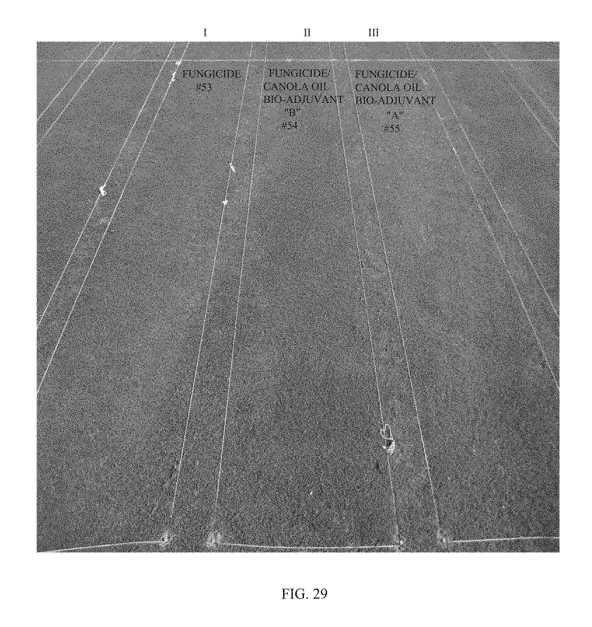

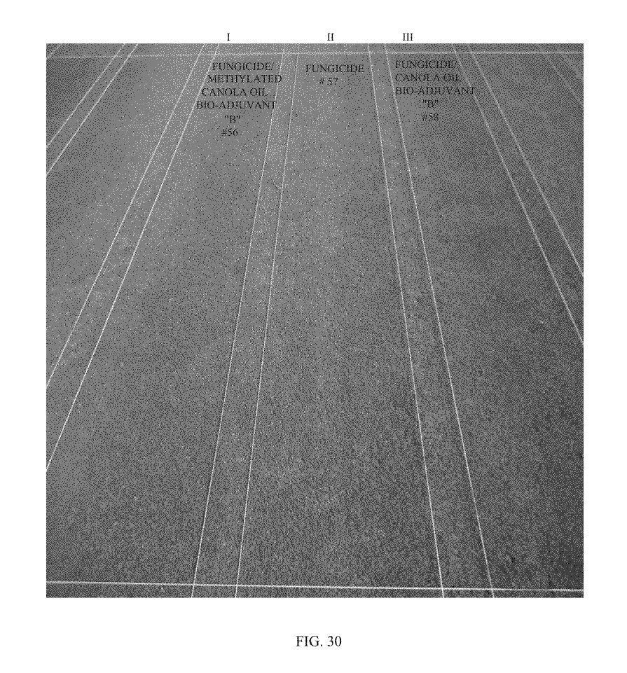

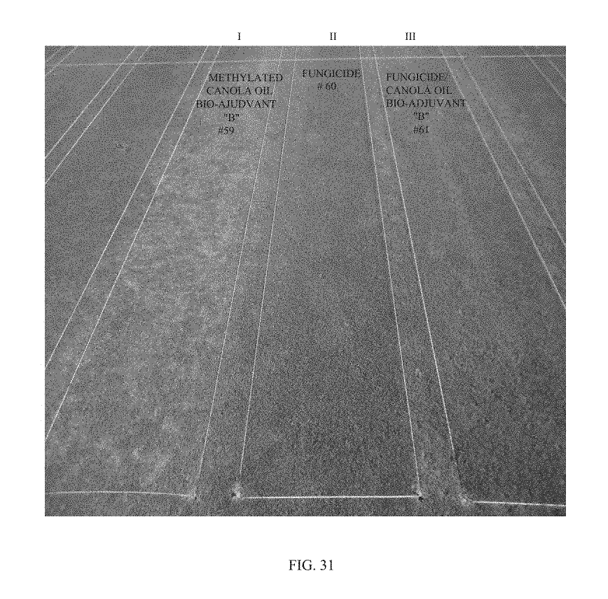

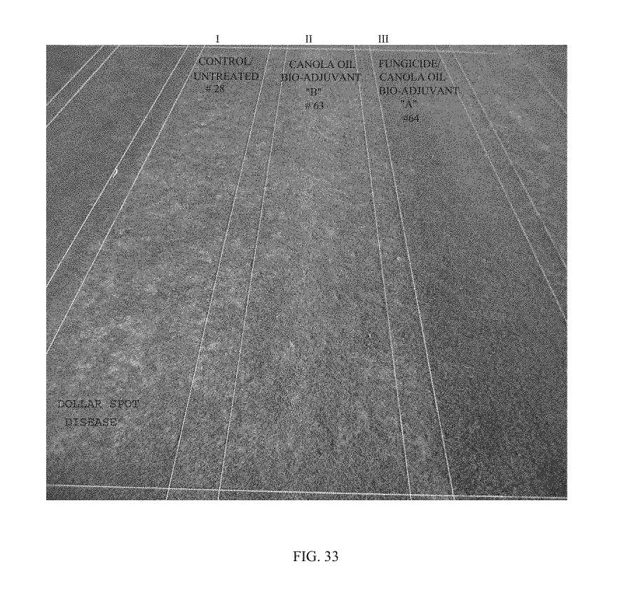

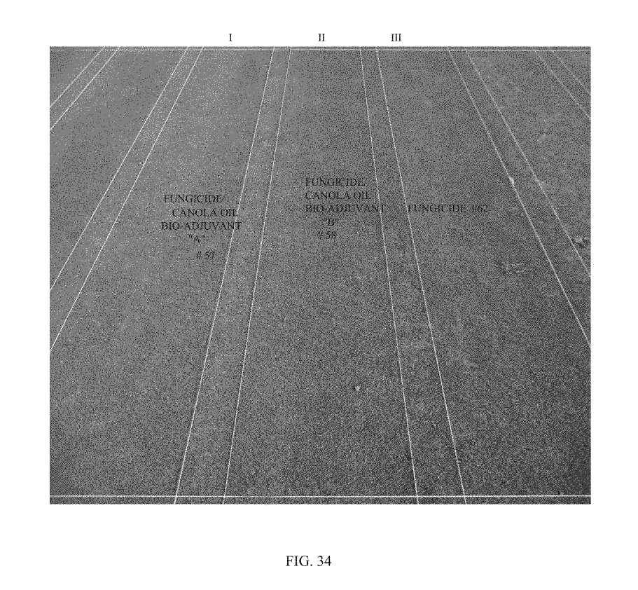

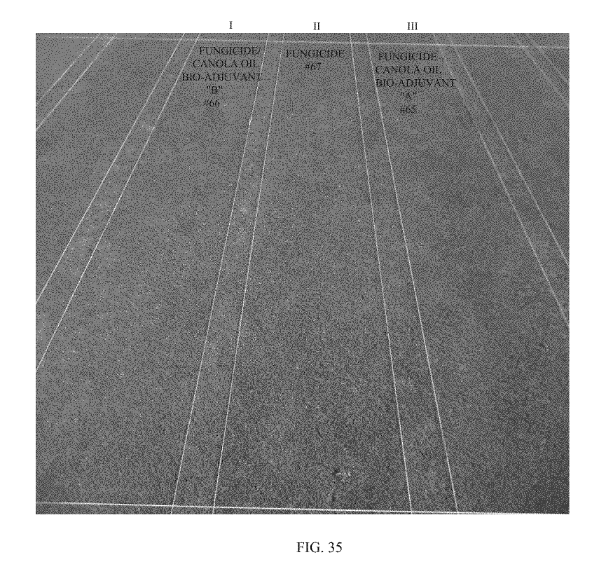

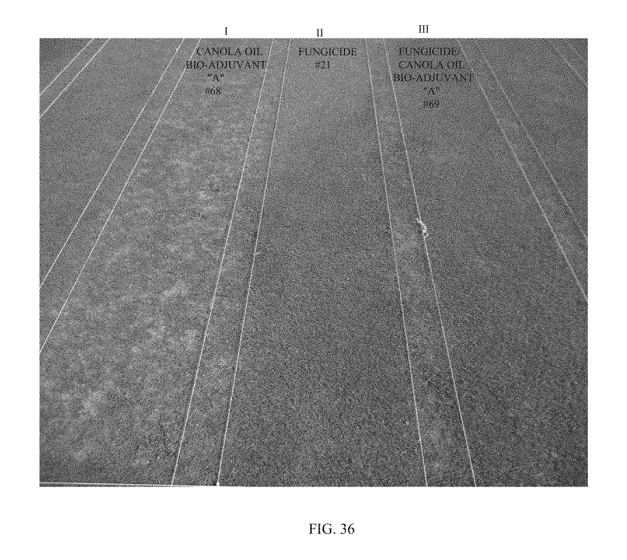

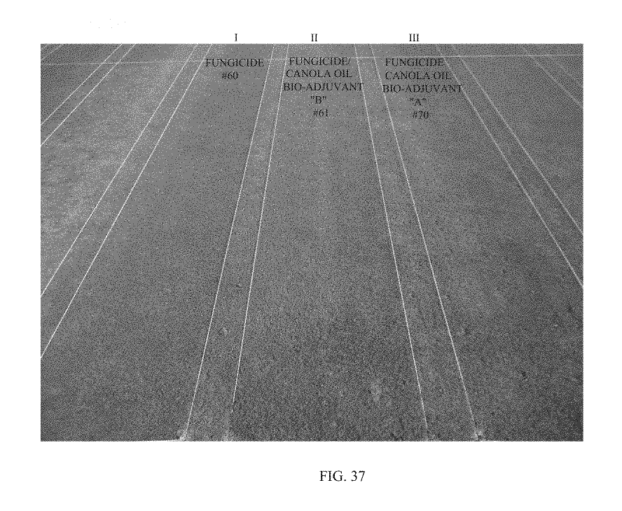

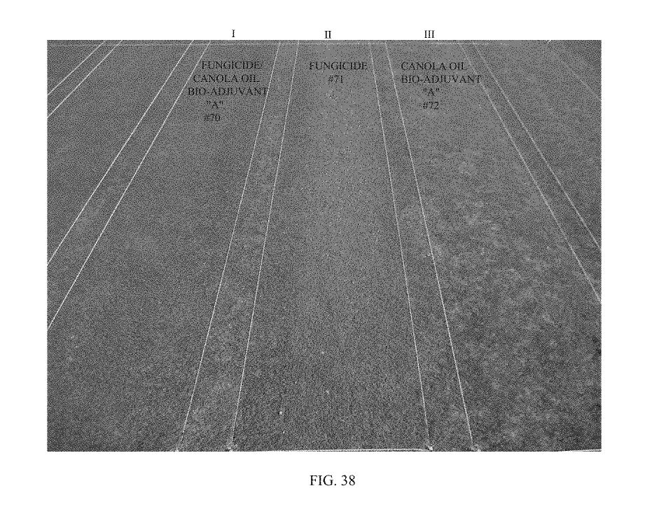

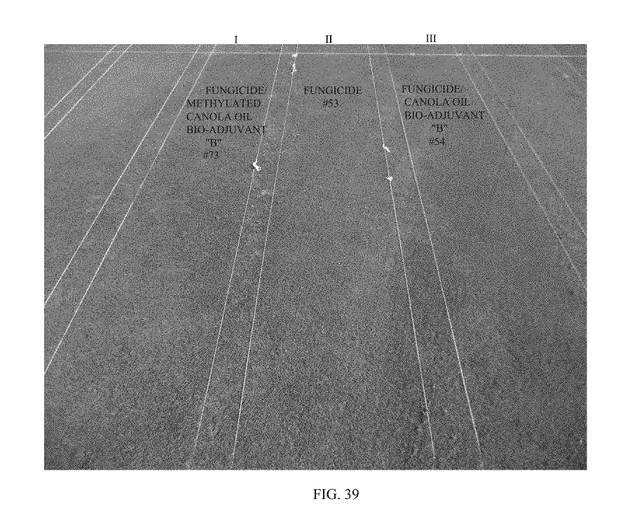

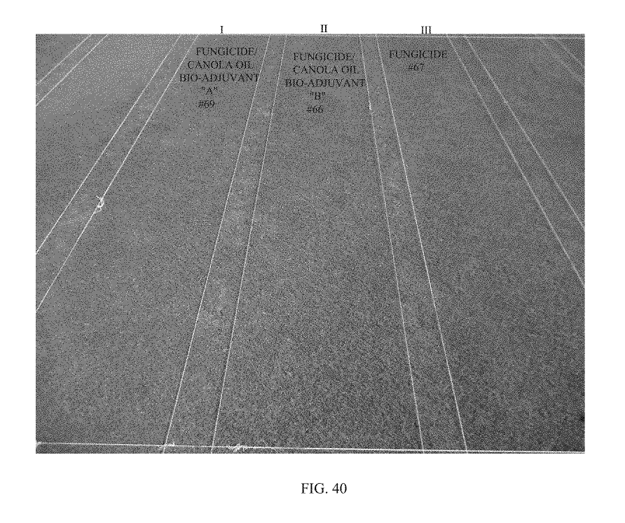

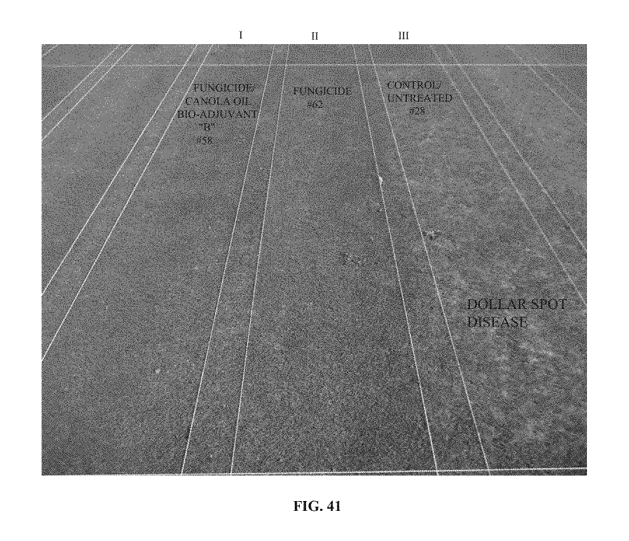

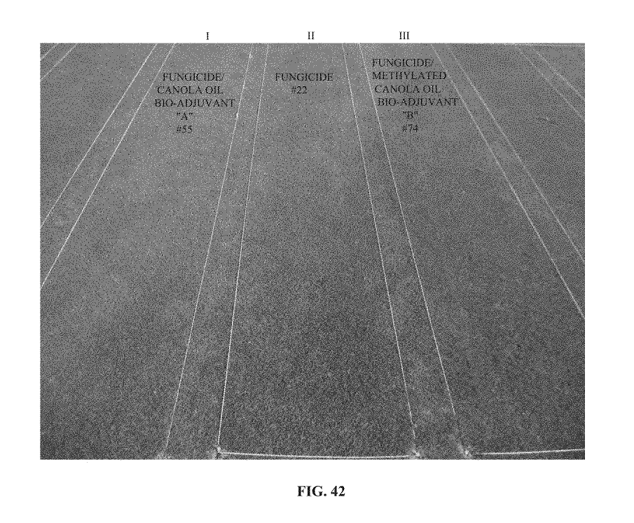

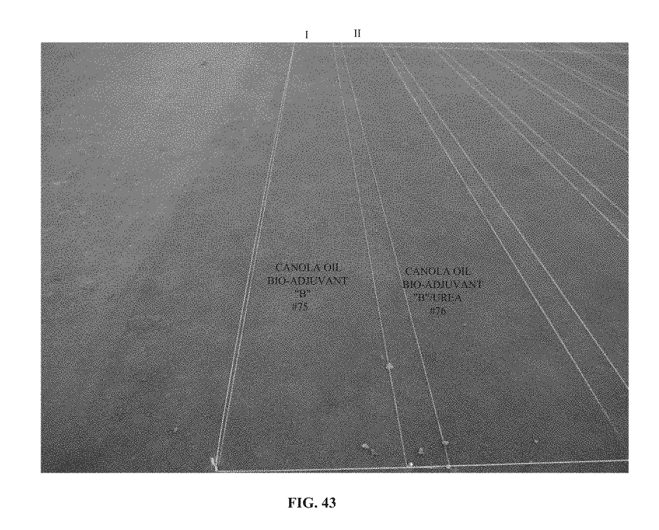

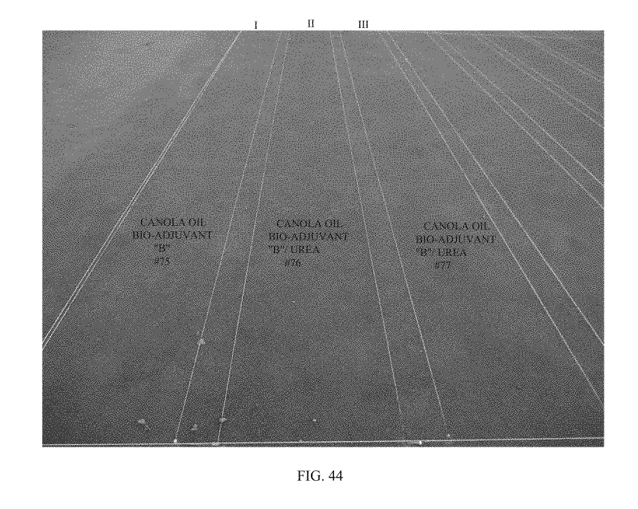

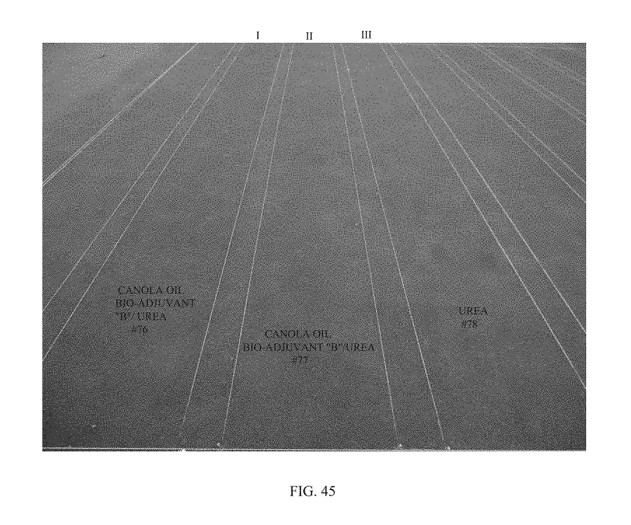

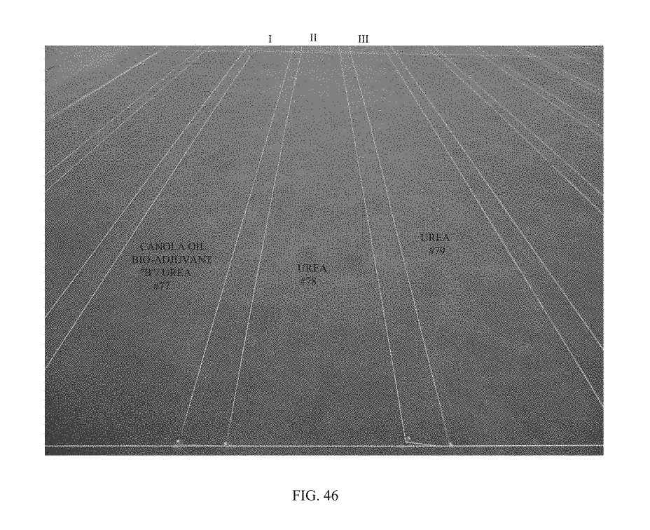

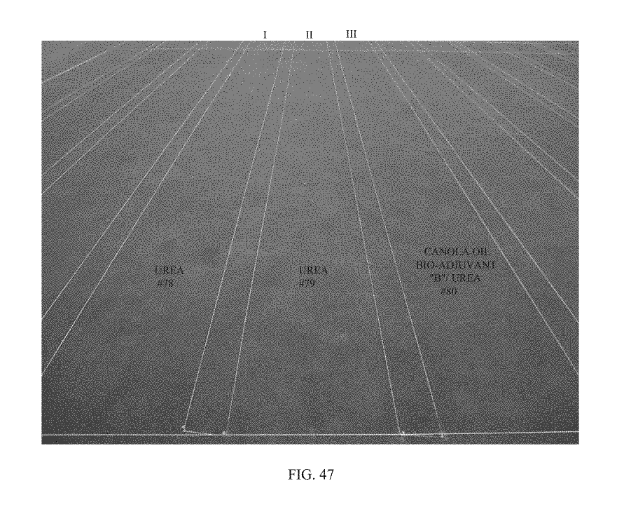

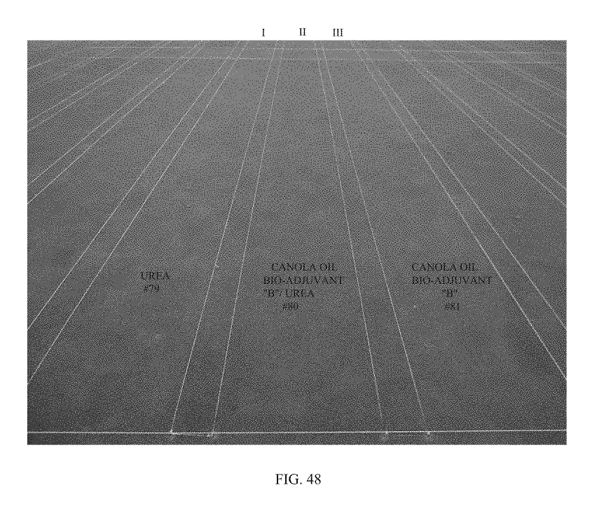

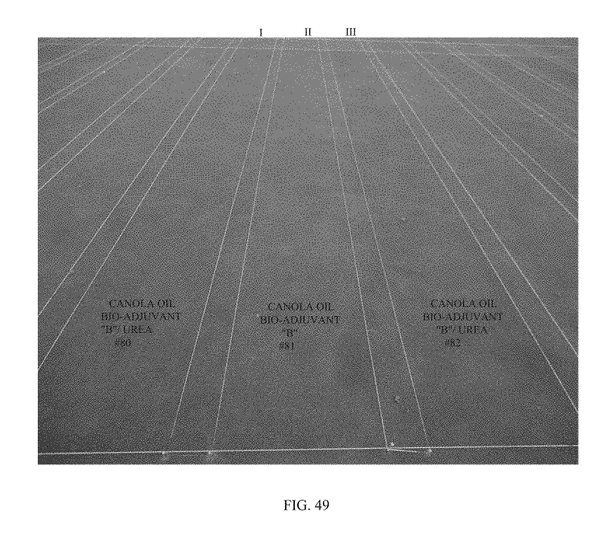

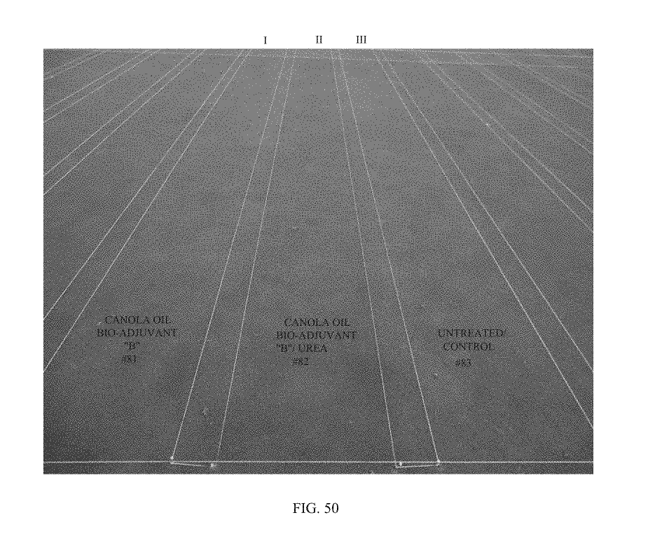

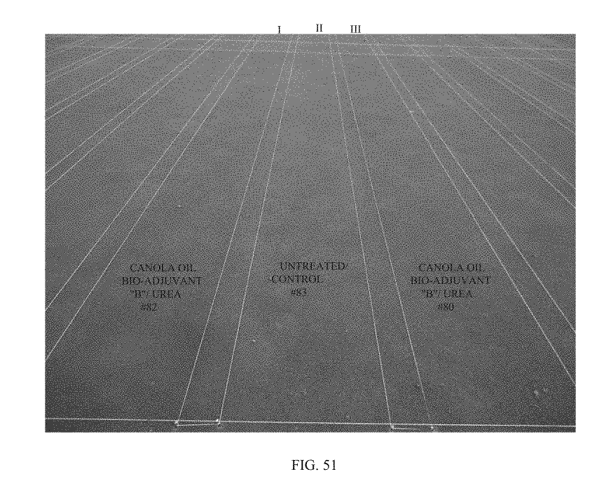

See also, FIGS. 1-51, which show sections of bentgrass treated with various crop treatment products, including comparison treatments and control/untreated portions (i.e., portions having dollar spot disease, dew, frost or which are unfertilized). More details on the crop treatment concentrates used on the turfgrass portions shown in FIGS. 1-51 are noted below in Table 1. Other than in FIG. 19, alleys 102 of overspray shown in FIGS. 1-20 (labeled only in FIGS. 1 and 18) can be seen in between the identified sections, e.g., “I”, “II”, “III” and so forth. These and other crop treatment concentrates, including comparison treatments, are discussed in more detail in the Example section

Treatments shown in Table 1 were applied according to method described in Examples 1, 4 and 5. All components were tank-mixed prior to application. Each amount of biorational concentrate (i.e., “concentrate) was formulated with only the concentrate components (no water). Various amounts of concentrate were then added to water to produce a crop treatment product. When added to the spray solution the concentrate was formulated with approximately 1.1 gal (3.79 L) of water as a carrier to produce a crop treatment product. Each crop treatment product was applied at a rate of approximately 48 GPA (1.1 gal/1000 sq. ft.) (449 L/ha). The term “Canola Oil Bio-Adjuvant”/“Canola Oil Bio-Adjuvant “A”/“Canola Oil Biorational Concentrate” refers to a Spartan brand food grade canola oil in combination with Foursome turfgrass pigment (Quali-Pro Inc.) and Silwet L-77 surfactant (32:1.6:1 ratio v/v. The term “Methylated Canola Oil Bio-Adjuvant “A”/“Methylated Canola Oil Biorational “A” Concentrate” refers to Persist Ultra brand methylated canola oil (Precision Labs, Inc.) in combination with Foursome turfgrass pigment (Quali-Pro Inc.) and Silwet L-77 surfactant (Helena Chemical Company) (32:1.6:1 ratio v/v).

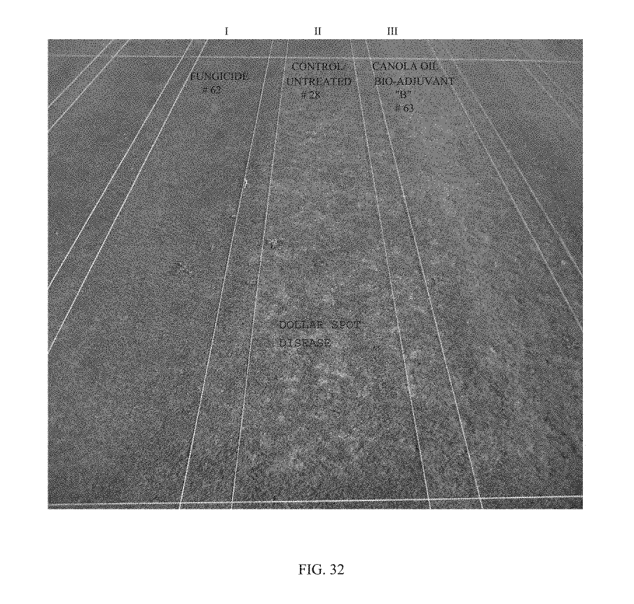

The term “Canola Oil Bio-Adjuvant “B”/“Canola Oil Biorational “B” Concentrate” refers generally to a bio-adjuvant containing from about 46.5 to about 58% non-methylated canola oil, from about 33 to about 41.5% Foursome brand pigment, and from about 0.25% to about 20.5% Silwet L-77. The term “Methylated Canola Oil Bio-Adjuvant “B”/“Methylated Canola Oil Biorational “B” Concentrate” refers generally to a bio-adjuvant containing from about 46.5 to about 58% methylated canola oil, from about 33 to about 41.5% Foursome brand pigment, and from about 0.25% to about 20.5% Silwet L-77. The specific variations within the “B” Bio-Adjuvants for the testing shown in FIGS. 32-51 are shown in Table 1.

The term “Corn Oil Bio-Bio-Adjuvant” refers to a Meijer brand food grade corn oil+Foursome turfgrass pigment+Silwet L-77 surfactant (32:1.6:1 ratio v/v). The term “Soybean Oil Bio-Bio-Adjuvant” refers to a Spartan brand food grade soybean oil+Foursome turfgrass pigment+Silwet L-77 surfactant (32:1.6:1 ratio v/v).

TABLE 1
Crop Treatment Concentrate/Application Rates

| | | | Crop Treatment Concentrate (unless |
|---|---|---|---|
| | | | otherwise indicated, each non-methylated |
| | | | canola oil (i.e., canola oil) or canola oil |
| | | Corresponding | concentrate includes 0.29 fl. oz. of Silwet L-77 |
| | | Treatment No.- | surfactant per 1000 ft² (0.092 ml/m²). |
| Shown in | | EXAMPLE | The concentration of L-77 varies as shown |
| Figures | Treatment No. | (Table) | for the bio-adjuvants labeled as “Adjuvant “B”” |
| 1, 2, 17, | 1 | 1-EXAMPLE 1, | 1 fl. oz. (0.3 ml) Bayer brand 26 GT |
| 19, 20 | (Comparison) | (Table 2) | (“26 GT”) brand fungicide |
| | | | (comprised of iprodione) |
| 1, 2, 7, | 2 | 2-EXAMPLE 1, | 1 fl. oz. (0.3 ml) 26 GT/10 fl. oz. (3.2 ml) |
| 16, 17 | | (Table 2) | Canola Oil Concentrate as Bio-Adjuvant |
| | | | (hereinafter “Canola Oil Bio-Adjuvant” or |
| | | | “Canola Oil Bio-Adjuvant “A”) |
| 2, 16, 17 | 3 | 3-EXAMPLE 1, | 10 fl. oz. (3.2 ml) Canola Oil Concentrate |
| | | (Table 2) | |
| 16 | 4 | 4-EXAMPLE 1, | 0.25 fl. oz. (0.08 ml) “Banner Maxx II” |
| | (Comparison) | (Table 2) | brand fungicide |
| 3 | 5 | 5-EXAMPLE 1, | 0.25 fl. oz. (0.08 ml) Banner Maxx II/10 fl. |
| | | (Table 2) | oz. (3.2 ml) Canola Oil Bio-Adjuvant |
| 3, 4 | 6 | 6-EXAMPLE 1, | 1 fl. oz. (0.3 ml) “Daconil Action” brand |
| | (Comparison) | (Table 2) | fungicide |
| 3, 4, 5 | 7 | 7-EXAMPLE 1, | 1 fl. oz. (0.3 ml) Daconil Action/10 fl. oz. |
| | | (Table 2) | (3.2 ml) Canola Oil Bio-Adjuvant |
| 4, 5 | 8 | 8-EXAMPLE 1, | 0.7 fl. oz. (0.22 ml) “Insignia SC” brand |
| | (Comparison) | (Table 2) | fungicide |
| 4, 5, 7 | 9 | 9-EXAMPLE 1, | 0.7 fl. oz. (0.24 ml) Insignia SC/10 fl. oz. |
| | | (Table 2) | (3.2 ml) Canola Oil Bio-Adjuvant |
| 7 | 10 | 10-EXAMPLE 1, | 0.75 fl. oz. (0.24 ml) “Enclave” brand |
| | (Comparison) | (Table 2) | fungicide |
| 8, 9 | 11 | 11-EXAMPLE 1, | 0.75 fl. oz. (0.24 ml) Enclave/10 fl. oz. |
| | | (Table 2) | (3.2 ml) Canola Oil Bio-Adjuvant |
| 8, 9, 10 | 12 | 12-EXAMPLE 1, | 0.15 fl. oz. (0.05 ml) “Torque” brand |
| | (Comparison) | (Table 2) | fungicide |
| 9, 10 | 13 | 13-EXAMPLE 1, | 0.15 fl. oz. (0.05 ml) Torque/10 fl. oz. |
| | | (Table 2) | (3.2 ml) Canola Oil Bio-Adjuvant |
| 10 | 14 | 14-EXAMPLE 1, | *1 fl. oz. (0.3 ml) 26 GT/8 fl. oz. (2.5 ml) |
| | (Comparison) | (Table 2) | “Civitas” brand mineral oil |
| | | | (“Mineral Oil Adjuvant”) |
| | 15 | 15-EXAMPLE 1, | *8 fl. oz. (2.5 ml) Civitas |
| | (Comparison) | (Table 2) | |
| | 16 | 16-EXAMPLE 1, | *0.25 fl. oz. (7.39 ml) Banner Maxx II/8 fl. oz. |
| | (Comparison) | (Table 2) | (0.24 L) Civitas |
| 17 | 17 | 17-EXAMPLE 1, | *1 oz. (0.03 L) Daconil Action/8 fl. oz. |
| | (Comparison) | (Table 2) | (0.24 L) Civitas |
| 11 | 18 | 18-EXAMPLE 1, | *0.7 fl. oz. (20.7 ml) Insignia SC/8 fl. oz. |
| | | (Table 2) | (0.24 L) Civitas |
| 11, 12 | 19 | 19-EXAMPLE 1, | 1 fl. oz. (0.03 ml) Daconil Weather Stik |
| | (Comparison) | (Table 2) | |
| 8, 11, 12 | 20 | 20-EXAMPLE 1, | 1 fl. oz. (0.03 ml) Daconil Weather Stik/10 |
| | | (Table 2) | fl. oz. (0.3 ml) Canola Oil Bio-Adjuvant |
| 36 | 21 | 21-EXAMPLE 1, | 4 fl. oz. (1.3 ml/m²) 26 GT (label rate) |
| | (Comparison) | (Table 2) | |
| 42 | 22 | 22-EXAMPLE 1, | 1 fl. oz. (0.32 ml/m²) Banner Maxx II |
| | (Comparison) | (Table 2) | (label rate) |
| | 23 | 23-EXAMPLE 1, | 3.2 fl. oz. (1.0 ml/m²) Daconil Action |
| | (Comparison) | (Table 2) | (label rate) |
| | 24 | 24-EXAMPLE 1, | 3 fl. oz. (0.95 ml/m²) Enclave (label rate) |
| | (Comparison) | (Table 2) | |
| 13 | 25 | 25-EXAMPLE 1, | 3.2 fl. oz. (0.95 ml/m²) Daconil Weather |
| | (Comparison) | (Table 2) | Stik (label rate) |
| 13, 14 | 26 | 26-EXAMPLE 1, | 0.2 oz. (0.06 gm/m²) Compass brand |
| | (Comparison) | (Table 2) | fungicide |
| 13, 14, 15 | 27 | 27-EXAMPLE 1, | 0.2 fl. oz. (0.06 gm/m²) Compass/10 fl. oz. |
| | | (Table 2) | (3.2 ml/m²) Canola Oil Bio-Adjuvant |
| 1, 12, 14, | 28 | 28-EXAMPLE 1, | Control/Untreated (Dollar Spot Disease) |
| 15, 32, | | (Table 2) | |
| 33, | | 29-EXAMPLE 14, | |
| | | (Tables 20-23) | |
| 15 | 29 | 29-EXAMPLE 1 | *1 fl. oz. (0.32 ml/m²) Daconil Weather |
| | (Comparison) | (Table 2) | Stik/8 fl. oz. (2.5 ml/m²) Civitas |
| 19, 20 | 30 | 2-EXAMPLE 5, | 4 fl. oz. (1.27 ml/m²) 26 GT (label rate) |
| | | (Table 6) | |
| 20 | 31 | 21-EXAMPLE 5, | 10 fl. oz. (3.2 ml/m²) Rite Aid brand |
| | | (Table 6) | Mineral Oil “Adjuvant”/0.46 fl. oz. |
| | | | (0.15 ml/m²) Foursome brand pigment |
| 19 | 32 | 5-EXAMPLE 5, | 1 fl. oz. (0.32 ml/m²) 26 GT/10 fl. oz. (3 |
| | | (Table 6) | |
| 19, 20 | 33 | 4-EXAMPLE 5, | 1 fl. oz. (0.32 ml/m²) 26 GT/10 fl. oz. |
| | | (Table 6) | (3.2 ml/m²)” Canola Oil Bio-Adjuvant” |
| 19, 20 | 34 | 3-EXAMPLE 5, | 1 fl. oz. (0.32 ml/m²) 26 GT/10 fl. oz. |
| | | (Table 6) | (3.2 ml/m²) “Soybean Oil Bio-Adjuvant” |
| 17 | 35 | 35-EXAMPLE 1, | Control/Untreated (Dew) |
| | | (Table 6) | |
| 18 | 36 | 4-EXAMPLE 4, | 0.2 lb. (0.98 g/m²) actual nitrogen (Urea) |
| | (Comparison) | (Table 5) | |
| 18 | 37 | 3-EXAMPLE 4, | 0.2 lb. (0.98 g/m²) actual nitrogen (Urea)/8 |
| | | (Table 5) | fl. oz. (2.5 ml/m²) Canola Oil Bio-Adjuvant |
| 18 | 38 | 1-EXAMPLE 4, | 8 fl. oz. (2.5 ml/m²) Canola Oil Concentrate |
| | | (Table 5) | |
| 18 | 39 | 5-EXAMPLE 4, | Untreated Control |
| | | Table 5 | (Healthy/Dormant/Unfertilized Turfgrass) |
| 21 | 40 | 2-EXAMPLE 4, | 4 fl. oz. (2.9 ml/m²) Canola Oil Concentrate |
| | | (Table 5) | |
| 22 | 41 | 17-EXAMPLE 13 | 0.5 fl. oz. (0.16 ml) “Trinity” brand |
| | | (Tables 18 and 19) | fungicide/0.2 oz. (0.08 ml) Insignia SC/1.1 |
| | | | fl. oz. (0.35 ml) “Persist Ultra” brand |
| | | | Methylated Canola Oil “B” Concentrate as |
| | | | Bio-Adjuvant “B” (hereinafter “Methylated |
| | | | Canola Oil Bio-Adjuvant ‘B’”), specifically“B^{a}” |
| 22 | 42 | 1-EXAMPLE 13 | Control/Untreated (Crown Rot Anthracnose) |
| | | (Tables 18 and 19) | |
| 22-24 | 43 | 15-EXAMPLE 13 | 0.5 fl. oz. (0.16 ml) Trinity/0.4 fl. oz. |
| | (Comparison) | (Tables 18 and 19) | (0.13 ml) Insignia SC (label rate) |
| 23 | 44-18 | 18-EXAMPLE 13 | 0.5 fl. oz. (0.16 ml) Trinity/0.2 fl. oz. |
| | | (Tables 18 and 19) | (0.08 ml) Insignia SC/10 fl. oz. (3.2 ml) Canola |
| | | | Oil Concentrate as Bio-Adjuvant “A” |
| 23 | 45 | 2-EXAMPLE 13 | 1 fl. oz. (0.32 ml/m²) “Mirage” brand |
| | (Comparison) | (Tables 18 and 19) | fungicide (label rate) |
| 24 | 46 | 3-EXAMPLE 13 | 0.5 fl. oz. (0.16 ml) Mirage/1.4 fl. oz. |
| | | (Tables 18 and 19) | (0.45 ml) Canola Oil Concentrate “B” as Bio- |
| | | | Adjuvant “B” (hereinafter “d Canola Oil |
| | | | Bio-Adjuvant “B”), specifically “B”^{b} |
| 24 | 47 | 11-EXAMPLE 13 | 0.07 oz. (0.23 ml) Compass/10 fl. oz. |
| | | (Tables 18 and 19) | (3.2 ml/) Canola Oil Bio-Adjuvant “A” |
| 25, 26 | 48 | 12-EXAMPLE 13 | 0.07 fl. oz. (0.23 ml) Compass/1.4 fl. oz. |
| | | (Tables 18 and 19) | (0.45 ml/m²) Canola Oil Bio-Adjuvant “A” |
| 25 | 49 | 4-EXAMPLE 13 | 0.5 fl. oz. (0.16 ml) Mirage/1.1 fl. oz. |
| | | (Tables 18 and 19) | (0.35 ml) Methylated Canola Oil Bio-Adjuvant |
| | | | “B^{ac}” |
| 26 | 50 | 5-EXAMPLE 13 | 0.5 fl. oz. (0.16 ml) Mirage/5 fl. oz. |
| | | (Tables 18 and 19) | (1.6 ml/m²) Canola Oil Bio-Adjuvant “A” |
| 27 | 51 | 6-EXAMPLE 13 | 0.5 fl. oz. (0.16 ml) Mirage/ 1.4 fl. oz. |
| | | (Tables 18 and 19) | (0.45 ml/m²) Canola Oil Bio-Adjuvant “A” |
| 28 | 52 | 7-EXAMPLE 13 | 0.5 fl. oz. (0.16 ml) Mirage (half label rate) |
| | (Comparison) | (Tables 18 and 19) | |
| 29, 39 | 53 | 12-EXAMPLE 14 | 3 fl. oz. (0.96 ml) “Interface” brand |
| | (Comparison) | (Tables 20-23) | fungicide (full label rate) |
| 29, 39 | 54 | 21-EXAMPLE 14 | 0.07 fl. oz. (0.02 ml) “Emerald” brand |
| | | (Tables 20-23) | fungicide/1.4 fl. oz. (0.45 ml) Canola Oil |
| | | | Adjuvant “B^{b}” |
| 29, 42 | 55 | 7-EXAMPLE 14 | 1 fl. oz. (0.32 ml) Interface/5 fl. oz. (1.6 ml) |
| | | (Tables 20-23) | Canola Oil Bio-Adjuvant “A” |
| 30 | 56 | 10-EXAMPLE 14 | 1 fl. oz. (0.32 ml) Interface/1.1 fl. oz. (0.35 ml) |
| | | (Tables 20-23) | Methylated Canola Oil Bio-Adjuvant “B^{a}” |
| 30, 34 | 57 | 23-EXAMPLE 14 | 0.07 fl. oz. (0.02 ml) Emerald |
| | (Comparison) | (Tables 20-23) | (half label rate) |
| 30, 34, 41 | 58 | 3-EXAMPLE 14 | 1.5 fl. oz. (0.48 ml) 26 GT/1.4 fl. oz. |
| | | (Tables 20-23) | (0.45 ml) Canola Oil Bio-Adjuvant “B^{b}” |
| 31 | 59 | 28-EXAMPLE 14 | 1.1 fl. oz. (0.35 ml) Methylated Canola Oil |
| | | (Tables 20-23) | Adjuvant “B^{a}” |
| 31, 37 | 60 | 24-EXAMPLE 14 | 0.13 fl. oz. (0.04 ml) Emerald |
| | (Comparison) | (Tables 20-23) | |
| 31, 37 | 61 | 9-EXAMPLE 14 | 1 fl. oz. (0.32 ml) Interface/1.4 fl. oz. |
| | | (Tables 20-23) | (0.45 ml) Canola Oil Bio-Adjuvant “B^{b}” |
| 32, 34, 41 | 62 | 17-EXAMPLE 14 | 0.38 fl. oz. (0.12 ml) Banner Maxx |
| | (Comparison) | (Tables 20-23) | |
| 32, 33 | 63 | 27-EXAMPLE 14 | 1 fl. oz. (0.32 ml) Canola Oil Bio-Adjuvant |
| | | (Tables 20-23) | “B^{b}” |
| 33 | 64 | 8-EXAMPLE 14 | 1 fl. oz. (0.32 ml) Interface/1.4 fl. oz. |
| | | (Tables 20-23) | (0.45 ml) Canola Oil Bio-Adjuvant “A” |
| 34, 36 | 65 | 13-EXAMPLE 14 | 0.38 fl. oz. (0.12 ml) Banner Maxx/5 fl. oz. |
| | | (Tables 20-23) | (1.6 ml) Canola Oil Bio-Adjuvant “A” |
| 35, 40 | 66 | 15-EXAMPLE 14 | 0.38 fl. oz. (0.12 ml) Banner Maxx/1.4 fl. oz. |
| | | (Tables 20-23) | (0.45 ml) Canola Oil Bio-Adjuvant “B^{b}” |
| 35, 40 | 67 | 5-EXAMPLE 14 | 1.5 fl. oz. (0.48 ml) 26 GT |
| | (Comparison) | (Tables 20-23) | |
| 36 | 68 | 25-EXAMPLE 14 | 1 fl. oz. (0.32 ml) Canola Oil Bio-Adjuvant |
| | | (Tables 20-23) | “A” |
| 36, 40 | 69 | 1-EXAMPLE 14 | 1.5 fl. oz. (0.48 ml) 26 GT/5 fl. oz. (1.6 ml) |
| | | (Tables 20-23) | Canola Oil Bio-Adjuvant “A” |
| 37, 38 | 70 | 19-EXAMPLE 14 | 0.07 fl. oz. (0.02 ml) Emerald/5 fl. oz. |
| | | (Tables 20-23) | (1.6 ml) Canola Oil Bio-Adjuvant “A” |
| 38 | 71 | 11-EXAMPLE 14 | 1 fl. oz. (0.32 ml) Interface (label rate) |
| | (Comparison) | (Tables 20-23) | |
| 38 | 72 | 26-EXAMPLE 14 | 5 fl. oz. (1.6 ml) Canola Oil Bio-Adjuvant “A” |
| | | (Tables 20-23) | |
| 39 | 73 | 22-EXAMPLE 14 | 0.07 fl. oz. (0.02 ml) Emerald/1.1 fl. oz. |
| | | (Tables 20-23) | (0.35 ml) Methylated Canola Oil Adjuvant “B^{a}” |
| 42 | 74 | 16-EXAMPLE 14 | 0.38 fl. oz. (0.12 ml) Banner Maxx/1.1 fl. oz. |
| | | (Tables 20-23) | (0.35 ml) Methylated Canola Oil Bio- |
| | | | Adjuvant “B^{a}” |
| 43, 44 | 75 | 1-EXAMPLE 15 | 0.5% V/V Canola Oil Bio-Adjuvant “B^{b}” |
| | | (Tables 24-26) | |
| 43, 44, 46 | 76 | 2-EXAMPLE 15 | 0.5% V/V Canola Oil Bio-Adjuvant |
| | | (Tables 24-26) | “B^{b}”/0.1 lb. N/1000 sq. ft. “Urea (46-0-0)^{c}” |
| 44, 45, 46 | 77 | 3-EXAMPLE 15 | 0.5% V/V Canola Oil Bio-Adjuvant |
| | | (Tables 24-26) | “B^{b}”/0.05 lb. N/1000 sq. ft. Urea (46-0-0)^{c} |
| 45, 46, 47 | 78 | 4-EXAMPLE 15 | 0.1 lb. N/1000 sq. ft. Urea (46-0-0)^{c} |
| | (Comparison) | (Tables 24-26) | |
| 45, 47, 48 | 79 | 5-EXAMPLE 15 | 0.05 lb. N/1000 sq. ft. Urea (46-0-0)^{c} |
| | (Comparison) | (Tables 24-26) | |
| 47, 48, | 80 | 6-EXAMPLE 15 | 1.0% V/V Canola Oil Bio-Adjuvant |
| 49, 51 | | (Tables 24-26) | “B^{b}”)/0.05 lb. N/1000 sq. ft. Urea (46-0-0)^{c} |
| 48, 49, 50 | 81 | 7-EXAMPLE 15 | 1% V/V Canola Oil Bio-Adjuvant “B^{b}” |
| | | (Tables 24-26) | |
| 49, 50, 51 | 82 | 8-EXAMPLE 15 | 1% V/V Canola Oil Bio-Adjuvant “B^{b}/0.1 |
| | | (Tables 24-26) | lb. N/1000 sq. ft. Urea (46-0-0)^{c} |

^{a}58% methylated canola oil, 41.5% Foursome brand pigment, 0.5% Silwet L-77.
^{b}46.5% canola oil, 33% Foursome Brand pigment, 20.5% Silwet L-77.
^{c}Treatments of sprayable urea (46-0-0) (The Andersons, Inc.) hereinafter “Urea (46-0-0)”

As noted above, in one embodiment, the ingredients are tank-mixed prior to delivery. In one embodiment, a conventional liquid or foam sprayer apparatus is used. In one embodiment, the apparatus described in the '928 patent is used. In one embodiment, the apparatus described in U.S. Patent Publication No. US2014/0097264 is used, which application is incorporated by reference herein in its entirety.

In one embodiment, the various biorational treatment concentrates or products are delivered one or more times within a month, within a one year period and/or over multiple years, including, for example, in early spring before “green-up” begins, i.e., before the quality of the target crop begins to improve through individual plant growth, increased color intensity of individual plants, and increased overall density of a given area when frost is still present and temperatures are freezing, to promote early plant biomass increase. In one embodiment, the treatment is applied at any time of day when no rainfall or irrigation is expected for at least one hour, such as for at least two hours. However, the time period may be reduced depending on other conditions, such as wind and temperature. As such, in various embodiments, drying time for the various treatments can vary from 30 minutes up to two hours, such as at least about one hour or at least about two hours. In various embodiments, treatment may be applied to a wet turf or a dry turf. In various embodiments, treatment is applied in the early morning to in the evening. In one embodiment, the treatment is delivered in the spring and/or summer and/or fall and/or winter.

The various embodiments will be further described by reference to the following examples, which are offered to further illustrate various embodiments of the present invention. It should be understood, however, that many variations and modifications may be made while remaining within the scope of the various embodiments.

### Example 1

### 2013 Canola Oil Concentrate/Canola Oil Bio-Adjuvant General Effects Study

This study was established on an irrigated, dollar spot-infected (Sclerotinia homoeocarpa) creeping bentgrass (Agrostis palustris) fairway (˜0.5 in (1.3 cm) height of cut) on the Hancock Turfgrass Research Center on the Michigan State University campus in East Lansing, Mich. Fertility was maintained at approximately 0.1 lb. Nitrogen (N)/1000 ft² (4.9 g/m²)/14 days. The study was established in four replications of a randomized block design, using 2 ft.×7.5 ft. (0.6 m×2.3 m) plots with 6″ (0.15 m) alleys (102 in FIG. 1). Treatments were applied with a CO2 backpack sprayer (R&D Sprayers, Inc., Opelousas, La.) operating at 40 PSI (2.8 kg/cm²) a 48 GPA (449 L/ha) spray volume, utilizing a single nozzle (8002E Tee-Jet flat fan) spray boom. Fungicides used in this study included 26GT (a standard dollar spot fungicide) (Bayer Cropscience), Banner Maxx II (Syngenta Corp.), Daconil Action (Syngenta Corp.), Insignia SC (BASF Corp.), Enclave (Quali-Pro Inc.), Daconil Weatherstik (Syngenta Corp.), and Compass (Bayer Corp.). Curative treatments were initiated on this uniformly-infected fairway on Aug. 8, 2013, with three additional re-applications on August 21, September 5, and Sep. 23, 2013.

Fungicide application rates were lowered from label recommendations when tank-mixed with the canola oil concentrate, in order to detect the effect of the canola oil bio-adjuvant/fungicide combination. The dollar spot infection was substantially uniform throughout the study area at study initiation, so disease data are reported as mean percent observed disease/treatment (Table 2).

Turfgrass quality ratings were based on a visual rating scale of color intensity, density and growth, with a “1” being the worst and a “9” being the best, with a “7” representing acceptable turfgrass quality, as is understood in the art.

Some biomass ratings were subjective visual estimations based on appearance of a combination of increased biomass and increased density on a 1 (least increase) to 9 (most increase) scale. Objective biomass ratings were also performed based on an increase in dried weight of clippings. Clippings were collected over pre-measured plot areas in each treatment replicate using a Toro® brand walk-behind greens mower Model Greensmaster 8000 at the height described in this Example and dried in a drying oven (60° C.) for approximately 48 hours before being weighed.

Dew estimations were made at dawn, based on a 1 (least) to 5 (most) scale, two days after the treatments were applied.

Dollar spots typically range in size from about 0.25 in (0.64 cm) to 1.5 in (3.81 cm) in diameter, and can occur in clusters and can merge into a larger area.

Values were analyzed in this Example and the other examples herein using Analysis of Variance (ANOVA) and least significant difference (LSD) mean separation procedures of SAS™ (SAS Institute Inc., SAS Campus Drive, Cary, N.C.). Significant differences due to treatment type were detected using Analysis of Variance (ANOVA), a statistical method known in the art for finding significant differences between treatment types by analyzing variance between observations. Effects were compared using the well-known least significant differences (LSD) analysis method. Data is organized by criteria other than the letter series in the LSD, but as those skilled in the art understand, each lower-case letter in Table 2 (and in all other tables where this type of information is presented herein) refers to a comparable LSD value. Unless otherwise states, the means reported herein, have a significance level (P)=0.05. As is understood in the art, a “P” value is the probability that the observed statistic occurred by chance alone. As such, with a “P” value of 0.05, there is a 5% chance that the significance between two values is due to random chance, not treatment effect.

Means (generally, of 4 repetitions, rated and, where applicable, clipped, on dates indicated) for different treatments which are followed by the same letter are not significantly different from each other, i.e., have a difference less than the least significant difference value calculated by the statistical analysis. See, for example, the mean value of “36.25” for treatment 2 in Table 7 and mean value of “37.5” for treatment 3 in the same table, where the letter “c” is used in both. Means followed by a single letter are not significantly different from other means followed by the same letter, but are significantly different from means followed by other letters. See for example, mean value “52.5” for treatment 1 in Table 7 and mean value “36.25” for treatment 2 in the same table, with one showing the letter “a” and the other showing the letter “c.” Means followed by a series of letters (e.g. 13 abc) are not different from other means followed by any one of “a,” “b” or “c,” but are significantly different from means not followed by any of these same letters. See, for example, mean value “40” for treatment 9 in Table 6 and mean value “42.5” for treatment 11 in the same table, where the letters “b-d” are used in both. This principle holds regardless of the order in which the means appear in the data tables or how many letters follow a particular mean.

As can be seen in Table 2, significantly less dollar spot was observed following treatment with reduced rates (less than full label dose) of 26GT, Daconil Action, Insignia SC, Torque, Daconil Weather Stik, and a label rate of Compass, when these reduced rate fungicides were applied with the canola oil bio-adjuvant, compared to the reduced rate treatments alone. As expected, the label rate application of Insignia SC alone was not effective against dollar spot, but it was surprisingly effective when applied with the canola oil bio-adjuvant. However, the separation between the Enclave reduced rate alone application and the reduced rate application with the canola oil bio-adjuvant was not statistically significant, suggesting that excessive Enclave was used in the Enclave/canola oil bio-adjuvant treatment.

Turfgrass quality differences mimicked the dollar spot results, with statistically better turfgrass quality when the canola oil concentrate was tank-mixed with each of the fungicides tested, except Enclave, due to the unexpected level of dollar spot control at the off-label 0.75 fl. oz./1000 ft² (22.2 ml/m²) test rate for Enclave.

Visual biomass ratings indicated an unexpected, statistically significant biomass increase (increased or accelerated individual plant growth rate and overall plant density improvement) when the canola oil concentrate was tank-mixed with each of the reduced rate fungicides tested, except Enclave and Daconil Weatherstik. This observation was supported with statistically significant clipping (biomass) dry weight increases when the tank-mixes included Daconil Action, Insignia SC, and Torque. This biomass increase also appears to be due to improved disease control.

Finally, as shown in Table 2, statistically significant dew reductions were observed whenever the canola oil concentrate or canola oil bio-adjuvant was applied. This effect diminished over time, but dew reduction was still evident for about 10 days after treatment on an approximately 14-day re-application cycle. See also FIGS. 1-17.

TABLE 2
2013 Canola Oil Concentrate/Canola Oil Bio-Adjuvant General Effects Study

| | | | | Dollar | | | | Visual | | Clippings | | | |
|---|---|---|---|---|---|---|---|---|---|---|---|---|---|
| | | | | Spot | | Turfgrass | | Growth | | (Biomass) | | Dew^{a,f} | |
| Treatment | | | | Disease^{a,b} | | Quality^{a,c} | | (Biomass)^{a,d} | | Dry wt (g)^{e} | | Formation | |
| No.^{g} | Treatment Name | Rate^{h} | | Sep. 30, 2013 | | Sep. 30, 2013 | | Sep. 20, 2013 | | Oct. 13, 2013 | | Sep. 25, 2013 | |
| 1 | 26 GT | 1 | (0.32) | 37.5 | de | 4.8 | efg | 5 | d-g | 20.9 | a-f | 4.25 | bc |
| 2 | 26 GT + | 1 | (0.32) | 12.5 | g-j | 6.8 | abc | 6.3 | abc | 19.18 | b-g | 1.0 | h |
| | Canola Oil Bio-Adjuvant^{h} | 10 | (3.2) | | | | | | | | | | |
| 3 | Canola Oil Concentrate | 10 | (3.2) | 47.5 | cd | 4.5 | fg | 3.3 | ijk | 15.78 | f-l | 2.0 | g |
| 4 | Banner Maxx II | 0.25 | (0.08) | 41.25 | c-e | 4 | fgh | 4 | g-j | 17.15 | d-j | 4.25 | bc |
| 5 | Banner Maxx II + | 0.25 | (0.08) | 28.75 | ef | 5.8 | cde | 5.5 | c-f | 22.98 | a-d | 1.5 | gh |
| | Canola Oil Bio-Adjuvant | 10 | (3.2) | | | | | | | | | | |
| 6 | Daconil Action | 1 | (0.32) | 62.5 | ab | 3 | hi | 3 | jk | 9.7 | lm | 5.0 | a |
| 7 | Daconil Action + | 1 | (0.32) | 41.25 | c-e | 4.8 | efg | 4.7 | efg | 16.38 | e-k | 2.0 | g |
| | Canola Oil Bio-Adjuvant | 10 | (3.2) | | | | | | | | | | |
| 8 | Insignia SC | 0.7 | (0.22) | 46.25 | cd | 4.5 | fg | 4 | g-j | 10.58 | k-m | 4.25 | bc |
| 9 | Insignia SC + | 0.7 | (0.22) | 10 | g-j | 7 | ab | 6.3 | abc | 17.6 | d-i | 1.75 | g |
| | Canola Oil Bio-Adjuvant | 10 | (3.2) | | | | | | | | | | |
| 10 | Enclave | 0.75 | (0.24) | 17.25 | f-i | 6 | bcd | 6 | a-d | 21.25 | a-f | 4.25 | bc |
| 11 | Enclave + | 0.75 | (0.24) | 6.75 | ij | 6.5 | abc | 6.8 | ab | 26.4 | a | 1.0 | h |
| | Canola Oil Bio-Adjuvant | 10 | (3.2) | | | | | | | | | | |
| 12 | Torque | 0.15 | (0.05) | 37.5 | de | 4.5 | efg | 4.3 | ghi | 17.53 | d-i | 4.75 | ab |
| 13 | Torque + | 0.15 | (0.05) | 7.0 | ij | 7 | ab | 7.0 | a | 24.03 | a-c | 1.5 | gh |
| | Canola Oil Bio-Adjuvant | 10 | (3.2) | | | | | | | | | | |
| 14 | 26 GT + | 1 | (0.32) + | 21.8 | f-h | 5.8 | cde | 5.5 | c-f | 19.7 | a-f | 3.0 | ef |
| | Civitas + | 8 | (2.5) + | | | | | | | | | | |
| | Harmonizer | 0.5 | (0.16) | | | | | | | | | | |
| 15 | Civitas + | 8 | (2.5) + | 51.3 | bc | 3.8 | gh | 2.8 | k | 9.75 | kl | 3.0 | ef |
| | Harmonizer | 0.5 | (0.16) | | | | | | | | | | |
| 16 | Banner Maxx II + | 0.25 | (0.08) + | 22.5 | fg | 5.8 | cde | 5.8 | b-e | 17.03 | c-k | 2.75 | f |
| | Civitas + | 8 | (2.5) + | | | | | | | | | | |
| | Harmonizer | 0.5 | (0.16) | | | | | | | | | | |
| 17 | Daconil Action + | 1 | (0.32) | 43.8 | cd | 5.0 | def | 4.5 | fgh | 18.48 | b-h | 3.0 | ef |
| | Civitas + | 8 | (2.5) | | | | | | | | | | |
| | Harmonizer | 0.5 | (0.16) | | | | | | | | | | |
| 18 | Insignia SC + | 0.7 | (0.22) + | 8.4 | h-j | 7.3 | a | 6.5 | abc | 25.03 | ab | 2.75 | f |
| | Civitas + | 8 | (2.5) + | | | | | | | | | | |
| | Harmonizer | 0.5 | (0.16) | | | | | | | | | | |
| 19 | Daconil Weatherstik. | 1 | (0.32) | 65 | a | 2.3 | i | 2.8 | k | 10.9 | k-m | 4.75 | ab |
| 20 | Daconil Weatherstik. + | 1 | (0.32) | 48.75 | cd | 4 | fgh | 3.3 | ijk | 14.13 | g-m | 2.0 | g |
| | Canola Oil Bio-Adjuvant | 10 | (3.2) | | | | | | | | | | |
| 21 | 26 GT | 4 | (1.3) | 0 | j | 6.5 | abc | 5.5 | c-f | 19.63 | b-g | 3.5 | de |
| 22 | Banner Maxx II | 1 | (0.32) | 0 | j | 7 | ab | 6.5 | abc | 21.98 | a-e | 3.0 | ef |
| 23 | Daconil Action | 3.2 | (1.02) | 18.75 | f-j | 5.8 | cde | 5 | d-g | 15.78 | f-l | 4.25 | bc |
| 24 | Enclave | 3 | (0.95) | 0 | j | 6.5 | abc | 5 | d-g | 18.05 | c-h | 4.25 | bc |
| 25 | Daconil Weatherstik | 3.2 | (1.02) | 36.25 | de | 4.3 | fg | 4.3 | ghi | 11.95 | i-m | 4.75 | ab |
| 26 | Compass (wettable | 0.2 oz. 1000 ft² | | 66.25 | a | 2.5 | i | 2.5 | kl | 11.2 | j-m | 4.0 | cd |
| | granular treatment | (0.064 g/cm²) | | | | | | | | | | | |
| | product) | | | | | | | | | | | | |
| 27 | Compass + | 0.2 oz. 1000 ft² | | 42.5 | cd | 4.5 | fg | 4 | g-j | 13.03 | h-m | 1.75 | g |
| | | (0.064 g/cm²) | | | | | | | | | | | |
| | Canola Oil Bio-Adjuvant | 8 | (2.5) | | | | | | | | | | |

| | | | | | | | | | | | | |
|---|---|---|---|---|---|---|---|---|---|---|---|---|
| 28, 35ⁱ | Control (no treatment) | — | 72.5 | a | 2.3 | i | 1.5 | l | 9.1 | m | 5.0 | a |
| 29 | Daconil Weather | 1 (0.32)/8 (2.5) | | | | | | | | | | |
| | Stik/Civitas | | | | | | | | | | | |

^{a}Means (of 4 repetitions (“reps”)) followed by the same letter are not significantly different: P = 0.05, LSD.
^{b}Disease visual rating scale: mean percent plot area infected with dollar spot (treated curatively).
^{c}Turfgrass quality visual rating scale: 1 = worst, 9 = best, 7 = acceptable.
^{d}Visual biomass increase (individual plant growth and overall density increase) visual rating scale: 1 = least increase, 9 = most increase.
^{e}P = 0.10, LSD.
^{f}Dew formation visual rating scale: 1 = least, 5 = most, 2 days after treatment.
^{g}Canola Oil Concentrate/Bio-Adjuvant = food grade canola oil + Foursome turfgrass pigment (Quali-Pro Inc.) + Silwet L-77 surfactant components applied in volumes consistent with a 32:1.6:1 ratio v/v of oil:pigment:surfactant.
^{h}Rate Unit = fl. oz./1000 ft² (ml/m²) unless otherwise specified.
ⁱ#28(dollar spot disease), #35(dew)

### Example 2

### 2013 Canola Oil Concentrate and Urea (46-0-0) Fertilizer/Canola Oil Bio-Adjuvant Study

This study was established on an irrigated, creeping bentgrass (Argostis palustris) fairway (˜0.5 in (1.3 cm) height of cut) on the same research center as in Example 1. The study was established in four replications of a randomized block design, using 2 ft.×10.5 ft. (0.6 m×3.2 m) plots with 6 in. (0.15 m) alleys. Prior to the study, diseases were controlled with as-needed fungicide applications. Fertility was maintained at approximately 0.1 lb. N/1000 ft² (0.49 g/m²)/mo. The treatments were applied with the backpack sprayer described in Example 1 using the same conditions as in Example 1. Turfgrass quality ratings and biomass ratings were performed as described in Example 1. Clippings were also collected as described in Example 1.

Treatments of sprayable urea (46-0-0) (The Andersons, Inc.) hereinafter “Urea (46-0-0)” and Civitas/Harmonizer fungicide/turf pigment (Suncor Energy Corp.) were applied initially on Aug. 22, 2013.

As the data indicates (Table 3), after only one application, the canola oil concentrate (treatment 3) produced a significantly better quality turfgrass than the untreated control. When a 0.1 lb N/1000 ft² (0.49 g/m²) rate of urea was added to the canola oil concentrate (treatment #4), a significantly improved turfgrass quality resulted, compared to both the urea only treatment and the untreated control. This improved turfgrass quality was accompanied by a surprisingly significantly increased biomass due to an increased growth rate and density, as observed visually and as measured by the increased amount of clippings, as compared to the urea only treatment and the untreated control. This effect became more pronounced as the urea rate was increased (treatments #6 and #8). This data indicates that the canola oil concentrate, when applied alone, simulates the effect of a 0.1 lb. (0.05 kg) urea application, in terms of increased turfgrass biomass and quality. When applied in combination with urea, not only was this effect further enhanced, but biomass increase (as evidenced by visual observations and increased clipping weight) was also significantly increased, as compared to the control.

As the results show, use of the canola oil bio-adjuvant not only allowed for a reduction in fertilizer application rates, it provided for increased amounts of turfgrass biomass, as shown by the improved biomass visual ratings and dry weight biomass measurements increase without sacrificing quality. Use of a biorational treatment concentrate rather than a chemical treatment concentrate, such as a synthetic fertilizer, also reduces run-off environmental contamination, such as with nitrates and other nutrients.

TABLE 3
2013 Canola Oil Concentrate and Urea (46-0-0)
Fertilizer/Canola Oil Bio-Adjuvant Study

| | | | | | Visual | Clippings |
|---|---|---|---|---|---|---|
| | | | | Turfgrass | Growth | (Biomass) |
| Trt. | | Rate per | | Quality^{b} | (Biomass)^{c} | Dry wt (g) |
| No. | Treatment Name | 1000 ft²(m²) | Rate Unit | Sep. 3, 2013 | Sep. 3, 2013 | Sep. 3, 2013 |
| 1 | Control | — | | 6.0^{a} f | 2.25^{a} f | 7.7^{a} f |
| 2 | Urea (46-0-0) | 0.1 (0.05) | lb. (kg) N^{e} | 6.5 ef | 3 ef | 7.21 f |
| 3 | Canola Oil | 10 (3.2) | fl. oz. (ml) | 6.75 de | 3.75 de | 7.97 ef |
| | Concentrate^{d} | | | | | |
| 4 | Urea (46-0-0)+ | 0.1 (0.05) | lb. (kg) N | 7.5 bc | 4.25 cd | 9.47 cde |
| | Canola Oil | 10 (3.2) | fl. oz. (ml) | | | |
| | Bio-Adjuvant^{d} | | | | | |
| 5 | Urea (46-0-0) | 0.2 (0.1) | lb. (kg) N | 6.75 de | 3.75 de | 7.87 f |
| 6 | Urea (46-0-0)+ | 0.2 (0.1) | lb. (kg) N | 7.75 abc | 5.5 ab | 11.11 ab |
| | Canola Oil | 10 (3.2) | fl. oz. (ml) | | | |
| 7 | Urea (46-0-0) | 0.3 (0.15) | lb.(kg) N | 7.5 bc | 3.75 de | 9.77 bcd |
| 8 | Urea (46-0-0)+ | 0.3 (0.15) | lb. (kg) N | 8.0 ab | 5.5 ab | 11.65 a |
| | Canola Oil | 10 (3.2) | fl. oz. (ml) | | | |
| | Bio-Adjuvant | | | | | |
| 9 | Civitas + | 8 (2.5) | fl. oz. (ml) | 7.25 cd | 4 d | 8.5 def |
| | Harmonizer | 0.5 (0.16) | fl. oz. (ml) | | | |
| 10 | Urea (46-0-0)+ | 0.1 (0.05) | lb.(kg) N | 7.75 abc | 4.5 cd | 10.6 abc |
| | Civitas+ | 8 (2.5) | fl. oz. (ml) | | | |
| | Harmonizer | 0.5 (0.16) | fl. oz. (ml) | | | |
| 11 | Urea (46-0-0)+ | 0.2 (0.1) | lb. (kg) N | 7.5 bc | 5 bc | 10.63 abc |
| | Civitas+ | 8 (2.5) | fl. oz. (ml) | | | |
| | Harmonizer | 0.5 (0.16) | fl. oz. (ml) | | | |
| 12 | Urea (46-0-0)+ | 0.3 (0.15) | lb. (kg) N | 8.25 a | 6 a | 11.17 ab |
| | Civitas+ | 8 (2.5) | fl. oz. (ml) | | | |
| | Harmonizer | 0.5 (0.16) | fl. oz. (ml) | | | |

^{a}Means (of 4 reps) followed by the same letter are not significantly different (p = 0.05, LSD).
^{b}Turfgrass quality visual rating scale: 1 = worst, 9 = best, 7 = acceptable.
^{c}Visual biomass increase (individual plant growth and overall density increase)visual rating scale: 1 = least increase, 9 = most increase.
^{d}Canola oil concentrate/canola oil bio-adjuvant = food grade canola oil + Foursome turfgrass pigment + Silwet L-77 surfactant (32:1.6:1 ratio v/v).
^{e}Actual nitrogen (not a commercial product containing nitrogen).

### Example 3

### 2013 Canola Oil Concentrate and Urea/Ammonium Nitrate (UAN) (28-0-0) Fertilizer/Canola Oil Bio-Adjuvant Study

This study was established on an irrigated, creeping bentgrass (Agrostis palustris) putting green (˜0.15 in (0.038 cm) height of cut) on the same research center as in previous examples. The study was established in four replications of a randomized block design, using 2 ft.×10.5 ft. (0.6 m×3.2 m) plots with 6 in. (0.15 m) alleys. Prior to the study, fertility was maintained at 0.1 lb N/1000 ft² (0.49 g/m²) and fungicide applications were made as needed. Treatments were applied with the backpack sprayer described in Example 1, using the same conditions as in Example 1. Turfgrass quality ratings and biomass ratings were performed as described in Example 1. Clippings were also collected as described in Example 1.

Treatments of UAN brand agricultural fertilizer (Urea/ammonium nitrate blend, 28-0-0 analysis, purchased at local elevator) (hereinafter “UAN fertilizer”) were applied on Oct. 9, 2013 to a study area where diseases had been controlled, but which had received no 2013 fertility treatment, except for a 0.1 lb N/1000 ft² (0.49 g/m²) application (urea) on Sep. 20, 2013.

As the data in Table 4 indicates, the canola oil concentrate applied alone (treatment 2) promoted significantly increased turfgrass biomass (visually) as compared to the UAN fertilizer alone at either rate (treatments 1 and 3) on the Oct. 16, 2013 rating date. The same is true when the UAN fertilizer was tank-mixed with the canola oil concentrate (treatments 5-8). All treatments produced significantly increased turfgrass biomass (visually) as compared to the untreated control on the first rating date. On the second rating date (Nov. 4, 2013) the high rate of canola oil concentrate alone (treatment 2 in Table 4) was still producing significantly increased turfgrass biomass (visually) than either rate of UAN fertilizer alone (treatments 1 and 3). On the second rating date (Nov. 4, 2013), all the UAN fertilizer/canola oil concentrate (i.e., canola oil bio-adjuvant) tank-mixes, except the lowest rate combination (treatments 7 and 8) were producing significantly increased turfgrass biomass (visually) than the UAN fertilizer alone, at either rate (treatments 1 and 3).

In terms of clipping dry weights, all treatments, except the UAN fertilizer at both rates (treatments 1 and 3), and the reduced rate tank-mix (treatment 7), yielded significantly more clippings than the untreated control.

This data shows that if the reduced rate of UAN fertilizer is applied with the high rate of the canola bio-adjuvant, the UAN fertilizer rate can be reduced by 50% with no loss of visual biomass increase (growth and density) or turf quality (treatment 6 versus treatment 1). In fact, just the high rate of canola oil concentrate alone (treatment 2), unexpectedly produced significantly more visual biomass increase (growth and density) and better turfgrass quality than the high rate of UAN fertilizer alone (treatment 1). This is environmentally beneficial and could reduce EPA concern about nitrate run-off, which can result in surface and ground water pollution.

TABLE 4
2013 Canola Oil Concentrate and UAN (28-0-0) Fertilizer/Canola Oil Bio-Adjuvant Study

| | | | | | | | Clippings |
|---|---|---|---|---|---|---|---|
| | | Rate per | | Visual | Visual | Turfgrass | (Biomass)^{a,} |
| Trt. | Treatment | 1000 ft² | Rate | (Biomass)^{a,c} | (Biomass)^{a,c} | Quality^{a,b} | Dry wt (g) |
| No. | Name | (m²) | Unit | Oct. 16, 2013 | Nov. 4, 2013 | Nov. 4, 2013 | Nov. 5, 2013 |
| 1 | UAN fertilizer | 0.1 (0.05) | lb. (kg) N^{e} | 2.25 c | 3.5 de | 5.75 bc | 8.57 bc |
| 2 | Canola Oil | 5 (1.6) | fl. oz. | 3.5 ab | 5.25 a | 6.5 a | 9.113 ab |
| | Concentrate^{e} | | (ml) | | | | |
| 3 | UAN fertilizer | 0.05 (0.025) | lb. (kg) N | 2.25 c | 3.5 de | 5.75 bc | 8.559 bc |
| 4 | Canola Oil Bio- | 2.5 (0.78) | fl. oz. | 3.0 b | 4.5 abc | 6.0 ab | 9.321 ab |
| | Adjuvant | | (ml) | | | | |
| 5 | UAN fertilizer | 0.1 (0.05) | lb. (kg) N | 4.0 a | 4.75 abc | 6.5 a | 9.699 a |
| | Canola Oil Bio- | 5 (1.6) | fl. oz. | | | | |
| | Adjuvant | | (ml) | | | | |
| 6 | UAN fertilizer | 0.05 (0.025) | lb. (kg) N | 4.0 a | 5.0 abc | 6.5 a | 9.292 ab |
| | Canola Oil Bio- | 5 (1.6) | fl. oz. | | | | |
| | Adjuvant | | (ml) | | | | |
| 7 | UAN fertilizer | 0.05 (0.025) | lb. (kg) N | 3.0 b | 4.0 cd | 6.0 ab | 8.801 abc |
| | Canola Oil Bio- | 2.5 (0.78) | fl. oz. | | | | |
| | Adjuvant | | (ml) | | | | |
| 8 | UAN fertilizer | 0.1 (0.05) | lb. (kg) N | 3.25 b | 4.25 bcd | 6.5 a | 9.186 ab |
| | Canola Oil Bio- | 2.5 (0.78) | fl. oz. | | | | |
| | Adjuvant | | (ml) | | | | |
| 9 | Control | | | 1.5 d | 3.0 e | 5.25 c | 7.991 c |

^{a}Means (of 4 reps) followed by the same letter are not significantly different (P = 0.10, LSD).
^{b}Turfgrass quality visual rating scale: 1 = worst, 9 = best, 7 = acceptable.
^{c}Visual biomass increase (individual plant growth and overall density increase) visual rating scale: 1 = least increase, 9 = most increase.
^{d}Canola oil concentrate/canola oil bio-adjuvant = canola oil + Foursome turfgrass pigment + Silwet L-77 surfactant (32:1.6:1 ratio v/v).
^{e}Actual Nitrogen (not a commercial product containing nitrogen).

### Example 4

### 2013 Canola Oil Concentrate Spring “Green-Up”/Winter Dormancy Break Field Study

This study was established on a brown, desiccated, winter-dormant creeping bentgrass putting green (Agrostis palustris) (˜0.15 in (0.038 cm) height of cut) on the same research center as in previous examples. The study was established in four replications of a randomized block design, using 2 ft.×7.5 ft. (0.6 m×2.3 m) plots with 6 in. (0.15 m) alleys. Treatments were applied with the backpack sprayer described in Example 1 operating at 40 PSI (2.8 kg/cm²) with a 96 GPA (898 L/ha) spray volume. Treatments were applied in this “green-up”/winter dormancy break study on a 21-day schedule on Apr. 5, 2013, and Apr. 27, 2013 Turfgrass quality ratings in this example included observations of increased density, increased growth, and degree of color intensity change. These observations were taken on May 11, 2013, and were based on a visual 1 (worst) −9 (best) rating scale, with a 7-rating representing acceptable turfgrass “quality.”

As the data in Table 5 indicates, the canola oil concentrate at both the 4 fl. oz. and 8 fl. oz./1000 sq. ft. (1.27 and 2.55 ml/m²) application rates produced a significantly better quality turfgrass than either the UAN fertilizer only or the untreated control. When tank-mixed with the UAN fertilizer and formulated with a carrier as described herein, the canola oil:concentrate produced a significantly superior turfgrass quality compared to any other treatment in the study. This study demonstrates the biomass improving properties (increased density and growth) of canola oil concentrate and its utility for advancing the timing of improved quality of turfgrass in the spring, as well as improving turfgrass quality when soils are still too cool for bentgrass growth.

This testing also shows that plant oil concentrates, such as the canola oil concentrate tested herein, when properly formulated, can provide a better quality turfgrass surface earlier in the growing season than was previously possible, particularly in terms of color intensity. This surprising characteristic of the canola oil concentrate suggests that a growing season extension may be possible by forcing plants to break winter dormancy earlier than they normally would, even when supplemental fertility is applied (treatment. 4). This supports previous observations that the canola oil concentrate forces increased turfgrass biomass amounts through increased growth and density at very cold soil temperatures, even under snow cover of up to four months duration (as seen in previous snow mold studies not reported here). The mechanism behind this winter surge in biomass amounts is currently unknown. (See also FIG. 18).

TABLE 5
2013 Canola Oil Concentrate Spring “Green-Up”/Winter Dormancy Break Field Study

| | | Rate Per | | | Turfgrass |
|---|---|---|---|---|---|
| Trt | Treatment | 1000 ft² | Rate | Application | Quality^{b} |
| No. | Name | (m²) | Unit | Interval | May 11, 2013 |
| 1 | Canola Oil Concentrate^{c} | 8 (2.55) | fl. oz. (ml) | 14 days | 7.0^{a} b |
| 2 | Canola Oil Concentrate | 4 (1.27) | fl. oz. (ml) | 14 days | 7.0 b |
| 3 | Canola Oil Bio-Adjuvant + | 8 + | fl. oz. (ml) | 14 days | 7.75 a |
| | Urea (46-0-0) | (2.55+) | | | |
| | | 0.2 (0.1) | lb. (kg) N | | |
| 4 | Urea (46-0-0) | 0.2 (0.1) | lb. (kg) N | 14 days | 6.0 c |
| 5 | Control | — | — | — | 5.0 d |

^{a}Means (of 4 reps) followed by the same letter do not significantly differ (P = 0.05, LSD).
^{b}Turfgrass quality visual rating scale: 1 = worst, 9 = best, 7 = acceptable.
^{c}Canola oil concentrate/canola oil bio-adjuvant = canola oil + Foursome turfgrass dye + Silwet L-77 surfactant in a 94.7%:4.7%:0.8% ratio. Subsequent testing conducted at a ratio of 92.5%:4.6%:2.9% (32:1.6:1 ratio v/v).

### Example 5

### 2014 Plant Oil Concentrate/Plant Oil Bio-Adjuvant Substitution Study

This study was established on an irrigated creeping bentgrass (Agrostis palustris) fairway (˜0.5 in (1.3 cm) height of cut) on the same research center as in previous examples. The study was established in four replications of a randomized block design on a fairway, which was substantially uniformly dollar spot infected (Sclerotinia homoeocarpa)), using 2 ft.×10.5 ft. plots (0.6 m×3.2 m) with 6 in. (0.15 m) alleys. Treatments were applied with the small plot sprayer described in Example 1 using the same conditions described in Example 1. Turfgrass quality ratings and biomass ratings were performed as described in Example 1. Clippings were also collected as described in Example 1.

Treatments included food grade soybean oil, canola oil, corn oil, and peanut oil (all purchased at a local grocery store), neem oil (Organic Dews/Vijayarenga Agencies), and food grade mineral oil (Rite Aid Corp.). Treatments were applied initially on Aug. 28, 2014, with a second application on Sep. 12, 2014. The study area was fertilized at the rate of a 0.1 lb N/1000 ft² (0.49 g/m²)/21 days.

As the data in Table 6 indicates, rapid, unexpected synergistic dollar spot control was achieved when the reduced rate 26 GT fungicide was applied with Foursome pigment+Silwet1-77 and either soybean oil, canola oil, corn oil, peanut oil, neem oil, or mineral oil (treatments 3-7 and 22). Dollar spot control was not successful when the components of the above tank mixes were individually applied or applied in groupings without the reduced rate fungicide. Nor did the reduced rate fungicide (treatment 1) or the label rate of the fungicide (treatment 2), applied alone, adequately control dollar spot during this late-season study.

The surprising results of this study suggest that control of dollar spot may be possible with fungicide rates that are reduced by up to 75% below recommended label application rates when utilizing a plant oil concentrate, such as concentrates of soybean oil, canola oil, corn oil and/or neem oil. (Other results suggest the same for glycerol concentrates) (See Table 9). These results further suggests that control of dollar spot may be possible with greatly reduced levels of conventional crop treatment concentrates and products. Based on this and other data, it is likely that plant oil-based concentrates can substitute for petroleum-based mineral oil-containing treatment concentrates and products, reducing the environmental impact of turfgrass treatment even further.

Accompanying the dramatic dollar spot disease control were dramatic turfgrass quality improvements when the plant oils were used in combination with the fungicide at a “low” rate, i.e., at a rate of 1 fl. oz./1000 sq. ft. (0.32 ml/m²) (Table 6). Mean turfgrass quality was significantly better in the plant oil bio-adjuvant/26 GT treatments (treatments 3-7) than in any other treatments in the study, except for treatment 22 reduced rate.

The dramatic dollar spot control improvements and the improved turfgrass quality provided by the reduced rate fungicide/oil tank mixes was supported by the dramatic visual biomass increase with these tank mixes (Table 6). Significant visual biomass increases were observed in (reduced rate) fungicide/plant oil bio-adjuvant tank mixes utilizing reduced rate 26GT fungicide with soybean oil, corn oil, canola oil, peanut oil, or neem oil compared to the reduced rate and label rate 26GT treatments alone (except for peanut oil). Biomass dry weights reflected the visual biomass increases, with the soybean oil, corn oil, neem oil, and mineral oil/reduced rate fungicide tank-mixes clearly showing significantly more biomass (grams, dried) than most other treatments, despite the inherent variability in such data.

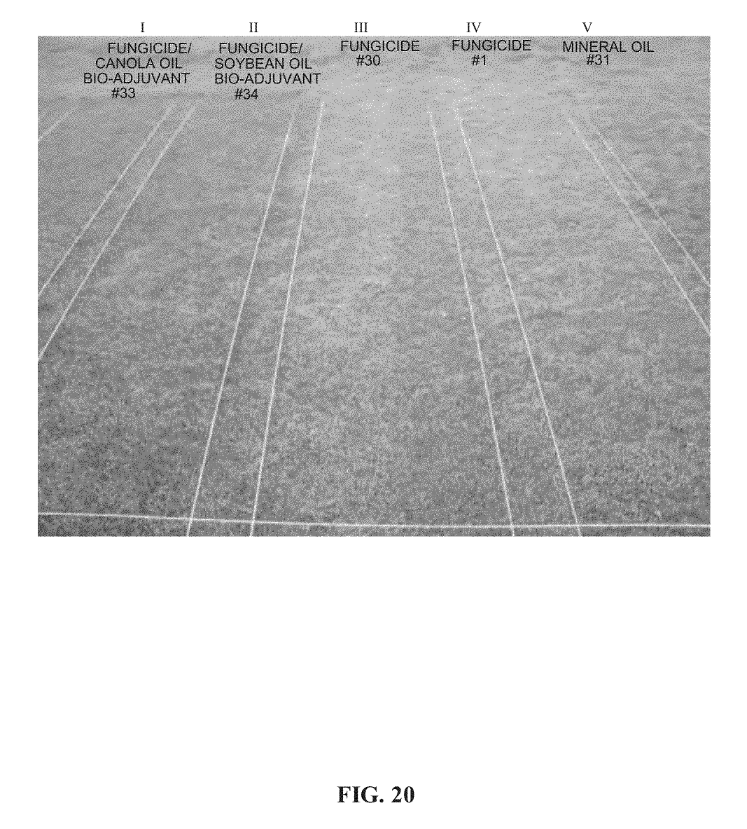

Many of the treatments shown in Table 6 that contained the plant oil bio-adjuvants also exhibited dramatically less dew than treatments without plant oils. Since heavy dews have long been associated with increased dollar spot incidence, treatments to reduce dew extent and duration during the day will also reduce dollar spot pressure. Further, treatments that reduce dew accumulation can also be expected to reduce frost deposition, as shown in Table 6. Even nine days after treatment application, the plant oil+Silwet L-77 treatments (treatments 8-12) and the plant oil+Silwet L-77+Foursome pigment treatments (treatments 13-16) still exhibited significantly less frost than the untreated control. Although the fungicide-alone treatments (treatments 1 and 2) displayed relatively heavy frost, this frost level was significantly reduced in most of the reduced rate fungicide/plant oil bio-adjuvant tank mixes (treatments 3-6). Since morning frost delays golf play due to turfgrass damage resulting from traffic, treatments that reduce frost allow golf course managers to open their courses to play earlier in the day than on courses where frost accumulates/dissipates normally. See also FIGS. 19 and 20.

TABLE 6
2014 Plant Oil Concentrate/Plant Oil Bio-Adjuvant Substitution Study

| | | Rate^{h} | | | | | | |
|---|---|---|---|---|---|---|---|---|
| | | (fl. oz.) | Dollar Spot | | | | Clippings | |
| | | per | Disease | Turfgrass | Visual | Dew | (Biomass) | Frost |
| Trt. | Treatment | 1000 ft² | (%)^{b} | Quality^{c} | (Biomass)^{d} | Formation^{e} | Dry wt (g) | Rating^{g} |
| No. | Name | (ml/m²) | Oct. 1, 2014 | Sep. 24, 2014 | Oct. 1, 2014 | Sep. 14, 2014 | Sep. 19, 2014 | Oct. 11, 2014 |
| 1 | 26 GT | 1 | 41.25^{a} b-d | 4.25^{a} d-g | 1.75^{a} gh | 5^{a} a | 5.37^{a} c-f | 3.75^{a} a |
| | | (0.32) | | | | | | |
| 2 | 26 GT (label | 4 | 19.25 gh | 5 cd | 2.75 c-e | 5 a | 4.86 d-f | 3.25 a-c |
| | rate) | (1.27) | | | | | | |
| 3 | 26 GT+ | 1 | 4 i | 6.5 a | 3.75 a | 1.25 g | 7.58 a | 2.25 e-g |
| | | (0.32) | | | | | | |
| | Soybean Oil+ | 9.25 | | | | | | |
| | | (2.94) | | | | | | |
| | Foursome | 0.46 | | | | | | |
| | pigment+ | (0.15) | | | | | | |
| | Silwet L-77 | 0.29 | | | | | | |
| | surfactant | (.09) | | | | | | |
| 4 | 26 GT+ | 1 | 10 hi | 6.25 a | 3.5 ab | 1.5 fg | 6.1575 a-d | 2.5 d-f |
| | | (0.32) | | | | | | |
| | Canola Oil+ | 9.25 | | | | | | |
| | | (2.94) | | | | | | |
| | Foursome | 0.46 | | | | | | |
| | pigment+ | (0.15) | | | | | | |
| | Silwet L-77 | 0.29 | | | | | | |
| | surfactant | (.09) | | | | | | |
| 5 | 26 GT+ | 1 | 6.5 i | 6.5 a | 3.75 a | 1.5 fg | 7.46 a | 2.5 d-f |
| | | (0.32) | | | | | | |
| | Corn Oil+ | 9.25 | | | | | | |
| | | (2.94) | | | | | | |
| | Foursome | 0.46 | | | | | | |
| | pigment+ | (0.15) | | | | | | |
| | Silwet L-77 | 0.29 | | | | | | |
| | surfactant | (.09) | | | | | | |
| 6 | 26 GT+ | 1 (0.32) | 8.25 i | 6.25 a | 3.25 a-c | 1.25 g | 4.68 ef | 2.5 d-f |
| | Peanut Oil+ | 9.25 | | | | | | |
| | | (2.94) | | | | | | |
| | Foursome | 0.46 | | | | | | |
| | pigment+ | (0.15) | | | | | | |
| | Silwet L-77 | 0.29 | | | | | | |
| | surfactant | (.09) | | | | | | |
| 7 | 26 GT+ | 1 | 3 i | 6.5 a | 3.75 a | 1.75 e-g | 7.35 a | 3 b-d |
| | | (0.32) | | | | | | |
| | Neem Oil+ | 9.25 | | | | | | |
| | | (2.94) | | | | | | |
| | Foursome | 0.46 | | | | | | |
| | pigment+ | (0.15) | | | | | | |
| | Silwet L-77 | 0.29 | | | | | | |
| | surfactant | (.09) | | | | | | |
| 8 | Canola Oil+ | 9.25 | 46.25 bc | 3.25 h-j | 1.25 hi | 1.25 g | 4.875 d-f | 1 j |
| | | (2.94) | | | | | | |
| | Silwet L-77 | 0.29 | | | | | | |
| | surfactant | (.09) | | | | | | |
| 9 | Soybean Oil+ | 9.25 | 40 b-d | 3.5 g-j | 2 fg | 2 d-f | 4.84 d-f | 1.5 h-j |
| | | (2.94) | | | | | | |
| | Silwet L-77 | 0.29 | | | | | | |
| | surfactant | (.09) | | | | | | |
| 10 | Corn Oil+ | 9.25 | 50 ab | 3.75 f-i | 1.75 gh | 1.25 g | 4.6 ef | 1.25 ij |
| | | (2.94) | | | | | | |
| | Silwet L-77 | 0.29 | | | | | | |
| | surfactant | (.09) | | | | | | |
| 11 | Peanut Oil+ | 9.25 | 42.5 b-d | 3.5 g-j | 1 i | 1.5 fg | 4.46 ef | 1.75 g-i |
| | | (2.94) | | | | | | |
| | Silwet L-77 | 0.29 | | | | | | |
| | surfactant | (.09) | | | | | | |
| 12 | Neem Oil+ | 9.25 | 36.25 c-e | 4 e-h | 1.75 gh | 1.25 g | 5.385 c-f | 1.5 h-j |
| | | (2.94) | | | | | | |
| | Silwet L-77 | 0.29 | | | | | | |
| | surfactant | (.09) | | | | | | |
| 13 | Canola Oil+ | 9.25 | 27.5 e-g | 5 cd | 2.5 d-f | 2.25 de | 6.46 a-c | 1.75 g-i |
| | | (2.94) | | | | | | |
| | Silwet L-77 | 0.29 | | | | | | |
| | surfactant+ | (.09) | | | | | | |
| | +Foursome | 0.46 | | | | | | |
| | pigment | (0.15) | | | | | | |
| 14 | Corn Oil+ | 9.25 | 32.5 d-f | 4.75 c-e | 2.25 e-g | 2 d-f | 5.74 b-e | 1.25 ij |
| | | (2.94) | | | | | | |
| | Silwet L-77 | 0.29 | | | | | | |
| | surfactant+ | (.09) | | | | | | |
| | +Foursome | 0.46 | | | | | | |
| | pigment | (0.15) | | | | | | |
| 15 | Soybean Oil+ | 9.25 | 25 fg | 5.25 bc | 3 b-d | 2 d-f | 5.57 b-f | 1.5 h-j |
| | | (2.94) | | | | | | |
| | Silwet L-77 | 0.29 | | | | | | |
| | surfactant | (.09) | | | | | | |
| | +Foursome | 0.46 | | | | | | |
| | pigment | (0.15) | | | | | | |
| 16 | Peanut Oil+ | 9.25 | 32.5 d-f | 5.25 bc | 3 b-d | 2.5 cd | 5.81 b-e | 2 f-h |
| | | (2.94) | | | | | | |
| | Silwet L-77 | 0.29 | | | | | | |
| | surfactant | (.09) | | | | | | |
| | +Foursome | 0.46 | | | | | | |
| | pigment | (0.15) | | | | | | |
| 17 | Neem Oil+ | 9.25 | 35 d-f | 4.5 c-f | 2.5 d-f | 2 d-f | 6.94 ab | 2.5 d-f |
| | | (2.94) | | | | | | |
| | Silwet L-77 | 0.29 | | | | | | |
| | surfactant | (.09) | | | | | | |
| | +Foursome | 0.46 | | | | | | |
| | pigment | (0.15) | | | | | | |
| 18 | Foursome | 0.46 | 33.75 d-f | 5.25 bc | 2.25 e-g | 5 a | 4.7 ef | 3.5 ab |
| | pigment | (0.15) | | | | | | |
| 19 | Silwet L-77 | 0.29 | 50 ab | 2.75 j | 1.25 hi | 3 bc | 4.61 ef | 3 b-d |
| | surfactant | (.09) | | | | | | |
| 20 | Untreated | | 57.5 a | 3 ij | 1.25 hi | 4.75 a | 4.21 f | 2.75 c-e |
| | Control | | | | | | | |
| 21 | Rite Aid brand | 9.25 | 35 d-f | 5 cd | 2.5 d-f | 3.25 b | 5.72 b-e | 2.5 d-f |
| | Mineral Oil+ | (2.94) | | | | | | |
| | Foursome | 0.46 | | | | | | |
| | pigment+ | (0.15) | | | | | | |
| | Silwet L-77 | 0.29 | | | | | | |
| | | (.09) | | | | | | |
| 22 | 26 GT+ | 1 | 12.5 hi | 6 ab | 3.5 ab | 2.5 cd | 6.91 ab | 2.5 d-f |
| | | (0.32) | | | | | | |
| | Rite Aid brand | 9.25 | | | | | | |
| | Mineral Oil+ | (2.94) | | | | | | |
| | Foursome | 0.46 ± | | | | | | |
| | pigment+ | (0.15 ±) | | | | | | |
| | Silwet L-77 | 0.29 | | | | | | |
| | surfactant | (.09) | | | | | | |

^{a}Means (of 4 reps) followed by the same letter are not significantly different: P = 0.05, LSD.
^{b}Disease visual rating scale: Mean % plot area infected with dollar spot (after 2 applications, applied curatively).
^{c}Turfgrass quality visual rating scale: 1 = worst, 9 = best, 7 = acceptable.
^{d}Visual biomass increase (individual plant growth rate and overall density increase) visual rating scale: 1 = least increase, 5 = most increase.
^{e}Dew formation visual scale: 0 = least, 5 = most, 7 days after treatment.
^{f}Canola oil concentrate + surfactant (32:1.6:1 ratio).
^{g}Frost Rating Scale: 1 = least, 5 - most, 9 days after treatment.
^{h}Plant Oil Concentrate/Bio-Adjuvant (32:1.6:1 ratio (v/v) of oil:pigment:surfactant).

### Example 6

### 2014 Canola Oil Concentrate/Canola Oil Bio-Adjuvant Application Rate Effects Study

This study was established on an irrigated, uniformly dollar spot-infected (Sclerotinia homoeocarpa) creeping bentgrass (Agrostis palustris) fairway (˜0.5 in. (1.3 cm) height of cut) on the same research center as in the previous examples. The objective was to examine the effect on dollar spot control and turfgrass biomass increase rate of various canola oil concentrates in tank-mixes with reduced rate 26GT fungicide. The study was established in four replications of a randomized block design using 2 ft.×10.5 ft. (0.6 m×3.2 m) plots with 6″ (0.15 m) alleys. Fertility (urea) was maintained at approximately 0.1 lb N/1000 ft² (0.49 g/m²)/14 days throughout the study duration. Treatments were applied with the same small plot sprayer described in Example 1, using the same conditions as in Example 1. Turfgrass quality ratings and biomass ratings were performed as described in Example 1. Clippings were also collected as described in Example 1. Treatments were applied initially on Sep. 9, 2014, with a second application on Sep. 23, 2014.

As the data in Table 7 indicates, dollar spot control and increased biomass amounts are directly related to the rate of canola oil concentrate used in the fungicide/canola oil concentrate (i.e., canola oil bio-adjuvant) tank-mixes, with the degree of dollar spot control and the rate of turfgrass biomass increase increasing significantly with increasing canola oil bio-adjuvant rate. Turfgrass quality seemed less reliant on the rate of canola oil concentrate application, with all fungicide/canola oil concentrates (canola oil+Foursome pigment+Silwet L-77) producing a significantly better turfgrass quality than the untreated control or the reduced rate fungicide-alone treatment.

TABLE 7
2014 Canola Oil Concentrate and Canola Oil Bio-Adjuvant
Application Rate Effects Study

| | | | Dollar | | | | | |
|---|---|---|---|---|---|---|---|---|
| Trt. | Treatment | | Spot | | Turfgrass | | Visual | |
| No. | Name | Rate^{d} | (%)^{b} | LSD | Quality^{c} | LSD | (Biomass)^{f} | LSD |
| 1 | 26GT | 1 (0.32) | 52.5^{a} | a | 4.5 | de | 1.75 | e |
| 2 | 26GT+ | 1 (0.32) | 36.25 | c | 5.25 | bc | 2.75 | c |
| | Canola Oil Bio- | 2.5 (0.78) | | | | | | |
| | Adjuvant^{e} | | | | | | | |
| 3 | 26GT+ | 1 (0.32) | 37.5 | c | 5.25 | bc | 2.5 | cd |
| | Canola Oil | 5 (1.59) | | | | | | |
| | Bio-Adjuvant | | | | | | | |
| 4 | 26GT+ | 1 (0.32) | 25 | d | 6 | a | 3.5 | ab |
| | Canola Oil Bio- | 10 (3.2) | | | | | | |
| | Adjuvant | | | | | | | |
| 5 | 26GT+ | 1 (0.32) | 21.25 | d | 5.75 | ab | 3.75 | a |
| | Canola Oil | 15 (4.77) | | | | | | |
| | Bio-Adjuvant | | | | | | | |
| 6 | Canola Oil | 2.5 (0.78) | 50 | ab | 4.75 | cd | 2.75 | c |
| | Concentrate | | | | | | | |
| 7 | Canola Oil | 5 (1.59) | 36.25 | c | 5.5 | ab | 2.5 | cd |
| | Concentrate | | | | | | | |
| 8 | Canola Oil | 10 (3.2) | 37.5 | c | 5.25 | bc | 2.5 | cd |
| | Concentrate | | | | | | | |
| 9 | Canola Oil | 15 (4.77) | 25 | d | 5.5 | ab | 3 | bc |
| | Concentrate | | | | | | | |
| 10 | Untreated | | 55 | a | 4 | e | 2 | de |
| | Control | | | | | | | |
| 11 | 26GT (label | 4 (1.27) | 42.5 | bc | 4.75 | cd | 2.5 | cd |
| | rate) | | | | | | | |

^{a}Means (of 4 reps) followed by the same letter are not significantly different P = 0.05, LSD.
^{b}Dollar spot rating scale: % plot area infected.
^{c}Turfgrass quality visual rating scale: (1 = worst, 9 = best, 7 = acceptable.
^{d}Rate Unit - fl. oz./1000 ft² (ml/m²)
^{e}Canola Oil Concentrate/Canola Oil Bio-Adjuvant = canola oil + Foursome pigment + Silwet L-77 (32:1.6:1) ratio v/v).
^{f}Biomass increase (individual plant growth rate and overall density increase:: 1 = least biomass increase, 5 = most increase.

### Example 7

### 2012 Canola Oil Bio-Adjuvant Dollar Spot Study

This study was established on an irrigated, creeping bentgrass (Agrostis palustris)/annual bluegrass (Poa annua) putting green (˜0.15 in (0.038 cm) height of cut) which was infected substantially uniformly with dollar spot (Sclerotinia homoeocarpa) on the same research center as in the previous examples. Treatments were applied using the same sprayer described in Example 1 using the same conditions as described in Example 1. Turfgrass quality ratings were performed as described in Example 1.

Treatments were applied to 2 ft.×7.5 ft. (0.6 m×2.2 m) plots on Sep. 15, 2012 and on Sep. 29, 2012. The study was rated for dollar spot incidence and turfgrass quality on Oct. 4, 2012, as reported in Table 8. Further ratings were not possible due to the onset of turfgrass dormancy.

Soluble (urea) fertilizer was applied on Sep. 15, 2012 at (⅛ lb. (0.06 kg) N/1000 sq. ft. (93 m²) and on Sep. 29, 2012 at 0.1 lb. (0.05 kg) N/1000 sq. ft. (93 m²) As the data in Table 8 indicates, all fungicide-alone treatments failed to promote significantly better control of dollar spot than the untreated control, over the short three-week duration of this study, prior to turf dormancy. However, when the canola oil concentrate containing canola oil, Foursome brand pigment and Silwet L-77 brand surfactant, was applied either alone or as a bio-adjuvant in combination with fungicides, significantly better dollar spot control was observed (Table 8). Insignia SC was applied at full label rate (0.7 fl. oz./1000 sq. ft. (20.7 ml/93 m²)), although Insignia is labelled only for suppression of dollar spot, not dollar spot control. However, in combination with the canola oil bio-adjuvant (treatment 11), even Insignia (a weak dollar spot fungicide) provided significantly improved dollar spot control as compared to the 26GT applied at full label rate (treatment 8 in Table 8). This surprising result provides a basis for label expansion for fungicides, such as Insignia fungicide, allowing reduced label amounts to be used for dollar spot control.

This study illustrates the speed with which canola oil bio-adjuvants, and likely other plant oil-based bio-adjuvants and off-label “reduced rate” fungicides, promote turfgrass recovery from a diseased condition, even as turf dormancy is occurring and biomass increase is slowing. Recovery is expedited through increased biomass growth rate and improved fungicide efficacy.

TABLE 8
2012 Canola Oil Bio-Adjuvant Dollar Spot Study

| | | | | Oct. 4, 2012 | | | |
|---|---|---|---|---|---|---|---|
| | | | | Dollar | | | |
| Canola Oil Dollar Spot Study | | | | Spot^{b} | | Oct. 4, 2012 - | |
| Trt. | | | | (%) | | Quality^{c} | |
| No. | Trt. Name | Rate^{d} | | Mean^{a} | LSD | Mean^{a} | LSD |
| 1 | 26 GT | 1 | (0.32) | 27.5 | ab | 5.75 | ab |
| 2 | 26 GT+ | 1 | (0.32) | 9.75 | de | 6.25 | a |
| | Canola Oil+ | 8 | (2.55) | | | | |
| | Foursome+ | 0.4 | (0.13) | | | | |
| | Silwet L-77 | 2 fl. oz./100 gal | (0.16 ml/L) | | | | |
| 3 | Canola Oil+ | 8 | (2.55) | 19.25 | b-d | 6 | a |
| | Foursome+ | 0.4 | (0.13) | | | | |
| | Silwet L-77 | 2 fl. oz./100 gal | (0.16 ml/L) | | | | |
| 4 | Banner Maxx | 0.25 | (0.08) | 33.75 | a | 4.75 | c |
| 5 | Banner Maxx+ | 1 | (0.32) | 15.5 | c-e | 6.25 | a |
| | Canola Oil+ | 8 | (2.55) | | | | |
| | Foursome+ | 0.4 | (0.13) | | | | |
| | Silwet L-77 | 2 fl. oz./100 gal | (0.16 ml/L) | | | | |
| 6 | Daconil | 1 | (0.32) | 33.75 | a | 4.75 | c |
| | Weatherstik | | | | | | |
| 7 | Daconil | 1 | (0.32) | 6.75 | e | 6.5 | a |
| | Weatherstik+ | | | | | | |
| | Canola Oil+ | 8 | (2.55) | | | | |
| | Foursome+ | 0.4 | (0.13) | | | | |
| | Silwet L-77 | 2 fl. oz./100 gal | (0.16 ml/L) | | | | |
| 8 | 26 GT (label rate) | 4 | (1.27) | 25 | a-c | 5 | bc |
| 9 | Banner Maxx | 1 | (0.32) | 33.75 | a | 5 | bc |
| | (label rate) | | | | | | |
| 10 | Insignia SC | 0.7 | (0.22) | 26.5 | ab | 4.5 | c |
| | (label rate) | | | | | | |
| 11 | Insignia SC+ | 0.7 | (0.22) | 9.25 | e | 6 | a |
| | Canola Oil+ | 8 | (2.55) | | | | |
| | Foursome+ | 0.4 | (0.13) | | | | |
| | Silwet L-77 | 2 fl. oz./100 gal | (0.16 ml/L) | | | | |
| 12 | Untreated Control | | | 31.25 | a | 5 | bc |

^{a}Means (of 4 reps) followed by the same letter are not significantly different P = 0.05, LSD.
^{b}Dollar spot rating scale: % plot area infected.
^{c}Turfgrass quality visual rating scale: 1 = worst, 9 = best, 7 = acceptable.
^{d}Rate Unit - fl. oz./1000 ft² (ml/m²) unless otherwise noted.

### Example 8

### 2014 Canola Oil Concentrate/Canola Oil Bio-Adjuvant Dollar Spot Study

This study was established on an irrigated creeping bentgrass (Agrostis palustris) fairway (˜0.5 in. (1.3 cm) height of cut) which was infected substantially uniformly with dollar spot (Sclerotinia homoeocarpa) on the same research center as in the previous examples. The study was established in four replications of a random block design utilizing 2 ft.×10.5 ft. (0.6 m×3.2 m) plots. Treatments were applied on a 14-day schedule with the backpack sprayer described in Example 1, using the same conditions as in Example 1.

Treatments were applied curatively on Aug. 21, 2014, with reapplications on Sep. 6, 2014 and Sep. 23, 2014. Fertility was maintained at approximately 0.3 lb. (0.15 kg) N/1000 sq. ft. (93 m²)/mo. through August, with no additional fertility being applied in September. The study was rated on Sep. 30, 2014 for percent plot area diseased with dollar spot and for overall turfgrass quality as described in Example 1.

As the data in Table 9 indicates, dollar spot control was still incomplete in all treatments in this curative study six weeks after treatment initiation. Even the standard dollar spot control products applied at full label (“on-label”) rates (treatments 1-3 and 5) failed to fully eradicate the disease. This result is likely due to the low fertility maintained in this trial in order to promote disease pressure. The reduced rate fungicide treatments (treatments 6, 8 and 9) exhibited significantly more disease than the label rate treatments (treatments 1-3 and 5). The addition of Foursome pigment to the reduced rate fungicides (treatments 1-12) significantly improved the efficacy of the reduced rate fungicides applied alone (treatments 6, 8, and 9 9). Foursome pigment was not tested in combination with Triton FLO and Mirage, since these fungicides already contain a green pigment.

The addition of a canola oil concentrate (canola oil and Silwet L-77) to the reduced rate fungicide treatments (treatments 13, 14, and 17 in Table 9) failed to promote dollar spot control that matched the Foursome and reduced rate fungicide treatments (treatments 10-12). Both groups of treatments did, however, promote significant dollar spot control versus the untreated control treatment 23. Interestingly, when the canola oil bio-adjuvant was combined with the reduced rate fungicides (treatments 18-20), dollar spot control was significantly better than when the full label rates of these fungicides was applied alone (treatments 1, 2, and 4). The improved disease control efficacy of the Compass and canola oil bio-adjuvant treatment was especially surprising since Compass is not labelled for suppression or control of dollar spot.

These results show that better disease control is achieved with adequate level of fertilizer, as those skilled in the art understand this to be. Additionally, turfgrass dormancy was starting to occur. The substitution of anhydrous glycerol for the canola oil in the bio-adjuvant and 26GT treatment (treatment 25) also indicates that the glycerol is likely at least equivalent to canola oil in terms of dollar spot control, when the glycerol bio-adjuvant is applied with reduced (off-label) rates e.g., reduced rate of fungicides.

As the turfgrass quality data in Table 9 indicates, the addition of the canola oil or glycerol concentrates to the reduced rate fungicides (treatments 18-20) significantly improved the turfgrass quality, compared to the reduced rate fungicides alone (treatments 4, 6 and 7). The turfgrass quality was equivalent whether the reduced rate 26GT fungicide was applied with the canola oil bio-adjuvant or the glycerol bio-adjuvant.

TABLE 9
2014 Canola Oil Concentrate/Canola Oil Bio-Adjuvant
Fungicide Dollar Spot Study

| | | | | Disease | | Quality | |
|---|---|---|---|---|---|---|---|
| Trt. | | | | Mean^{g} | | Mean^{e} | |
| No. | Treatment Name | Rate^{h} | | (Sep. 30, 2014) | LSD^{a} | (Sep. 30, 2014) | LSD^{a} |
| | Standards: | | | | | | |
| 1 | 26GT | 4 | (1.28) | 36.25 | fg | 5.5 | d-g |
| 2 | Bayleton FLO | 0.5 | (0.16) | 36.25 | fg | 5.25 | e-h |
| 3 | Triton FLO^{f} | 1 | (0.32) | 12.5 | kl | 7 | ab |
| 4 | Compass | 0.2 | (0.06)ⁱ | 47.5 | cd | 5 | f-i |
| 5 | Mirage^{f} | 1 | (0.32) | 10.25 | l | 7.75 | a |
| | Reduced Rates: | | | | | | |
| 6 | 26GT | 1 | (0.32) | 46.25 | c-e | 5.25 | e-h |
| 7 | Bayleton FLO | 0.125 | (0.04) | 37.5 | e-g | 5 | f-i |
| 8 | Triton FLO | 0.14 | (0.05) | 38.75 | d-f | 5.25 | e-h |
| 9 | Mirage | 0.25 | (0.08) | 26.75 | hi | 6.25 | b-d |
| | Reduced Rates + | | | | | | |
| | Pigment: | | | | | | |
| 10 | 26GT+ | 1 | (0.32) | 28.75 | g-i | 6 | c-e |
| | Foursome | 0.46 | (0.15) | | | | |
| 11 | Bayleton FLO+ | 0.125 | (0.04) | 15.5 | j-l | 7 | ab |
| | Foursome | 0.46 | (0.15) | | | | |
| 12 | Compass+ | 0.2 | (0.061)^{I} | 21.25 | i-k | 6.5 | bc |
| | Foursome | 0.46 | (0.15) | | | | |
| | Reduced Rates + | | | | | | |
| | Plant Oil: | | | | | | |
| 13 | 26 GT+ | 1 | (0.32) | 50 | c | 4.75 | g-j |
| | Canola Oil^{b}+ | 9.3 | (2.94) | | | | |
| | Silwet L-77 | 0.3 | (0.095) | | | | |
| 14 | Bayleton FLO+ | 0.125 | (0.04) | 53.75 | bc | 4.5 | h-j |
| | Canola Oil+ | 9.3 | (2.94) | | | | |
| | Silwet L-77 | 0.3 | (0.095) | | | | |
| 15 | Mirage+ | 0.25 | (0.08) | 48.75 | c | 4.75 | g-j |
| | Canola Oil+ | 9.3 | (2.94) | | | | |
| | Silwet L-77 | 0.3 | (0.095) | | | | |
| 16 | TritonFLO+ | 0.14 | (0.05) | 47.5 | cd | 4.75 | g-j |
| | Canola Oil+ | 9.3 | (2.94) | | | | |
| | Silwet L-77 | 0.3 | (0.095) | | | | |
| 17 | Compass+ | 0.2 | (0.06)ⁱ | 60 | ab | 4 | j |
| | Canola Oil+ | 9.3 | (2.94) | | | | |
| | Silwet L-77 | 0.4 | (0.095) | | | | |
| | Reduced Rates + | | | | | | |
| | Bio-Adjuvant: | | | | | | |
| 18^{d} | 26 GT+ | 1 | (0.32) | 25 | hi | 6.5 | bc |
| | Canola Oil Bio- | 10 | (3.17) | | | | |
| | Adjuvant | | | | | | |
| 19^{d} | Bayleton FLO+ | 0.125 | (0.04) | 22.5 | ij | 6.25 | b-d |
| | Canola Oil Bio- | 10 | (3.17) | | | | |
| | Adjuvant | | | | | | |
| 20^{d} | Compass+ | 0.2 | (0.06)ⁱ | 32.5 | f-h | 6.0 | c-e |
| | Canola Oil Bio- | 10 | (3.17) | | | | |
| | Adjuvant | | | | | | |
| 21 | Canola Oil+ | 9.3 | (2.94) | 67.5 | a | 4.25 | ij |
| | Silwet L-77 | 0.3 | (0.095) | | | | |
| 25^{d} | 26 GT+ | 1 | (0.32) | 22.5 | ij | 6.25 | b-d |
| | Glycerol^{c} Bio- | 9.7 | (3.1) | | | | |
| | Adjuvant | | | | | | |
| 23 | Control | | | 66.25 | a | 4.5 | h-j |
| 24^{d} | Canola Oil | 10 | (3.2) | 32.5 | f-h | 5.75 | c-f |
| | Concentrate | | | | | | |

^{a}Means (of 4 reps) followed by the same letter are not significantly different P = 0.05, LSD. ^{a}
^{b}Food grade canola oil.
^{c}Anhydrous glycerol substituted for canola oil + Foursome (both in same volumes and ratios as in canola oil bio-adjuvant). No Silwet L-77 added
^{d}Individual canola oil, Foursome, and Silwet L-77 rates represent actual application rates when applied. Combined application volume = 10 fl. oz./1000 sq. ft. (3.2 ml/m²) trt. 24, 9.7 fl oz/1000 sq. ft. (1.5 ml/m²) with no Silwet L-77 added for trt. 25.
^{e}Turfgrass quality visual rating scale: 1 = worst, 9 = best, 7 = acceptable.
^{f}Fungicide containing green pigment.
^{g}Disease rating scale: percent plot area infected with dollar spot.
^{h}Rate Unit - fl. oz./1000 ft² (ml/m²) unless otherwise noted
ⁱRate Unit - grams (g)

### Example 9

### 2015 Canola Oil Concentrate/Canola Oil Bio-Adjuvant/Fungicide Dollar Spot Study

This study was established preventatively on an irrigated creeping bentgrass (Agrostis palustris)/annual bluegrass (Poa annua) fairway (˜0.5″ (1.3 cm) height of cut) on the same research center as in previous examples. The study was laid out in four replications of a randomized block design, using 2 ft.×7.5 ft. (0.6 m×2.3 m) plots with 6″ (0.15 m) alleys (102 in FIG. 1). Treatments were applied using the same sprayer and under the same conditions described in Example 1. Turfgrass quality ratings were performed as described in Example 1. Dew estimations were made at dawn, based on a 1 (least) to 5 (most) scale, two days after the treatments were applied. Disease data are reported as mean percent observed disease/treatment (Table 10).

All treatments were initiated on Jun. 24, 2015, with the 14 day treatments being re-applied on July 8, July 22, August 4, August 17, August 31, and Sep. 15, 2015. The 21 day treatments were re-applied on July 18, August 6, August 28, and Sep. 16, 2015. Fertility was applied at 0.1 lb N/1000 ft² (0.49 g/m²) on July 16, July 24, and Aug. 6, 2015.

Fungicide application rates were lowered from label recommendations when tank-mixed with the canola oil concentrate, in order to detect the effect of the canola oil bio-adjuvant/fungicide combination.

As the representative data four days after treatment in Table 10 indicates, the Bayer brand Interface fungicide (“Interface”), which is a combination of iprodione and trifloxystrobin, was applied at a reduced rate (less than full label dose) of one (1) fl. oz./1000 sq. ft. (0.32 ml/m²) on a 21-day interval. However, at this rate, the Interface failed to provide adequate dollar spot control, compared to the Emerald standard. (See Treatment 12). However, when it was applied with the canola oil bio-adjuvant at 1% v/v, 5 fl. oz./1000 sq. ft. (1.6 ml/m²), or 10 fl. oz./1000 sq. ft., (3.2 ml/m²) dollar spot control was achieved that was statistically identical to the standard Emerald fungicide treatment (See Treatments 13-15). The 1 fl. oz./1000 sq. ft. (0.32 ml/m²) rate of Interface represents a 50% to 75% reduction in the Interface label rate for fairway dollar spot control on a 21-day application interval.

A similar effect was observed when 26 GT fungicide was applied at 1 fl. oz./1000 sq. ft. (0.32 ml/m²) on a 21-day interval, which also failed to adequately control dollar spot. (See Treatment 6). When combined with a 10 fl. oz./1000 sq. ft. (3.2 ml/m²) rate of the canola oil bio-adjuvant, however, the 1 fl. oz./1000 sq. ft. (0.32/ml/m²) rate of 26 GT provided dollar spot control statistically equivalent to the Emerald standard. (See Treatment 8). The 1 fl. oz./1000 sq. ft. (0.32 ml/m²) rate of 26 GT represents a 50% to 75% reduction from the label rate for fairway dollar spot control on a 21-day interval. (See also Treatments 18 and 19).

When the 26 GT fungicide application rate was increased to 2 fl. oz./1000 sq. ft. (0.64 ml/m²) (lowest label rate), the addition of the canola oil bio-adjuvant did not significantly improve dollar spot control because the 2 fl. oz./1000 sq. ft. (0.64 ml/m²) rate, alone, controlled the dollar spot when applied preventatively on a 21-day interval. (Treatments 5, 9, 20 and 21).

When applied at 1 fl. oz./1000 sq. ft. (0.32 ml/m²) on a 14-day interval, 26 GT alone did not adequately control dollar spot, compared to the Emerald standard (Table 10). However, as with the off-label (reduced) rate of Interface, when this off-label (reduced) rate of 26 GT was combined with the canola oil bio-adjuvant at any rate tested, the dollar spot control was equivalent to the control provided by the Emerald standard, even at 14 days after treatment.

These data suggests that fungicides, such as Interface, can be applied at reduced rates, i.e., below-label rates, without sacrificing dollar spot control, when tank-mixed with a plant oil bio-adjuvant, such as a canola oil bio-adjuvant, at rates of 1% v/v or greater on a 21-day interval. Similarly, 26GT fungicide can be applied at below-label rates when tank-mixed with the canola oil bio-adjuvant at 10 fl. oz./1000 sq. ft. (3.2 ml/m²) or greater at a 21-day interval, or with any tested rate of the adjuvant, if applied on a 14-day interval.

Turfgrass quality data (Table 10) indicates that significantly superior turfgrass quality can be achieved with the use of the canola oil bio-adjuvant in a tank-mix with Interface or 26GT fungicides. This is true when the fungicide use rates are below label rates (Interface and 26GT), or at label rates (26GT).

The data further shows that canola oil concentrate provides no significant dollar spot control alone, and therefore, no turfgrass quality improvement, when applied on a 21-day interval (Table 10).

TABLE 10
2015 Canola Oil Concentrate/Canola Oil Bio-Adjuvant/Fungicide Dollar
Spot Study Fungicide/Bio-Adjuvant Pink Snow Mold Study Disease
Ratings, 2014-15

| Fungicide Reduced Rate | | | | Dollar Spot | | Turfgrass | |
|---|---|---|---|---|---|---|---|
| Groupings/Canola Oil | | | | Disease^{d} | | Quality^{e} | |
| Concentrate Levels | | | | (Aug. 31, 2015) | | (Aug. 31, 2015) | |
| | | | Applic. | | LSD^{a} | | LSD^{a} |
| Trt. No. | Trt. Name | Rate^{c} | Interval | Mean | 0.05 | Mean | 0.05 |
| 12 | Interface | 1 (0.32) | 21 days | 8.75 | d | 6.75 | fg |
| 13 | Interface+ | 1 (0.32) | 21 days | 1 | g | 7.75 | b-d |
| | Bio-Adjuvant | 1^{c} | 21 days | | | | |
| 14 | Interface+ | 1 (0.32) | 21 days | 0.625 | g | 7.75 | b-d |
| | Bio-Adjuvant | 5 (1.6) | 21 days | | | | |
| 15 | Interface+ | 1 (0.32) | 21 days | 0.3125 | g | 9 | a |
| | Bio-Adjuvant | 10 (3.2) | 21 days | | | | |
| 2 | Interface | 2 (0.64) | 21 days | 0.25 | g | 7.75 | b-d |
| 4 | Interface+ | 2 (0.64) | 21 days | 0.5 | g | 8.25 | b |
| | Bio-Adjuvant | 1^{c} | 21 days | | | | |
| 6 | 26 GT | 1 (0.32) | 21 days | 20.5 | b | 6 | hi |
| 8 | 26 GT+ | 1 (0.32) | 21 days | 22.5 | c | 6 | hi |
| | Bio-Adjuvant | 1^{d} | 21 days | | | | |
| 18 | 26 GT+ | 1 (0.32) | 21 days | 8 | de | 6.5 | gh |
| | Bio-Adjuvant | 5 (1.6) | 21 days | | | | |
| 19 | 26 GT+ | 1 (0.32) | 21 days | 1.875 | g | 7.5 | c-e |
| | Bio-Adjuvant | 10 (3.2) | 21 days | | | | |
| 5 | 26 GT | 2 (0.64) | 21 days | 3.625 | d-g | 6.75 | fg |
| 9 | 26 GT+ | 2 (0.64) | 21 days | 3 | e-g | 7.5 | c-e |
| | Bio-Adjuvant | 1^{c} | 21 days | | | | |
| 20 | 26 GT+ | 2 (0.64) | 21 days | 2.5 | fg | 7 | e-g |
| | Bio-Adjuvant | 5 (1.6) | 21 days | | | | |
| 21 | 26 GT+ | 2 (0.64) | 21 days | 0.375 | g | 7.25 | d-f |
| | Bio-Adjuvant | 10 (3.2) | 21 days | | | | |
| 25 | 26 GT | 1 (0.32) | 14 days | 22.5 | b | 5.75 | i |
| 24 | 26 GT+ | 1 (0.32) | 14 days | 4.25 | d-g | 7.25 | d-f |
| | Bio-Adjuvant | 1^{c} | 14 days | | | | |
| 23 | 26 GT+ | 1 (0.32) | 14 days | 2.75 | fg | 7.25 | d-f |
| | Bio-Adjuvant | 5 (1.6) | 14 days | | | | |
| 22 | 26 GT+ | 1 (0.32) | 14 days | 0.8125 | g | 7.25 | d-f |
| | Bio-Adjuvant | 10 (3.2) | 14 days | | | | |
| 3 | Interface | 4 (1.28) | 21 days | 0 | g | 8 | bc |
| 7 | 26 GT | 4 (1.28) | 21 days | 2.5 | fg | 7 | e-g |
| 26 | Emerald | 0.13 | 14 days | 0.1875 | g | 7 | e-g |
| | | (0.04) | | | | | |
| 10 | Canola Oil | 1^{c} | 21 days | 47.5 | a | 2 | j |
| | Concentrate | | | | | | |
| 16 | Canola Oil | 5 (1.6) | 21 days | 47.5 | a | 2 | j |
| | Concentrate | | | | | | |
| 17 | Canola Oil | 10 (3.2) | 21 days | 48.75 | a | 2.25 | j |
| | Concentrate | | | | | | |
| 1 | Untreated | | | 52.5 | a | 2.25 | j |
| | Control | | | | | | |

^{a}Means (of 4 reps) followed by the same letter are not significantly different P = 0.05, LSD.
^{b}% V/V.
^{c}Rate Unit = fl. oz./1000 ft² (ml/m²) unless otherwise marked.
^{d}Disease rating scale: percent dollar spot/plot.
^{e}Turfgrass quality visual rating scale: 1 = worst, 9 = best, 7 = acceptable.

### Example 10

### 2014-2015 Bio-Adjuvant/Fungicide Pink Mold Study

This study was established preventively on an annual irrigated bluegrass (Poa annua) putting green (˜0.15 in (0.038 cm) height of cut) on the same research center as in previous examples. The study was established in four replications of a randomized block design utilizing 2 ft.×7.5 ft. (0.6 m×2.3 m) plots with 6 in. (0.15 m) alleys (102 in FIG. 1). Treatments were applied on Nov. 15, 2014 with the same sprayer and under the same conditions described in Example 1. The study was inoculated with a mixture of Microdochium nivale and Typhula incarnata growing on a sand/cornmeal blend on Oct. 7, 2014, Nov. 17, 2014 and Dec. 6, 2014.

The initial ratings were taken on Dec. 26, 2014 when disease was becoming established prior to permanent snow cover. As the early season data (Table 11) indicates, all reduced rate fungicides tested provided significantly better disease control statistically when applied in a tank-mix with the canola oil bio-adjuvant or the canola oil/neem oil (85%/15%) bio-adjuvant. The reduced rate fungicide/bio-adjuvant combination treatments of Compass or Instrata also provided significantly better disease control than the full-rate treatments of Compass or Instrata (standards). The reduced rate 26 GT/canola oil bio-adjuvant treatment provided disease control equivalent to the label rate of 26 GT, while the reduced rate 26 GT+canola oil/neem oil bio-adjuvant treatment provided significantly better disease control than the label rate 26 GT treatment. Both the canola oil bio-adjuvant and the canola oil/neem oil bio-adjuvant treatments, applied alone, provided significantly improved disease control, compared to the untreated control, and statistically equivalent disease control, compared to the standard fungicides at label rates. The predominant snow mold species was Microdochium nivale.

Late-season disease data (Table 11), taken on Mar. 14, 2015, indicates that, as disease pressure increased unevenly across replicate plots and the treatment residues degraded, a less statistically significant benefit was observed from the addition of bio-adjuvants to the reduced rate fungicides, although the canola oil bio-adjuvant was still significantly improving the performance of the reduced rate Instrata (Treatment #2). In retrospect, the low Compass rate used was still too high in that it controlled the disease too well to show a statistically significant benefit from the addition of bio-adjuvants (Treatment #3). Importantly, all reduced rate fungicide/bio-adjuvant treatments were still providing disease control that was statistically equivalent to the full rate fungicide treatments. Lastly, both the canola oil and canola oil/neem oil bio-adjuvant treatments were still providing significantly improved disease control, compared to the untreated control at 3 months after treatment application.

Early season turfgrass quality ratings (Table 12), taken on Dec. 26, 2014, reflect the significant turfgrass quality enhancement provided by the bio-adjuvants when they were tank-mixed with fungicides. All fungicide/bio-adjuvant combination treatments provided significantly better turfgrass quality than the fungicides applied alone, whether at full rates or reduced rates.

Late-season turfgrass quality data (Table 12), taken on Mar. 14, 2015, showed that the addition of the canola oil and canola oil/neem oil bio-adjuvants to reduced rate fungicides at the time of a single application (Nov. 15, 2014) produced a significant, multi-month turfgrass quality enhancement, as evidenced by improved disease control and better turfgrass color intensity. These results reinforces previous observations in snow mold trials where single application canola oil bio-adjuvant/reduced rate fungicide treatments displayed significantly better disease control, turfgrass quality and biomass increase after 4 months under snow cover than comparable reduced rate fungicide-only treatments.

TABLE 11
Fungicide/Bio-Adjuvant Pink Snow Mold Study Disease
Ratings, 2014-15

| | | | Dollar Spot | | Dollar Spot | |
|---|---|---|---|---|---|---|
| | | | Disease | | Disease | |
| | | | (Dec. 26, | | (Mar. 14, | |
| | | | 2014) | | 2015) | |
| Treatment | Treatment | | | LSD^{a} | | LSD^{a} |
| No. | Name | Rate^{c} | Mean | 0.05 | Mean | 0.05 |
| 1 | Instrata | 2.8 (0.89) | 30 | bc | 33.75 | bc |
| 2 | Instrata+ | 2.8 (0.89) | 1.75 | f | 6.25 | d |
| | Canola Oil | 10 (3.2) | | | | |
| | Bio-Adjuvant | | | | | |
| 3 | Compass | 0.06 (0.02) | 23.75 | c | 13.75 | cd |
| 4 | Compass+ | 0.06 (0.02) | 6.5 | ef | 0 | d |
| | Canola Oil | 10 (3.2) | | | | |
| | Bio-Adjuvant | | | | | |
| 5 | 26 GT | 1 (0.32) | 33.75 | b | 47.5 | ab |
| 6 | 26 GT+ | 1 (0.32) | 22.5 | cd | 32.5 | bc |
| | Canola Oil | 10 (3.2) | | | | |
| | Bio-Adjuvant | | | | | |
| 7 | Instrata+ | 2.8 (0.89) | 5.25 | ef | 21.25 | cd |
| | Canola | 10 (3.2) | | | | |
| | Oil/Neem Oil | | | | | |
| | Bio-Adjuvant | | | | | |
| | (85:15) | | | | | |
| 8 | Compass+ | 0.06 (0.02) | 5 | ef | 1.75 | d |
| | Canola | 10 (3.2) | | | | |
| | Oil/Neem Oil | | | | | |
| | Bio-Adjuvant | | | | | |
| | (85:15) | | | | | |
| 9 | 26 GT+ | 1 (0.32) | 13.75 | de | 23.75 | b-d |
| | Canola | 10 (3.2) | | | | |
| | Oil/Neem Oil | | | | | |
| | Bio-Adjuvant | | | | | |
| | (85:15) | | | | | |
| 10 | Instrata (full | 11 (3.5) | 26.75 | bc | 1.25 | d |
| | label rate) | | | | | |
| 11 | Compass | 0.25 (0.08) | 25 | bc | 0 | d |
| | (full label | | | | | |
| | rate) | | | | | |
| 12 | 26 GT (label | 4 (1.3) | 31.25 | bc | 33.75 | bc |
| | rate) | | | | | |
| 13 | Canola Oil | 10 (3.2) | 22.5 | cd | 18.75 | cd |
| | Bio-Adjuvant | | | | | |
| 14 | Canola | 10 (3.2) | 25.5 | bc | 37.5 | bc |
| | Oil/Neem Oil | | | | | |
| | Bio-Adjuvant | | | | | |
| | (85:15) | | | | | |
| 15 | Untreated | | 52.5 | a | 70 | a |
| | Control | | | | | |

^{a}Means (of 4 reps) followed by the same letter are not significantly different P = 0.05, LSD.
^{b}Disease rating scale: percent plot area infected with Dollar spot spieces Microdochium nivale.
^{c}Rate is fl. oz./1000 ft² (ml/m²)

TABLE 12
Fungicide/Bio-Adjuvant Pink Snow Mold Study Turfgrass
Quality Ratings, 2014-15

| | | | Pink Snow | | Pink Snow | |
|---|---|---|---|---|---|---|
| | | | Mold^{b} | | Mold^{b} | |
| | | | (Dec. 26, | | (Mar. 14, | |
| Treat- | | | 2014) | | 2015) | |
| ment | | | | LSD^{a} | | LSD^{a} |
| No. | Treatment Name | Rate^{c} | Mean | 0.05 | Mean | 0.05 |
| 1 | Instrata | 2.8 (0.89) | 4.75 | ef | 4 | d-g |
| 2 | Instrata+ | 2.8 (0.89) | 7.5 | ab | 6.75 | ab |
| | Canola Oil Bio- | 10 (3.2) | | | | |
| | Adjuvant | | | | | |
| 3 | Compass | 0.06 oz./ | 5 | d-f | 4.25 | d-f |
| | | 1000 ft² | | | | |
| | | (0.02 mg/m²) | | | | |
| 4 | Compass+ | 0.06 oz./ | 7 | b | 7.25 | a |
| | | 1000 ft² | | | | |
| | | (0.02 mg/m²) | | | | |
| | Canola Oil Bio- | 10 (3.2) | | | | |
| | Adjuvant | | | | | |
| 5 | 26 GT | 1 (0.32) | 4.5 | f | 3 | gh |
| 6 | 26 GT+ | 1 (0.32) | 6.25 | c | 4.25 | d-f |
| | Canola Oil Bio- | 10 (3.2) | | | | |
| | Adjuvant | | | | | |
| 7 | Instrata+ | 2.8 (0.89) | 7.75 | a | 5.75 | bc |
| | Canola Oil/Neem | 10 (3.2) | | | | |
| | Oil Bio-Adjuvant | | | | | |
| | (85:15) | | | | | |
| 8 | Compass+ | 0.06 oz./ | 7.5 | ab | 7 | a |
| | | 1000 ft² | | | | |
| | | (0.02 mg/m²) | | | | |
| | Canola Oil/Neem | 10 (3.2) | | | | |
| | Oil Bio-Adjuvant | | | | | |
| | (85:15) | | | | | |
| 9 | 26 GT+ | 1 (0.32) | 7 | b | 5.5 | c |
| | Canola Oil/Neem | 10 (3.2) | | | | |
| | Oil Bio-Adjuvant | | | | | |
| | (85:15) | | | | | |
| 10 | Instrata | 11 (3.5) | 5 | d-f | 4.75 | c-e |
| 11 | Compass | 0.25 oz./ | 5.25 | de | 5 | cd |
| | | 1000 ft² | | | | |
| | | (.08 mg/m²) | | | | |
| 12 | 26 GT | 4 (1.3) | 4.5 | f | 3.5 | fg |
| 13 | Canola Oil Bio- | 10 (3.2) | 6.25 | c | 4 | d-g |
| | Adjuvant | | | | | |
| 14 | Canola Oil/Neem | 10 (3.2) | 5.5 | d | 3.75 | e-g |
| | Oil Bio-Adjuvant | | | | | |
| | (85:15) | | | | | |
| 15 | Untreated | | 3.75 | g | 2 | h |
| | Control | | | | | |

^{a}Means (of 4 reps) followed by the same letter are not significantly different P = 0.05, LSD.
^{b}Turfgrass quality visual rating scale: 1 = worst, 9 = best, 7 = acceptable.
^{c}Rate is fl. oz./1000 ft² (ml/m²) unless otherwise noted.

### Example 11

### 2015 Bio-Adjuvant Turfgrass Spring “Green-Up” (Dormancy Break) Study

This study was established on a creeping bentgrass (Agrostis palustris) putting green (˜0.15 in (0.038 cm) height of cut) on the same research center as previous examples. Treatments were applied in the same manner and using the same equipment as previously described in Example 1. Turfgrass quality ratings and biomass ratings were performed as described in Example 1. Clippings were also collected as described in Example 1.

Treatments were applied once only to 2 ft (0.7 m)×10.5 ft (3.2 m) plots of turfgrass on Apr. 1, 2015, while the turfgrass was still in winter dormancy (desiccated, brown, and thin). No additional applications were made to the study area. The study was rated visually for turfgrass biomass increase on Apr. 3, 2015 (2 days after treatment), on Apr. 11, 2015, and on Apr. 17, 2015. Turfgrass quality ratings were taken on Apr. 11, 2015 and Apr. 17, 2015. Turfgrass clippings were collected, dried, and weighed on Apr. 19, 2015 and May 2, 2015.

As the data in Table 13 indicates, by Apr. 3, 2015, most of the bio-adjuvant treatments had already produced a significant visual biomass increase surge in the turfgrass, compared to the untreated control (treatment #1). The exceptions were the urea only treatment (treatment 8) and the neem oil 1% v/v treatment (treatment #9). The canola oil and neem oil bio-adjuvants, applied alone, produced significant visual turfgrass biomass increase that was directly related to the concentration of bio-adjuvant applied. This direct application rate-biomass increase rate relationship was partially evident in the subsequent 3 biomass increase assessments (through Apr. 25, 2015) as well, despite waning spray residues.

Although dried clipping data is notoriously variable with small plots, the data in Table 14 generally supports the visual biomass increase rating data with the highest rate canola oil bio-adjuvant treatment (treatment #4) producing significantly more clippings than the untreated control (treatment #1) on both collection dates. Where the canola oil adjuvant was applied with urea (treatments #5-7) the clipping weights were not significantly different from the untreated control, although there was a trend toward more clippings where the combination was applied. Combination treatments #5 and #7 also produced significantly more clippings than the urea alone treatment (treatment #8) on the Apr. 19, 2015 collection date.

Although the differences were no longer significant on the May 2, 2015 collection date, the trend toward more clippings where the combinations were applied (versus the untreated control) was still evident. Where the neem oil bio-adjuvant was applied, either alone (treatments 9-11), or in combination with urea (treatments 12-14), no significant clipping weight differences were observed, compared to the untreated control in the Apr. 19, 2015 clipping collection. Compared to the urea-only treatment (treatment 8), however, all neem oil and urea combination treatments (treatments #12-14) produced significantly more clippings than the urea-only treatment (treatment 8) at the time of the Apr. 19, 2015 collection. By the May 2, 2015 collection date, the two high-rate neem oil bio-adjuvant/urea combinations treatments #13 and #14) had produced significantly more clippings than either the untreated control (treatment #1) or the urea only treatment (treatment 8).

In terms of turfgrass quality (Table 15), most canola oil and neem oil bio-adjuvant treatments, whether applied alone or with urea, significantly improved turfgrass quality on the Apr. 4, 2015 and Apr. 25, 2015 rating dates, compared to the untreated control (treatment #1) and the urea only treatment. At the time of the April 17 rating, all treatments were producing a significantly better quality turfgrass than the untreated control. The trend in the turfgrass quality data also indicates that the turfgrass quality generally improved as the rate of either bio-adjuvant increased, whether applied alone or with urea.

TABLE 13
2015 Bio-Adjuvant Turfgrass Spring “Green-Up” Study - Turfgrass Appearance (Biomass)

| | | | | Apr. 3, 2015 | | Apr. 11, 2015 | | Apr. 17, 2015 | | Apr. 25, 2015 | |
|---|---|---|---|---|---|---|---|---|---|---|---|
| | | | | Appearance | | Appearance | | Appearance | | Appearance | |
| | | | | (Biomass | | (Biomass | | (Biomass | | (Biomass | |
| | | | | Increase)^{b} | | Increase)^{b} | | Increase)^{b} | | Increase)^{b} | |
| | | | | Apr. 3, 2015 | | Apr. 11, 2015 | | Apr. 17, 2015 | | Apr. 25, 2015 | |
| Treatment | Treatment | | | | LSD^{a} | | LSD^{a} | | LSD^{a} | | LSD^{a} |
| No. | Name | Rate^{c} | Rate Unit | Mean | 0.05% | Mean | 0.05% | Mean | 0.05% | Mean | 0.05% |
| 1 | Untreated | | | 1 | e | 1.25 | h | 1.5 | g | 1 | f |
| | Control | | | | | | | | | | |
| 2 | Canola | 1 | % v/v | 2 | cd | 2.25 | g | 2.75 | ef | 2.25 | de |
| | Oil Bio- | | | | | | | | | | |
| | Adjuvant | | | | | | | | | | |
| 3 | Canola | 5 (1.6) | fl. oz./1000 ft² (ml/m²) | 3.5 | b | 3.5 | de | 3.25 | c-e | 3 | bc |
| | Oil Bio- | | | | | | | | | | |
| | Adjuvant | | | | | | | | | | |
| 4 | Canola | 10 (3.2) | fl. oz./1000 ft² (ml/m²) | 4.75 | a | 4.75 | ab | 4.5 | ab | 3.75 | a |
| | Oil Bio- | | | | | | | | | | |
| | Adjuvant+ | | | | | | | | | | |
| 5 | Canola | 1 | % v/v | 2.25 | cd | 3 | ef | 3 | d-f | 2.5 | cd |
| | Oil Bio- | | | | | | | | | | |
| | Adjuvant+ | | | | | | | | | | |
| | Urea | 0.2 (0.1) | lb. N/1000 ft² (kg | | | | | | | | |
| | | | N/m²) | | | | | | | | |
| 6 | Canola | 5 (1.6) | fl. oz./1000 ft² (ml/m²) | 3.75 | b | 4.25 | bc | 4 | a-c | 3.5 | ab |
| | Oil Bio- | | | | | | | | | | |
| | Adjuvant+ | | | | | | | | | | |
| | Urea | 0.2 (0.1) | lb. N/1000 ft² (kg | | | | | | | | |
| | | | N/m²) | | | | | | | | |
| 7 | Canola | 10 (3.2) | fl. oz./1000 ft² (ml/m²) | 4.25 | ab | 5 | a | 4.75 | a | 4 | a |
| | Oil Bio- | | | | | | | | | | |
| | Adjuvant+ | | | | | | | | | | |
| | Urea | 0.2 (0.1) | lb. N/1000 ft² (kg | | | | | | | | |
| | | | N/m²) | | | | | | | | |
| 8 | Urea only | 0.2 (0.1) | lb. N/1000 ft² (kg | 1.5 | de | 2.5 | fg | 3 | d-f | 2.25 | de |
| | | | N/m²) | | | | | | | | |
| 9 | Neem Oil | 1 | % v/v | 1.5 | de | 2.25 | g | 2.25 | fg | 1.75 | e |
| | Bio- | | | | | | | | | | |
| | Adjuvant | | | | | | | | | | |
| 10 | Neem Oil | 5 (1.6) | fl. oz./1000 ft² (ml/m²) | 2.5 | c | 2.75 | fg | 2.75 | ef | 2.25 | de |
| | Bio- | | | | | | | | | | |
| | Adjuvant | | | | | | | | | | |
| 11 | Neem Oil | 10 (3.2) | fl. oz./1000 ft² (ml/m²) | 4 | ab | 3.75 | cd | 3.75 | b-d | 3 | bc |
| | Bio- | | | | | | | | | | |
| | Adjuvant | | | | | | | | | | |
| 12 | Neem Oil | 1 | % v/v | 2 | cd | 3 | ef | 3 | d-f | 2.75 | cd |
| | Bio- | | | | | | | | | | |
| | Adjuvant+ | | | | | | | | | | |
| | Urea | 0.2 (0.1) | lb. N/1000 ft² (kg | | | | | | | | |
| | | | N/m²) | | | | | | | | |
| 13 | Neem Oil | 5 (1.6) | fl. oz./1000 ft² (ml/m²) | 3.5 | b | 3.5 | de | 3.5 | c-e | 3 | bc |
| | Bio- | | | | | | | | | | |
| | Adjuvant+ | | | | | | | | | | |
| | Urea | 0.2 (0.1) | lb. N/1000 ft² (kg | | | | | | | | |
| | | | N/m²) | | | | | | | | |
| 14 | Neem Oil | 10 (3.2) | fl. oz./1000 ft² (ml/m²) | 3.75 | b | 4.25 | bc | 4.5 | ab | 3.75 | a |
| | Bio- | | | | | | | | | | |
| | Adjuvant+ | | | | | | | | | | |
| | Urea | 0.2 (0.1) | lb. N/1000 ft² (kg | | | | | | | | |
| | | | N/m²) | | | | | | | | |

^{a}Means (of 4 reps) followed by the same letter are not significantly different P = 0.05, LSD.
^{b}Turfgrass biomass visual increase rating scale: 1 = least increase, 5 = most increase.
^{c}Rate is fl. oz./1000 ft² (ml/m²) unless otherwise noted.

TABLE 14
2015 Bio-Adjuvant Turfgrass Spring “Green-Up” Study - Dried Clippings Weights

| | | | | Clippings | | Clippings | |
|---|---|---|---|---|---|---|---|
| | | | | (Biomass) | | (Biomass) | |
| | | | | Dry wt (g) | | Dry wt (g) | |
| | | | | Apr. 19, 2015 | | May 2, 2015 | |
| Treatment | Treatment | | | | LSD | | LSD |
| No. | Name | Rate | Rate Unit^{b} | Mean | 0.05%^{a} | Mean | 0.05%^{a} |
| 1 | Untreated | | | 5.21 | bc | 6.373 | cd |
| | Control | | | | | | |
| 2 | Canola Oil | 1 | % v/v | 6.59 | ab | 7.665 | a-c |
| | Bio- | | | | | | |
| | Adjuvant | | | | | | |
| 3 | Canola Oil | 5 (1.6) | | 5.478 | bc | 6.778 | a-d |
| | Bio- | | | | | | |
| | Adjuvant | | | | | | |
| 4 | Canola Oil | 10 (3.2) | | 7.26 | a | 8.153 | a |
| | Bio- | | | | | | |
| | Adjuvant | | | | | | |
| 5 | Canola Oil | 1 | % v/v | 6.625 | ab | 7.035 | a-d |
| | Bio- | | | | | | |
| | Adjuvant+ | | | | | | |
| | Urea | 0.2 (0.1) | lb. N/1000 ft² | | | | |
| | | | (kg N/m²) | | | | |
| 6 | Canola Oil | 5 (1.6) | | 5.825 | a-c | 6.768 | a-d |
| | Bio- | | | | | | |
| | Adjuvant+ | | | | | | |
| | Urea | 0.2 (0.1) | lb. N/1000 ft² | | | | |
| | | | (kg N/m²) | | | | |
| 7 | Canola Oil | 10 (3.2) | | 6.623 | ab | 6.973 | a-d |
| | Bio- | | | | | | |
| | Adjuvant+ | | | | | | |
| | Urea | 0.2 (0.1) | lb. N/1000 ft² | | | | |
| | | | (kg N/m²) | | | | |
| 8 | Urea only | 0.2 (0.1) | lb. N/1000 ft² | 4.623 | c | 6.175 | d |
| | | | (kg N/m²) | | | | |
| 9 | Neem Oil | 1 | % v/v | 5.385 | bc | 5.84 | d |
| | Bio- | | | | | | |
| | Adjuvant | | | | | | |
| 10 | Neem Oil | 5 (1.6) | | 4.755 | c | 6.89 | a-d |
| | Bio- | | | | | | |
| | Adjuvant | | | | | | |
| 11 | Neem Oil | 10 (3.2) | | 5.818 | a-c | 6.588 | b-d |
| | Bio- | | | | | | |
| | Adjuvant | | | | | | |
| 12 | Neem Oil | 1 | % v/v | 6.358 | ab | 7.025 | a-d |
| | Bio- | | | | | | |
| | Adjuvant+ | | | | | | |
| | Urea | 0.2 (0.1) | lb. N/1000 ft² | | | | |
| | | | (kg N/m²) | | | | |
| 13 | Neem Oil | 5 (1.6) | | 6.593 | ab | 8.028 | a |
| | Bio- | | | | | | |
| | Adjuvant+ | | | | | | |
| | Urea | 0.2 (0.1) | lb. N/1000 ft² | | | | |
| | | | (kg N/m²) | | | | |
| 14 | Neem Oil | 10 (3.2) | | 6.478 | ab | 7.995 | ab |
| | Bio- | | | | | | |
| | Adjuvant+ | | | | | | |
| | Urea | 0.2 (0.1) | lb. N/1000 ft² | | | | |
| | | | (kg N/m²) | | | | |

^{a}Means (of 4 reps) followed by the same letter are not significantly different P = 0.05, LSD.
^{b}Rate is fl. oz./1000 ft² (ml/m²) unless otherwise noted.

TABLE 15
2015 Bio-Adjuvant Turfgrass Spring “Green-Up” Study - Turfgrass Quality

| | | | | Apr. 11, 2015 | | Apr. 17, 2015 | | Apr. 25, 2015 | |
|---|---|---|---|---|---|---|---|---|---|
| | | | | Turfgrass | | Turfgrass | | Turfgrass | |
| | | | | Quality^{b} | | Quality^{b} | | Quality^{b} | |
| Trt. | Treatment | | Rate | | LSD | | LSD | | LSD |
| No. | Name | Rate | Unit^{c} | Mean | 0.05%^{a} | Mean | 0.05%^{a} | Mean | 0.05%^{a} |
| 1 | Untreated | | | 4.75 | f | 4.5 | h | 4.5 | f |
| | Control | | | | | | | | |
| 2 | Canola Oil | 1 | % v/v | 5.5 | d-f | 5.5 | g | 5.25 | d-f |
| | Bio- | | | | | | | | |
| | Adjuvant | | | | | | | | |
| 3 | Canola Oil | 5 | | 6.25 | b-d | 6.25 | d-f | 6 | b-d |
| | Bio- | (1.6) | | | | | | | |
| | Adjuvant | | | | | | | | |
| 4 | Canola Oil | 10 | | 7 | ab | 7.25 | ab | 7.25 | a |
| | Bio- | (3.2) | | | | | | | |
| | Adjuvant | | | | | | | | |
| 5 | Canola Oil | 1 | % v/v | 5.75 | c-e | 6 | d-g | 5.5 | de |
| | Bio- | | | | | | | | |
| | Adjuvant+ | | | | | | | | |
| | Urea | 0.2 | lb. | | | | | | |
| | | (0.1) | N/1000 ft² | | | | | | |
| | | | (kg | | | | | | |
| | | | N/m²) | | | | | | |
| 6 | Canola Oil | 5 | | 6.75 | ab | 6.75 | b-d | 6.75 | ab |
| | Bio- | (1.6) | | | | | | | |
| | Adjuvant+ | | | | | | | | |
| | Urea | 0.2 | lb. | | | | | | |
| | | (0.1) | N/1000 ft² | | | | | | |
| | | | (kg | | | | | | |
| | | | N/m²) | | | | | | |
| 7 | Canola Oil | 10 | | 7.25 | a | 7.5 | a | 7.25 | a |
| | Bio- | (3.2) | | | | | | | |
| | Adjuvant+ | | | | | | | | |
| | Urea | 0.2 | lb. | | | | | | |
| | | (0.1) | N/1000 ft² | | | | | | |
| | | | (kg | | | | | | |
| | | | N/m²) | | | | | | |
| 8 | Urea only | 0.2 | lb. | 5.5 | d-f | 5.5 | g | 5.75 | c-e |
| | | (0.1) | N/1000 ft² | | | | | | |
| | | | (kg | | | | | | |
| | | | N/m²) | | | | | | |
| 9 | Neem Oil | 1 | % v/v | 5.25 | ef | 5.5 | g | 5 | ef |
| | Bio- | | | | | | | | |
| | Adjuvant | | | | | | | | |
| 10 | Neem Oil | 5 | | 5.5 | d-f | 5.75 | fg | 5.5 | de |
| | Bio- | (1.6) | | | | | | | |
| | Adjuvant | | | | | | | | |
| 11 | Neem Oil | 10 | | 6.5 | a-c | 6.75 | b-d | 6.75 | ab |
| | Bio- | (3.2) | | | | | | | |
| | Adjuvant | | | | | | | | |
| 12 | Neem Oil | 1 | % v/v | 5.75 | c-e | 6 | e-g | 6.5 | a-c |
| | Bio- | | | | | | | | |
| | Adjuvant+ | | | | | | | | |
| | Urea | 0.2 | lb. | | | | | | |
| | | (0.1) | N/1000 ft² | | | | | | |
| | | | (kg | | | | | | |
| | | | N/m²) | | | | | | |
| 13 | Neem Oil | 5 | | 6.25 | b-d | 6.5 | c-e | 6.5 | a-c |
| | Bio- | (1.6) | | | | | | | |
| | Adjuvant+ | | | | | | | | |
| | Urea | 0.2 | lb. | | | | | | |
| | | (0.1) | N/1000 ft² | | | | | | |
| | | | (kg | | | | | | |
| | | | N/m²) | | | | | | |
| 14 | Neem Oil | 10 | | 7 | ab | 7 | a-c | 7.25 | a |
| | Bio- | (3.2) | | | | | | | |
| | Adjuvant+ | | | | | | | | |
| | Urea | 0.2 | lb. | | | | | | |
| | | (0.1) | N/1000 ft² | | | | | | |
| | | | (kg | | | | | | |
| | | | N/m²) | | | | | | |

^{a}Means (of 4 reps) followed by the same letter are not significantly different P = 0.05, LSD.
^{b}Turfgrass quality visual rating scale: 1 = worst, 9 = best, 7 = acceptable.
^{c}Rate is fl. oz./1000 ft² (ml/m²) unless otherwise noted.

### Example 12

### Crown Rot Anthracnose Management on a Putting Green Using a Canola Oil Bio-Adjuvant with Reduced-Rate Fungicides, 2015

This preventive crown rot anthracnose (Collectotrichum cereale) fungicide+canola oil bio-adjuvant study was established on the same turfgrass research center described in Example 1 using the same procedures and equipment described in Example 1. Turfgrass quality ratings were performed as described in Example 1.

The treatments were applied to 4 replicates of irrigated 2 ft.×7.5 ft. (0.6 m×2.3 m) plots of annual bluegrass (Poa annua) putting green turf on Jun. 6, 2015, Jun. 20, 2015, Jul. 1, 2015, Jul. 16, 2015, Jul. 29, 2015, and Aug. 15, 2015 for the 14-day interval treatments and on Jun. 6, 2015, Jul. 1, 2015, and Jul. 29, 2015 for the 28-day interval treatments.

The study was inoculated with the anthracnose pathogen growing on a mixture of sand and corn meal on Jun. 5, 2015, Jun. 10, 2015, and Jun. 18, 2015. Fertility was applied to the study on Jul. 14, 2015 at 1/10 lb. (0.04 kg) N/1000 sq. ft. (93 m²) on Jul. 25, 2015 at ⅛ lb. (0.06 kg) N/1000 sq. ft. (93 m²) and on Aug. 17, 2015 015 at 1/10 lb. (0.04 kg) N/1000 sq. ft. (93 m²). The study was background sprayed for dollar spot control with Emerald fungicide (0.15 fl. oz./1000 sq. ft.) on Jun. 7, 2015, Jul. 6, 2015 and Jul. 20, 2015. The study was rated for percent disease and turfgrass quality on Jun. 19, 2015, Jun. 30, 2015, Jul. 7, 2015, Jul. 14, 2015, Jul. 28, 2015, Aug. 13, 2015, and Aug. 24, 2015.

TABLE 16
Crown Rot Anthracnose (CRA) Incidence in a Canola Oil Bio-Adjuvant and Reduced
Rate Fungicide Putting Green Study, 2015

| | | Jul. 14, 2015 % CRA^{c} | | | Jul. 28, 2015 % CRA^{c} | | Aug. 13, 2015 % CRA^{c} | | |
|---|---|---|---|---|---|---|---|---|---|
| Treatment^{d} | Treatment | | App | | 0.05 | | 0.05 | | 0.05 |
| No. | Name | Rate^{b} | Interval | Mean^{a} | LSD | Mean^{a} | LSD | Mean^{a} | LSD |
| 1 | Banner Maxx | 2 | 14 days | 35 | b-f | 25 | d-f | 14.25 | g |
| | Spray | (0.64) | | | | | | | |
| 2 | Torque Spray | 0.6 | 28 days | 43.75 | a-c | 28.75 | d-f | 26.25 | d-g |
| | | (0.19) | | | | | | | |
| 5 | Trinity+ | 1 | 14 days | 43.75 | a-c | 22.5 | ef | 17.5 | g |
| | | (0.32) | | | | | | | |
| | Insignia SC | 0.4 | 14 days | | | | | | |
| | Spray | (0.13) | | | | | | | |
| 7 | Compass | 0.2 | 14 days | 40 | b-e | 45 | ab | 51.25 | ab |
| | Spray | (0.06) | | | | | | | |
| 8 | Compass+ | 0.05 | 14 days | 21.25 | g-i | 30 | c-f | 36.25 | c-e |
| | | (0.015) | | | | | | | |
| | Canola Oil | 10 | 14 days | | | | | | |
| | Bio-Adjuvant | (3.2) | | | | | | | |
| 9 | Banner Maxx+ | 0.5 | 14 days | 10.5 | i | 19.25 | f | 24.25 | e-g |
| | | (0.16) | | | | | | | |
| | Canola Oil | 10 | 14 days | | | | | | |
| | Bio-Adjuvant | (3.2) | | | | | | | |
| 10 | Trinity+ | 0.25 | 14 days | 13.75 | hi | 16.25 | f | 17.25 | g |
| | | (0.08) | | | | | | | |
| | Insignia SC+ | 0.1 | 14 days | | | | | | |
| | | (0.03) | | | | | | | |
| | Canola Oil | 10 | 14 days | | | | | | |
| | Bio-Adjuvant | (3.2) | | | | | | | |
| 11 | Canola Oil | 10 | 14 days | 31.25 | d-g | 28.75 | d-f | 35 | c-e |
| | Bio-Adjuvant | (3.2) | | | | | | | |
| 12 | Torque+ | 0.15 | 28 days | 23.75 | f-h | 26.25 | d-f | 18 | g |
| | | (0.05) | | | | | | | |
| | Canola Oil | 10 | 28 days | | | | | | |
| | Bio-Adjuvant | (3.2) | | | | | | | |
| 13 | Compass | 0.05 | 14 days | 40 | b-e | 38.75 | b-d | 40 | bc |
| | | (0.016) | | | | | | | |
| 14 | Trinity+ | 0.25 | 14 days | 46.25 | ab | 45 | ab | 43.75 | a-c |
| | | (0.08) | | | | | | | |
| | Insignia | 0.1 | 14 days | | | | | | |
| | | (0.03) | | | | | | | |
| 15 | Torque | 0.15 | 28 days | 41.25 | b-d | 47.5 | ab | 40 | bc |
| | | (0.05) | | | | | | | |
| 16 | Banner Maxx | 0.5 | 14 days | 45 | a-c | 43.75 | bc | 32.5 | c-f |
| | | (0.16) | | | | | | | |
| 17 | Untreated | | | 55 | a | 58.75 | a | 53.75 | a |
| | Control | | | | | | | | |
| 18 | Torque+ | 0.15 | 14 days | 36.25 | b-e | 35 | b-e | 38.75 | b-d |
| | | (0.05) | | | | | | | |
| | Canola Oil | 5 | 14 days | | | | | | |
| | Bio-Adjuvant | (1.6) | | | | | | | |
| 19 | Torque+ | 0.15 | 14 days | 33.75 | c-f | 45 | ab | 42.5 | a-c |
| | | (0.05) | | | | | | | |
| | Canola Oil | 1% | 14 days | | | | | | |
| | Bio-Adjuvant | V/V | | | | | | | |

^{a}Means (of 4 reps) followed by the same letter are not significantly different P = 0.05, LSD.
^{b}Rate: fl. oz./1000 ft² (ml/m²) unless otherwise stated.
^{c}Rating Scale: Mean percent/treatment of crown rot anthracnose (Colletofrichum cereale).
^{d}Treatments 3 and 4 are proprietary.

TABLE 17
Turfgrass Quality in a Crown Rot Anthracnose Putting Green Study Using Canola Oil
Bio-Adjuvant + Reduced rate Fungicides, 2015

| | | | | Jul. 14, 2015 | | Jul. 28, 2015 | |
|---|---|---|---|---|---|---|---|
| | | | | Turfgrass | | Turfgrass | |
| | | | | Quality^{c} | | Quality^{c} | |
| Trt.^{d} | Trt. | | Application | | 0.05 | | 0.05 |
| No. | Name | Rate^{b} | Interval | Mean^{a} | LSD | Mean^{a} | LSD |
| 1 | Banner Maxx | 2 | 14 days | 5.25 | c-e | 5.5 | a-c |
| | Spray | (0.64) | | | | | |
| 2 | Torque Spray | 0.6 | 28 days | 5 | d-f | 4.75 | c-f |
| | | (0.19) | | | | | |
| 5 | Trinity+ | 1 | 14 days | 4.5 | f-h | 5.25 | a-d |
| | | (0.32) | | | | | |
| 5 | Insignia SC | 0.4 | 14 days | | | | |
| | Spray | (0.13) | | | | | |
| 7 | Compass | 0.2 | 14 days | 4.75 | e-g | 4 | fg |
| | Spray | (0.06) | | | | | |
| 8 | Compass+ | 0.05 | 14 days | 5.75 | bc | 5.25 | a-d |
| | | (0.016) | | | | | |
| 8 | Canola Oil | 10 | 14 days | | | | |
| | Bio-Adjuvant | (3.2) | | | | | |
| 9 | Banner Maxx+ | 0.5 | 14 days | 6.5 | a | 6 | a |
| | | (0.16) | | | | | |
| 9 | Canola Oil | 10 | 14 days | | | | |
| | Bio-Adjuvant | (3.2) | | | | | |
| 10 | Trinity+ | 0.25 | 14 days | 6 | ab | 6 | a |
| 10 | Insignia SC+ | 0.1 | 14 days | | | | |
| | | (0.03) | | | | | |
| 10 | Canola Oil | 10 | 14 days | | | | |
| | Bio-Adjuvant | (3.2) | | | | | |
| 11 | Canola Oil | 10 | 14 days | 5.75 | bc | 5.75 | ab |
| | Bio-Adjuvant | (3.2) | | | | | |
| 12 | Torque+ | 0.15 | 28 days | 5.75 | bc | 4.75 | c-f |
| | | (0.05) | | | | | |
| 12 | Canola Oil | 10 | 28 days | | | | |
| | Bio-Adjuvant | (3.2) | | | | | |
| 13 | Compass | 0.05 | 14 days | 4.25 | g-i | 4.25 | e-g |
| | | (0.016) | | | | | |
| 14 | Trinity+ | 0.25 | 14 days | 4 | hi | 4.25 | e-g |
| | | (0.08) | | | | | |
| 14 | Insignia | 0.1 | 14 days | | | | |
| | | (0.03) | | | | | |
| 15 | Torque | 0.15 | 28 days | 4.5 | f-h | 4 | fg |
| | | (0.05) | | | | | |
| 16 | Banner Maxx | 0.5 | 14 days | 4.5 | f-h | 4.25 | e-g |
| | | (0.16) | | | | | |
| 17 | Untreated | | | 3.75 | i | 3.5 | g |
| | Control | | | | | | |
| 18 | Torque+ | 0.15 | 14 days | 4.25 | g-i | 4.5 | d-f |
| | | (0.05) | | | | | |
| 18 | Canola Oil | 5 | 14 days | | | | |
| | Bio-Adjuvant | (1.6) | | | | | |
| 19 | Torque+ | 0.15 | 14 days | 4.25 | g-i | 4.25 | e-g |
| | | (0.05) | | | | | |
| 19 | Canola Oil | 1% | 14 days | | | | |
| | Bio-Adjuvant | V/V | | | | | |

^{a}Means (of 4 reps) followed by the same letter are not significantly different P = 0.05, LSD.
^{b}Rate unit is fl. oz./1000 ft² (ml/m²) unless otherwise stated
^{c}Turfgrass quality visual rating scale: 1 = worst, 9 = best, 7 = acceptable.
^{d}Treatments 3 and 4 are proprietary.

### Example 13

### Crown Rot Anthracnose Management on a Putting Green Using a Canola Oil Bio-Adjuvant with Reduced-Rate Fungicides, 2016

This study was established preventively on the same irrigated annual bluegrass (Poa annua) putting green (˜0.15 in (0.038 cm) height of cut) used in Example 10, at the same research center as in previous examples. The study was established in four replications of a randomized block design utilizing 2 ft.×7.5 ft. (0.6 m×2.3 m) plots with 6 in. (0.15 m) alleys. Treatments were applied on Jun. 22, 2016, before disease was present with the same sprayer and under the same conditions described in Example 1. Turfgrass quality ratings and disease ratings were taken as in Example 12.

Treatments were re-applied on a 14-day schedule on Jul. 7, 2016, Jul. 23, 2016, and Aug. 6, 2016. The study was inoculated with the anthracnose pathogen growing on a mixture of sand and corn meal on Jul. 8, 2016, Jul. 11, 2016, Jul. 18, 2016, and Jul. 25, 2016. Fertility (18-9-18) was applied to the study on Jul. 20, 2016 at 1/10 lb. (0.04 kg) N/1000 sq. ft. (93 m²) on Jul. 28, 2016 at ⅛ lb. (0.06 kg) N/1000 sq. ft. (93 m²) and on Aug. 13, 2016 at ⅛ lb. (0.06 kg) N/1000 sq. ft. (93 m²). Irrigation was applied as needed to prevent wilt during the study duration. The study was rated for percent disease and turfgrass quality on Jul. 13, 2016, Jul. 22, 2016, Aug. 5, 2016 and Aug. 20, 2016.

As the data in Table 18 indicates, anthracnose disease pressure and disease intensity remained moderate through July in this study, with disease ratings of approximately 33% in the untreated controls. Under these moderate and superficial disease conditions, many of the reduced rate fungicide+bio-adjuvant treatments managed the disease as well or better, statistically, than the full rate treatments of Mirage, Compass, and Trinity+Insignia alone (Treatments 2, 8, 14, and 15). The August ratings indicate a significant increase in disease pressure and disease intensity, resulting in significantly reduced disease control in the reduced-rate fungicide+bio-adjuvant treatments, versus the full rate fungicide treatments. The exception was the reduced rate Mirage+bio-adjuvant treatments, which performed as well, in many cases, as the full rate Mirage alone treatment, and statistically better than the reduced-rate Mirage alone treatment. (Table 18). In summary, these data suggest that, under moderate disease pressure, crown rot anthracnose can be managed even with greatly reduced fungicide rates, when applied in combination with certain bio-adjuvants.

As Table 19 indicates, when disease pressure was light in mid-July, the fungicide/bio-adjuvant combinations significantly improved the turfgrass quality, as compared to full-rate fungicide-only treatments. Later in the season, the fungicide/bio-adjuvant combinations did not appear to improve turfgrass quality, compared to the full-rate fungicide-only treatments. This is likely due to a lack of disease control in the fungicide/adjuvant combination treatments, compared to the full-rate fungicide treatments.

TABLE 18
Disease Ratings in the Crown Rot Anthracnose Fungicide Bio-Adjuvant Study, 2016

| | | | | Jul. 13, 2016 | | Jul. 22, 2016 | | | Aug. 5, 2016 | | | Aug. 20, 2016 | | |
|---|---|---|---|---|---|---|---|---|---|---|---|---|---|---|
| | | | | % CRA^{c} | | % CRA^{c} | | | % CRA^{c} | | | % CRA^{c} | | |
| Trt | | | | | 0.05 | | | 0.05 | | | 0.05 | | | 0.05 |
| No. | Treatment Name | Rate^{b} | | MEAN^{a} | LSD | MEAN^{a} | | LSD | MEAN^{a} | | LSD | MEAN^{a} | | LSD |
| 1 | Control | | | 33.8 | ab | 31.3 | (2.3) | a | 57.5 | (2.8) | ab | 65 | (3.3) | a |
| 2 | Mirage | 1 | (0.32) | 16 | e-h | 5.8 | (1) | h-k | 8.5 | (1.3) | h | 7.3 | (1) | j |
| 3 | Mirage+ | 0.5 | (0.16) | 2.3 | i | 1.5 | (1) | jk | 7.8 | (1) | h | 5 | (1) | j |
| | Canola Oil Bio- | 1.4 | (0.45)^{d} | | | | | | | | | | | |
| | Adjuvant “B” | | | | | | | | | | | | | |
| 4 | Mirage+ | 0.5 | (0.16) | 1.3 | i | 0 | | k | 8 | (1) | h | 8 | (1) | j |
| | Methylated Canola | 1.1 | (0.35) | | | | | | | | | | | |
| | oil Bio-Adjuvant | | | | | | | | | | | | | |
| | “B” | | | | | | | | | | | | | |
| 5 | Mirage+ | 0.5 | (0.16) | 12.3 | f-i | 3.3 | (1) | i-k | 12.5 | (1.3) | h | 15.5 | (1) | ij |
| | Canola Oil Bio- | 5 | (1.6) | | | | | | | | | | | |
| | Adjuvant “A” | | | | | | | | | | | | | |
| 6 | Mirage+ | 0.5 | (0.16) | 14.8 | e-h | 7 | (1.3) | g-k | 13.8 | (1.5) | h | 20.5 | (1.3) | hi |
| | Canola Oil Bio- | 1.4 | (0.45)^{d} | | | | | | | | | | | |
| | Adjuvant “A” | | | | | | | | | | | | | |
| 7 | Mirage | 0.5 | (0.16) | 22.5 | b-f | 12.8 | (1.5) | e-i | 28.8 | (1.3) | fg | 33.8 | (1) | fg |
| 8 | Compass | 0.2 oz | | 31.3 | a-c | 32.5 | (2) | a | 56.3 | (28) | ab | 58.8 | (3) | ab |
| | | (0.08) | | | | | | | | | | | | |
| 9 | Compass+ | 0.07 oz | | 11.5 | f-i | 18 | (1.8) | c-f | 50 | (2.3) | a-d | 53.8 | (3) | b-d |
| | | (0.23) | | | | | | | | | | | | |
| | Canola Oil Bio- | 1.4 | (0.45)^{d} | | | | | | | | | | | |
| | Adjuvant “B” | | | | | | | | | | | | | |
| 10 | Compass+ | 0.07 oz | | 9 | g-i | 18 | (1.5) | c-f | 52.5 | (2.3) | a-c | 56.3 | (2.5) | a-c |
| | | (0.23) | | | | | | | | | | | | |
| | Methylated Canola | 1.1 | (0.35) | | | | | | | | | | | |
| | Oil Bio-Adjuvant | | | | | | | | | | | | | |
| | “B” | | | | | | | | | | | | | |
| 11 | Compass+ | 0.07 oz | | 11 | f-i | 18 | (1.8) | c-f | 52.5 | (2.3) | a-c | 52.5 | (2.3) | b-d |
| | | (0.23) | | | | | | | | | | | | |
| | Canola Oil Bio- | 10 | (3.2) | | | | | | | | | | | |
| | Adjuvant “A” | | | | | | | | | | | | | |
| 12 | Compass+ | 0.07 oz | | 35 | a | 32.5 | (2) | a | 60 | (2.8) | a | 53.8 | (2.8) | b-d |
| | | (0.23) | | | | | | | | | | | | |
| | Canola Oil Bio- | 1.4 | (0.45)^{d} | | | | | | | | | | | |
| | Adjuvant “A” | | | | | | | | | | | | | |
| 13 | Compass | 0.07 oz | | 28.8 | a-d | 26.3 | (2) | a-d | 57.5 | (2.5) | ab | 60 | (3) | ab |
| | | (0.23) | | | | | | | | | | | | |
| 14 | Trinity+ | 1 | (0.32) | 25.5 | a-e | 10.5 | (1.7) | f-j | 28 | (2) | fg | 27.5 | (1.3) | gh |
| | Insignia SC | 0.4 | (0.13) | | | | | | | | | | | |
| 15 | Trinity+ | 0.5 | (0.16) | 21.8 | c-f | 17.5 | (1.8) | d-f | 50 | (2.3) | a-d | 51.3 | (2.8) | b-d |
| | Insignia SC | 0.4 | (0.13) | | | | | | | | | | | |
| 16 | Trinity+ | 0.5 | (0.16) | 12.5 | f-i | 16.8 | (1.3) | d-g | 41.3 | (2.3) | c-e | 45 | (1.5) | de |
| | Insignia SC+ | 0.2 | (0.08) | | | | | | | | | | | |
| | Canola Oil Bio- | 1.4 | (0.45)^{d} | | | | | | | | | | | |
| | Adjuvant “B” | | | | | | | | | | | | | |
| 17 | Trinity+ | 0.5 | (0.16) | 5.5 | hi | 9.5 | (1.3) | f-k | 38.8 | (2.3) | d-f | 45 | (2.3) | de |
| | Insignia SC | 0.2 | (0.08) | | | | | | | | | | | |
| | Methylated Canola | 1.1 | (0.35) | | | | | | | | | | | |
| | Oil Bio-Adjuvant | | | | | | | | | | | | | |
| | “B” | | | | | | | | | | | | | |
| 18 | Trinity+ | 0.5 | (0.16) | 12.3 | f-i | 13 | (1.8) | e-i | 32.5 | (2) | ef | 40 | (2) | ef |
| | Insignia SC | 0.2 | (0.08) | | | | | | | | | | | |
| | Canola Oil Bio- | 10 | (3.2) | | | | | | | | | | | |
| | Adjuvant “A” | | | | | | | | | | | | | |
| 19 | Trinity+ | 0.5 | (0.16) | 22.5 | b-f | 15.5 | (1.5) | e-h | 50 | (2) | a-d | 53.8 | (2.5) | b-d |
| | Insignia SC | 0.2 | (0.08) | | | | | | | | | | | |
| | Canola Oil Bio- | 1.4 | (0.45)^{d} | | | | | | | | | | | |
| | Adjuvant “A” | | | | | | | | | | | | | |
| 20 | C.O.+ | 9.3 | (3.0) | 31.3 | a-c | 27.5 | (1.5) | a-c | 57.5 | (2.8) | ab | 61.3 | (3) | ab |
| | Silwet L-77 | 0.29 | (0.09) | | | | | | | | | | | |
| 21 | Foursome | 0.46 | (0.15) | 12.3 | f-i | 20.5 | (1.8) | b-e | 47.5 | (2.5) | b-d | 56.3 | (2) | a-c |
| 22 | Canola Oil Bio- | 10 | (3.2) | 18 | d-g | 30 | (1.8) | ab | 50 | (2.5) | a-d | 52.5 | (2) | b-d |

Adjuvant “A”

^{a}Means (of 4 reps) followed by the same letter are not significantly different P = 0.05, LSD.
^{b}Rate: fl. oz./1000 ft² (ml/m²) unless stated as dry ounces (oz), every 14 days.
^{c}Rating Scale: Mean percent/treatment of crown rot anthracnose (Collecfrichum cereale) and mean disease intensity ( ) per treatment on a 1-5 scale, where “1” = superficial disease, and “5” = very severe disease with significant turf loss. No disease severity data was taken on Jul. 13, 2016.
^{d}Equals 1% v/v at spray volume of 48 GPA used in this study

TABLE 19
Turfgrass Quality Ratings in the Crown Rot Anthracnose Fungicide Bio-Adjuvant Study, 2016.

| | Jul. 13, 3016 Quality^{c} | | Jul. 22, 2016 Quality^{c} | | Aug. 5, 2016 Quality^{c} | | Aug. 20, 2016 Quality^{c} | | | |
|---|---|---|---|---|---|---|---|---|---|---|
| Trt. | Treatment | | | 0.05 | | 0.05 | | 0.05 | | 0.05 |
| No. | Name | Rate^{b} | MEAN^{a} | LSD | MEAN^{a} | LSD | MEAN^{a} | LSD | MEAN^{a} | LSD |
| 1 | Control | | 5 | fg | 5.25 | gh | 3.75 | gh | 2.75 | i |
| 2 | Mirage | 1 | 6 | c-e | 7 | bc | 7 | ab | 6.5 | ab |
| | | (0.32) | | | | | | | | |
| 3 | Mirage+ | 0.5 | 7.5 | a | 7.5 | ab | 7.5 | a | 7 | a |
| | Canola | (0.16) | | | | | | | | |
| | Oil | 1.4 | | | | | | | | |
| | Adjuvant | (0.45)^{d} | | | | | | | | |
| | “B” | | | | | | | | | |
| 4 | Mirage+ | 0.5 | 7.75 | a | 8 | a | 7.5 | a | 6.25 | a-c |
| | | (0.16) | | | | | | | | |
| | Methylated | 1.1 | | | | | | | | |
| | Canola | (0.35) | | | | | | | | |
| | Oil Bio- | | | | | | | | | |
| | Adjuvant | | | | | | | | | |
| 5 | Mirage+ | 0.5 | 6.25 | cd | 7.25 | b | 6.75 | ab | 6 | b-d |
| | | (0.16) | | | | | | | | |
| | Canola | 5 | | | | | | | | |
| | Oil Bio-Adjuvant | (1.6) | | | | | | | | |
| | A | | | | | | | | | |
| 6 | Mirage+ | 0.5 | 5.75 | c-f | 7 | bc | 6.25 | bc | 6 | b-d |
| | | (0.16) | | | | | | | | |
| | Canola | 1.4 | | | | | | | | |
| | Oil Bio- | (0.45)^{d} | | | | | | | | |
| | Adjuvant | | | | | | | | | |
| | “A” | | | | | | | | | |
| 7 | Mirage | 0.5 | 5.25 | e-g | 6.25 | de | 6 | b-d | 5.25 | de |
| | | (0.16) | | | | | | | | |
| 8 | Compass | 0.2 oz | 5 | fg | 5.25 | gh | 3.5 | h | 3 | hi |
| | | (0.08) | | | | | | | | |
| 9 | Compass+ | 0.07 oz | 6.25 | cd | 5.5 | f-h | 4.5 | e-h | 4 | fg |
| | | (0.23) | | | | | | | | |
| | Canola | 1.4 | | | | | | | | |
| | Oil Bio- | (0.45)^{d} | | | | | | | | |
| | Adjuvant | | | | | | | | | |
| | “B” | | | | | | | | | |
| 10 | Compass+ | 0.07 oz | 6.25 | cd | 5.75 | e-g | 4.5 | e-h | 3.5 | g-i |
| | | (0.23) | | | | | | | | |
| | Methylated | 1.1 | | | | | | | | |
| | Canola | (0.35) | | | | | | | | |
| | Oil Bio- | | | | | | | | | |
| | Adjuvant | | | | | | | | | |
| | “B” | | | | | | | | | |
| 11 | Compass+ | 0.07 oz. | 6.5 | bc | 5.75 | e-g | 4.5 | e-h | 4 | fg |
| | | (0.23) | | | | | | | | |
| | Canola | 10 | | | | | | | | |
| | Oil Bio- | (3.2) | | | | | | | | |
| | Adjuvant | | | | | | | | | |
| | “A” | | | | | | | | | |
| 12 | Compass+ | 0.07 oz. | 4.75 | g | 5 | h | 3.5 | h | 2.75 | i |
| | | (0.23) | | | | | | | | |
| | Canola | 1.4 | | | | | | | | |
| | Oil Bio- | (0.45)^{d} | | | | | | | | |
| | Adjuvant | | | | | | | | | |
| | “A” | | | | | | | | | |
| 13 | Compass | 0.07 oz. | 5 | fg | 5.25 | gh | 3.75 | gh | 3 | hi |
| | | (0.23) | | | | | | | | |
| 14 | Trinity+ | 1 | 5.25 | e-g | 6 | d-f | 5.25 | c-e | 5.5 | cd |
| | | (0.32) | | | | | | | | |
| | Insignia | 0.4 | | | | | | | | |
| | SC | (0.13) | | | | | | | | |
| 15 | Trinity+ | 0.5 | 5.5 | d-g | 5.75 | e-g | 4.25 | e-h | 3.5 | g-i |
| | | (0.16) | | | | | | | | |
| | Insignia | 0.2 | | | | | | | | |
| | SC | (0.08) | | | | | | | | |
| 16 | Trinity+ | 0.5 | 6.25 | cd | 6 | d-f | 5 | d-f | 4.5 | ef |
| | | (0.16) | | | | | | | | |
| | Insignia | 0.2 | | | | | | | | |
| | SC+ | (0.08) | | | | | | | | |
| | Canola | 1.4 | | | | | | | | |
| | Oil Bio- | (0.45)^{d} | | | | | | | | |
| | Adjuvant | | | | | | | | | |
| | “B” | | | | | | | | | |
| 17 | Trinity+ | 0.5 | 7.25 | ab | 6.5 | cd | 4.75 | e-g | 4.25 | fg |
| | | (0.16) | | | | | | | | |
| | Insignia | 0.2 | | | | | | | | |
| | SC+ | (0.08) | | | | | | | | |
| | Methylated | 1.1 | | | | | | | | |
| | Canola | (0.35) | | | | | | | | |
| | Oil Bio- | | | | | | | | | |
| | Adjuvant | | | | | | | | | |
| | “B” | | | | | | | | | |
| 18 | Trinity+ | 0.5 | 6.25 | cd | 6.25 | de | 5 | d-f | 4.5 | ef |
| | | (0.16) | | | | | | | | |
| | Insignia | 0.2 | | | | | | | | |
| | SC+ | (0.08) | | | | | | | | |
| | Canola | 10 | | | | | | | | |
| | Oil Bio- | (3.2) | | | | | | | | |
| | Adjuvant | | | | | | | | | |
| | “A” | | | | | | | | | |
| 19 | Trinity+ | 0.5 | 6 | c-e | 6 | d-f | 4.25 | e-h | 3.75 | f-h |
| | | (0.16) | | | | | | | | |
| | Insignia | 0.2 | | | | | | | | |
| | SC+ | (0.08) | | | | | | | | |
| | Canola | 1.4 | | | | | | | | |
| | Oil Bio- | (0.45)^{d} | | | | | | | | |
| | Adjuvant | | | | | | | | | |
| | “A” | | | | | | | | | |
| 20 | Canola | 9.3 | 4.75 | g | 5 | h | 4 | f-h | 2.75 | i |
| | Oil+ | (3.0) | | | | | | | | |
| | Silwet L-77 | 0.29 | | | | | | | | |
| | | (0.09) | | | | | | | | |
| 21 | Foursome | 0.46 | 6.25 | cd | 5.75 | e-g | 4.25 | e-h | 4.25 | fg |
| | | (0.15) | | | | | | | | |
| 22 | Canola | 10 | 6 | c-e | 5.25 | gh | 4.5 | e-h | 3.75 | f-h |
| | Oil Bio- | (3.2) | | | | | | | | |
| | Adjuvant | | | | | | | | | |
| | “A” | | | | | | | | | |

^{a}Means (of 4 reps) followed by the same letter are not significantly different P = 0.05, LSD.
^{b}Rate: fl. oz./1000 ft² (ml/m²) unless stated as dry ounces (oz), every 14 days.
^{c}Turfgrass quality rating scale: 1-9 (1 = worst, 9 = best, 7 = acceptable turfgrass quality).
^{d}Equals 1% v/v at spray volume of 48 GPA used in this study.

### Example 14

### Dollar Spot Disease Management on Fairway Turf Using a Canola Oil Bio-Adjuvant with Reduced-Rate Fungicides, 2016

This study was established on an irrigated bentgrass (Agrostis palustris)/annual bluegrass (Poa annua) fairway turf (mowed at ½″ height of cut) with a history of severe dollar spot (Rutstroemia floccosum, Sclerotinia homoeocarpa) outbreaks, on the same research center as in the previous examples. The study was established in four replications of a randomized block design utilizing 2 ft.×10.5 ft. plots. Treatments were initially applied on Aug. 22, 2016, before disease was present, with the same sprayer and under the same conditions described in Example 1. Turfgrass quality ratings and disease ratings were taken as in Example 12.

Treatments were re-applied on a 14-day schedule on Sep. 6, 2016, Sep. 21, 2016, and Oct. 6, 2016. Since the initially selected fungicide rates were too low to control the disease, the 26 GT, Interface, and Banner Maxx rates of application were increased by 50 percent, to 1.5 fl oz (26GT), 0.75 fl oz (Interface), and 0.375 fl oz/1000 sq. ft. (Banner Maxx) on Sep. 6, 2016. The Emerald rate was boosted by 100%, from 0.033 oz/1000 sq. ft. to 0.065 oz/1000 sq. ft. The Interface rate of application was again boosted on Sep. 21, 2016 from 0.75 fl oz/1000 sq. ft. to 1 fl oz/1000 sq. ft., because this treatment was still displaying unacceptable dollar spot infection. The Sep. 21, 2016 fungicide rate boosts put the final fungicide application rates at 37.5% of the maximum 14-day interval dollar spot rate for 26GT, 33.3% of the maximum 14-day interval label rate for Interface, 18.8% of the maximum 14-day interval label rate for Banner Maxx, and 36% of the maximum 14-day interval label rate for Emerald.

The study was fertilized on August 24, September 4, and Oct. 5, 2016 at ⅛ lb. N/1000 sq. ft. with 18-9-18 granular fertilizer. Irrigation was applied nightly at 1/10″ (unless significant rain occurred). No other fungicides were applied to the study area.

As the data in Table 20 indicates, the initially selected reduced-rate fungicide levels would not hold under heavier disease pressure. Significant dollar spot disease had broken through in virtually all treatments, except the full label rate treatments. The exception was the Emerald treatments where most of the reduced-rate Emerald/bio-adjuvant combinations (treatments 19-22) provided dollar spot management comparable to the full label rate application. By Sep. 20, 2016, the 26GT and Emerald bio-adjuvant combinations were providing disease control similar to the full rate applications, but the Interface and Banner Maxx bio-adjuvant treatments were failing to provide disease control comparable to the full label rate applications. By Oct. 4, 2016, some of the Interface/bio-adjuvant combination treatments (treatments 7-10) and some of the Emerald/bio-adjuvant treatments were performing as well as the full rate Interface treatment. One of the 26GT/bio-adjuvant treatments was still providing adequate disease control, but none of the Banner Maxx/bio-adjuvant treatments (treatments 13-16) were performing as well as the full rate Banner Maxx treatment on Oct. 4, 2016. It appears that fungicide rates of at least 40% of the maximum 14-day interval label rates may be necessary when 26GT, Interface, and Emerald fungicide/bio-adjuvant combinations are relied upon for the control of dollar spot under heavy disease conditions. When Banner Maxx is applied in combination with the bio-adjuvant, Banner Max rates of 18.8% of the maximum 14-day interval application rates were not adequate, suggesting that rates of 25%-30% of the maximum label rate may be needed. Disease intensity ratings (Table 20) in the fungicide/bio-adjuvant treatments generally reflect the degree of dollar spot disease control in these treatments versus the untreated control or the bio-adjuvant-free, reduced rate fungicide treatments. Disease intensity was moderate throughout the study duration this season.

As the data in Table 21 indicates, turfgrass quality was directly related to the level of dollar spot control provided by the various treatments. Because early season fungicide/bio-adjuvant combination rates selected were too low to control dollar spot, quality levels were also low in these treatments, compared to the full rate fungicide treatments. As the fungicide/bio-adjuvant combination rates were adjusted upward and dollar spot came under control later in the season, the turfgrass quality in the fungicide/adjuvant treatments more closely mimicked the turfgrass quality in the full rate fungicide treatments. No phytotoxicity was observed in this study.

As the data in Table 22 indicates, the canola oil-based bio-adjuvants alone (treatments 25-28) significantly stimulated over-night fungal growth (fuzzing) when applied without a fungicide, compared to all other treatments. When applied with a fungicide, however, the bio-adjuvants significantly reduced dollar spot fuzzing, compared to the untreated control.

TABLE 20
Dollar Spot Ratings in Fungicide/Bio-Adjuvant Fairway Dollar Spot Study, 2016

| | | | | Sep. 4, 2016 | | Sep. 12, 2016 | | | Sep. 20, 2016 | | | Oct. 4, 2016 | | | Oct. 18, 2016 | | |
|---|---|---|---|---|---|---|---|---|---|---|---|---|---|---|---|---|---|
| | | | | % Dollar Spot^{c} | | % Dollar Spot^{c} | | | % Dollar Spot^{c} | | | % Dollar Spot^{c} | | | % Dollar Spot^{c} | | |
| Trt | Treatment | | | | LSD | | | LSD | | | LSD | | | LSD | | | LSD |
| No | Name | Rate^{b} | | Mean^{a} | 5% | Mean^{a} | | 5% | Mean^{a} | | 5% | Mean^{a} | | 5% | Mean^{a} | | 5% |
| 1 | 26 GT+ | 1.5 | (0.48) | 3.9 | h-k | 17.6 | (1.5) | d-g | 27.5 | (1.7) | f-j | 16.3 | (1.0) | c-f | 3.8 | (1.0) | ij |
| | Canola Oil | 5 | (1.6) | | | | | | | | | | | | | | |
| | Bio-Adjuvant | | | | | | | | | | | | | | | | |
| | “A” | | | | | | | | | | | | | | | | |
| 2 | 26 GT+ | 1.5 | (0.48) | 10.8 | c-k | 21.5 | (2.0) | d-f | 31.4 | (1.5) | ej | 18 | (1.0) | c-e | 10.5 | (1.0) | hi |
| | Canola Oil | 1.4 | (0.45)^{d} | | | | | | | | | | | | | | |
| | Bio-Adjuvant | | | | | | | | | | | | | | | | |
| | “A” | | | | | | | | | | | | | | | | |
| 3 | 26 GT+ | 1.5 | (0.48) | 11.8 | c-i | 20.1 | (2.0) | d-g | 26.3 | (1.3) | g-j | 6.3 | (1.0) | fg | 2.3 | (1.0) | ij |
| | Canola Oil | 1.4 | (0.45)^{e} | | | | | | | | | | | | | | |
| | Bio-Adjuvant | | | | | | | | | | | | | | | | |
| | “B” | | | | | | | | | | | | | | | | |
| 4 | 26 GT+ | 1.5 | (0.48) | 11.3 | c-j | 17.3 | (1.8) | d-g | 25.5 | (1.3) | g-k | 20.5 | (1.3) | cd | 3 | (1.0) | ij |
| | Methylated | 1.1 | (0.35) | | | | | | | | | | | | | | |
| | Canola oil | | | | | | | | | | | | | | | | |
| | Bio-Adjuvant | | | | | | | | | | | | | | | | |
| | “B” | | | | | | | | | | | | | | | | |
| 5 | 26 GT | 1.5 | (0.48) | 20.13 | a-d | 22.8 | (2.5) | de | 30 | (1.5) | e-j | 26.3 | (1.3) | bc | 17 | (1.0) | gh |
| 6 | 26 GT | 4 | (1.28) | 0.4 | k | 6.5 | (1.5) | hi | 18.9 | (1.0) | j-m | 4.6 | (1.0) | g | 0.9 | (1.0) | j |
| 7 | Interface+ | 1 | (0.32) | 7 | f-k | 14.3 | (2.3) | e-h | 25.5 | (1.3) | g-k | 10 | (1.0) | d-g | 1 | (1.0) | j |
| | Canola Oil | 5 | (1.6) | | | | | | | | | | | | | | |
| | Bio-Adjuvant | | | | | | | | | | | | | | | | |
| | “A” | | | | | | | | | | | | | | | | |
| 8 | Interface+ | 1 | (0.32) | 11.8 | c-i | 23 | (2.5) | de | 36.3 | (2.0) | d-h | 17.5 | (1.0) | c-e | 1.1 | (1.0) | j |
| | Canola Oil | 1.4 | (0.45)^{d} | | | | | | | | | | | | | | |
| | Bio-Adjuvant | | | | | | | | | | | | | | | | |
| | “A” | | | | | | | | | | | | | | | | |
| 9 | Interface+ | 1 | (0.32) | 14.4 | b-h | 16.3 | (1.8) | e-g | 23.8 | (1.5) | h-l | 1.9 | (1.0) | g | 0.3 | (1.0) | j |
| | Canola Oil | 1.4 | (0.45)^{e} | | | | | | | | | | | | | | |
| | Bio-Adjuvant | | | | | | | | | | | | | | | | |
| | “B” | | | | | | | | | | | | | | | | |
| 10 | Interface+ | 1 | (0.32) | 11.5 | c-i | 20.5 | (2.5) | d-g | 37.5 | (1.8) | c-g | 8.8 | (1.0) | e-g | 1.4 | (1.0) | j |
| | Methylated | 1.1 | (0.35) | | | | | | | | | | | | | | |
| | Canola oil | | | | | | | | | | | | | | | | |
| | Bio-Adjuvant | | | | | | | | | | | | | | | | |
| | “B” | | | | | | | | | | | | | | | | |
| 11 | Interface | 1 | (0.32) | 18.8 | a-e | 32.5 | (2.8) | bc | 42.5 | (2.3) | a-e | 26.8 | (1.3) | bc | 11 | (1.0) | hi |
| 12 | Interface | 3 | (0.96) | 0.5 | k | 0.6 | (1.0) | i | 0.2 | (1.0) | n | 0 | | g | 0.9 | (1.0) | j |
| 13 | Banner Maxx+ | 0.38 | (0.12) | 4.5 | g-k | 18.8 | (2.5) | d-g | 26.3 | (2.0) | g-j | 25 | (2.0) | bc | 31.3 | (1.3) | de |
| | Canola Oil | 5 | (1.6) | | | | | | | | | | | | | | |
| | Bio-Adjuvant | | | | | | | | | | | | | | | | |
| | “A” | | | | | | | | | | | | | | | | |
| 14 | Banner Maxx+ | 0.38 | (0.12) | 9 | e-k | 19.3 | (2.3) | d-g | 30 | (2.0) | e-j | 32.5 | (2.0) | b | 43.8 | (1.8) | bc |
| | Canola Oil | 1.4 | (0.45)^{d} | | | | | | | | | | | | | | |
| | Bio-Adjuvant | | | | | | | | | | | | | | | | |
| | “A” | | | | | | | | | | | | | | | | |
| 15 | Banner Maxx+ | 0.38 | (0.12) | 10 | d-k | 15 | (3.0) | e-h | 25.5 | (2.0) | g-k | 24.3 | (1.8) | bc | 28 | (1.0) | ef |
| | Canola Oil | 1.4 | (0.45)^{d} | | | | | | | | | | | | | | |
| | Bio-Adjuvant | | | | | | | | | | | | | | | | |
| | “B” | | | | | | | | | | | | | | | | |
| 16 | Banner Maxx+ | 0.38 | (0.12) | 3.5 | i-k | 13 | (2.3) | f-h | 23 | (1.8) | i-l | 20 | (1.3) | cd | 21.3 | (1.0) | fg |
| | Methylated | 1.1 | (0.35) | | | | | | | | | | | | | | |
| | Canola oil | | | | | | | | | | | | | | | | |
| | Bio-Adjuvant | | | | | | | | | | | | | | | | |
| | “B” | | | | | | | | | | | | | | | | |
| 17 | Banner Maxx | 0.38 | | 15 | b-g | 17.5 | (2.3) | d-g | 26.3 | (2.0) | g-j | 35 | (1.8) | b | 37.5 | (1.5) | cd |
| 18 | Banner Maxx | 1 | (0.32) | 0.7 | jk | 1.8 | (1.0) | i | 4.6 | (1.3) | n | 1.5 | (1.0) | g | 1.6 | (1.0) | j |
| 19 | Emerald+ | 0.07 oz | | 11.8 | c-i | 11.8 | (1.8) | gh | 6.1 | (1.0) | mn | 0.8 | (1.0) | g | 0.1 | (1.0) | j |
| | Canola Oil | 5 | (1.6) | | | | | | | | | | | | | | |
| | Bio-Adjuvant | | | | | | | | | | | | | | | | |
| | “A” | | | | | | | | | | | | | | | | |
| 20 | Emerald+ | 0.07 oz | | 15 | a-f | 20.5 | (2.8) | d-g | 23 | (1.3) | i-l | 25 | (1.3) | bc | 10.5 | (1.0) | hi |
| | | (0.02) | | | | | | | | | | | | | | | |
| | Canola Oil | 1.4 | (0.45)^{d} | | | | | | | | | | | | | | |
| | Bio-Adjuvant | | | | | | | | | | | | | | | | |
| | “B” | | | | | | | | | | | | | | | | |
| 21 | Emerald+ | 0.07 oz | | 9.5 | e-k | 13 | (1.8) | f-h | 6 | (1.0) | mn | 2.7 | (1.0) | g | 0.9 | (1.0) | j |
| | | (0.02) | | | | | | | | | | | | | | | |
| | Canola Oil | 1.4 | (0.45)^{e} | | | | | | | | | | | | | | |
| | Bio-Adjuvant | | | | | | | | | | | | | | | | |
| | “B” | | | | | | | | | | | | | | | | |
| 22 | Emerald+ | 0.07 oz | | 11.3 | c-j | 12.5 | (1.8) | f-h | 11.3 | (1.0) | l-n | 6.3 | (1.0) | fg | 0.1 | (1.0) | j |
| | | (0.02) | | | | | | | | | | | | | | | |
| | Methylated | 1.1 | (0.35) | | | | | | | | | | | | | | |
| | Canola oil | | | | | | | | | | | | | | | | |
| | Bio-Adjuvant | | | | | | | | | | | | | | | | |
| | “B” | | | | | | | | | | | | | | | | |
| 23 | Emerald | 0.07 oz | | 21.3 | a-c | 26.3 | (2.5) | cd | 32.5 | (1.5) | e-i | 35 | (1.8) | b | 15.5 | (1.0) | gh |
| 24 | Emerald | 0.13 oz | | 6.5 | g-k | 12 | (1.5) | gh | 13.1 | (1.0) | k-n | 3 | (1.0) | g | 2.3 | (1.0) | ij |
| 25 | Canola Oil | 1.4 | (0.32) | 21 | a-c | 35 | (3.3) | a-c | 48.8 | (2.8) | a-d | 50 | (3.5) | a | 52.5 | (3.8) | ab |
| | Bio-Adjuvant | | | | | | | | | | | | | | | | |
| | “B” | | | | | | | | | | | | | | | | |
| 26 | Canola Oil | 5 | (1.6) | 21.3 | a-c | 38.8 | (3.3) | ab | 48.8 | (3) | a-d | 52.5 | (3.5) | a | 50 | (3.8) | ab |
| | Bio-Adjuvant | | | | | | | | | | | | | | | | |
| | “A” | | | | | | | | | | | | | | | | |
| 27 | Canola Oil | 1.4 | (0.32) | 26.3 | a | 38.8 | (3.5) | ab | 46.3 | (2.5) | a-d | 52.5 | (3.3) | a | 51.3 | (3.3) | ab |
| | Bio-Adjuvant | | | | | | | | | | | | | | | | |
| | “B” | | | | | | | | | | | | | | | | |
| 28 | Methylated | 1.1 | (0.35) | 24.3 | ab | 38.8 | (3.8) | ab | 52.5 | (2.8) | ab | 58.8 | (3.8) | a | 51.3 | (3.3) | ab |
| | Canola oil | | | | | | | | | | | | | | | | |
| | Bio-Adjuvant | | | | | | | | | | | | | | | | |
| | “B” | | | | | | | | | | | | | | | | |
| 29 | Control | | | 26 | a | 40 | (3.5) | ab | 50 | (2.8) | a-c | 52.5 | (3.5) | a | 56.3 | (3.8) | a |
| 30 | Interface+ | 1 | (0.32) | 18.8 | a-e | 33.8 | (2.8) | bc | 40 | (2.0) | b-f | 20.5 | (1.8) | cd | 15 | (1.0) | gh |
| | Canola Oil | 0.7 | (0.22) | | | | | | | | | | | | | | |
| | Bio-Adjuvant | | | | | | | | | | | | | | | | |
| | B | | | | | | | | | | | | | | | | |
| 31 | Canola Oil | 0.7 | (0.22) | 22.5 | ab | 43.8 | (3.3) | a | 55 | (3.0) | a | 50 | (3.5) | a | 50 | (2.8) | ab |

Bio-Adjuvant
“B”

^{a}Mean (of 4 replicate plots) followed by the same letter are not significantly different from each other (P = 0.05, LSD).
^{b}Rate: s fl. oz./1000 sq. ft. (ml/m²), unless stated in dry ounces (oz), every 14 days.
^{c}Turfgrass quality rating scale: Mean percent/treatment of dollar spot (Sclerotinia homoeocarpa) and mean disease intensity ( ) per treatment on a 1-5 scale, where “1” = superficial disease, and “5” = very severe disease with significant turf loss. No disease severity data taken on Sep. 4, 2016.
^{d}Equals 1% v/v at spray volume of 48 GPA used in this study.

TABLE 21
Turfgrass Quality Ratings in Fungicide/Bio-Adjuvant Fairway Dollar Spot Study, 2016

| | | | Sep. 4, 2016 | | Sep. 12, 2016 | | Sep. 20, 2016 | | Oct. 4, 2016 | | Oct. 18, 2016 | |
|---|---|---|---|---|---|---|---|---|---|---|---|---|
| | | | Quality^{c} | | Quality^{c} | | Quality^{c} | | Quality^{c} | | Quality^{c} | |
| Trt. | Treatment | | | LSD | | LSD | | LSD | | LSD | | LSD |
| No. | Name | Rate^{b} | Mean | (0.05)^{a} | Mean | (0.05)^{a} | Mean | (0.05)^{a} | Mean | (0.05)^{a} | Mean | (0.05)^{a} |
| 1 | 26 GT+ | 1.5 | 6 | b | 6 | cd | 6 | c-f | 6.75 | b-e | 7.5 | a-c |
| | | (0.48) | | | | | | | | | | |
| | Canola Oil Bio- | 5 | | | | | | | | | | |
| | Adjuvant “A” | (1.6) | | | | | | | | | | |
| 2 | 26 GT+ | 1.5 | 5.75 | bc | 5.5 | c-f | 6.25 | b-e | 6.25 | d-g | 6.75 | d-f |
| | | (0.48) | | | | | | | | | | |
| | Canola Oil Bio- | 1.4 | | | | | | | | | | |
| | Adjuvant “A” | (0.45)^{d} | | | | | | | | | | |
| 3 | 26 GT+ | 1.5 | 5.75 | bc | 6 | cd | 5.75 | d-g | 7 | a-d | 8 | a |
| | | (0.48) | | | | | | | | | | |
| | Canola Oil Bio- | 1.4 | | | | | | | | | | |
| | Adjuvant “B” | (0.45)^{d} | | | | | | | | | | |
| 4 | 26 GT+ | 1.5 | 5.75 | bc | 6 | cd | 5.5 | e-h | 6.25 | d-g | 8 | a |
| | | (0.48) | | | | | | | | | | |
| | Methylated | 1.1 | | | | | | | | | | |
| | Canola oil Bio- | (0.35) | | | | | | | | | | |
| | Adjuvant “B” | | | | | | | | | | | |
| 5 | 26 GT | 1.5 | 5 | c-f | 5 | e-g | 5.5 | e-h | 6 | e-h | 6.75 | d-f |
| | | (0.48) | | | | | | | | | | |
| 6 | 26 GT | 4 | 7 | a | 6.25 | bc | 6.25 | b-e | 7.25 | a-c | 7.5 | a-c |
| | | (1.28) | | | | | | | | | | |
| 7 | Interface+ | 1 | 5.75 | bc | 5.75 | c-e | 5.75 | d-g | 7 | a-d | 7.25 | b-d |
| | | (0.32) | | | | | | | | | | |
| | Canola Oil Bio- | 5 | | | | | | | | | | |
| | Adjuvant “A” | (1.6) | | | | | | | | | | |
| 8 | Interface+ | 1 | 5 | c-f | 5 | e-g | 4.75 | hi | 6.5 | c-f | 7.75 | ab |
| | | (0.32) | | | | | | | | | | |
| | Canola Oil Bio- | 1.4 | | | | | | | | | | |
| | Adjuvant “A” | (0.45)^{d} | | | | | | | | | | |
| 9 | Interface+ | 1 | 5.5 | b-d | 5.75 | c-e | 5.5 | e-h | 7.25 | a-c | 8 | a |
| | | (0.32) | | | | | | | | | | |
| | Canola Oil Bio- | 1.4 | | | | | | | | | | |
| | Adjuvant “B” | (0.45)^{d} | | | | | | | | | | |
| 10 | Interface+ | 1 | 5 | c-f | 5.25 | d-g | 5 | g-i | 6.5 | c-f | 7.75 | ab |
| | | (0.32) | | | | | | | | | | |
| | Methylated | 1.1 | | | | | | | | | | |
| | Canola Oil Bio- | (0.35) | | | | | | | | | | |
| | Adjuvant “B” | | | | | | | | | | | |
| 11 | Interface | 1 | 4.5 | ef | 4.5 | gh | 4.25 | ij | 6.25 | d-g | 6.5 | e-g |
| | | (0.32) | | | | | | | | | | |
| 12 | Interface | 3 | 7 | a | 8 | a | 7.25 | a | 7.75 | a | 8 | a |
| | | (0.96) | | | | | | | | | | |
| 13 | Banner Maxx+ | 0.38 | 5.5 | b-d | 5 | e-g | 5 | g-i | 5 | i | 5.75 | h |
| | | (0.12) | | | | | | | | | | |
| | Canola Oil Bio- | 5 | | | | | | | | | | |
| | Adjuvant “A” | (1.6) | | | | | | | | | | |
| 14 | Banner Maxx+ | 0.38 | 5.5 | b-d | 5 | e-g | 5 | g-i | 5 | i | 5 | i |
| | | (0.12) | | | | | | | | | | |
| | Canola Oil Bio- | 1.4 | | | | | | | | | | |
| | Adjuvant A | (0.45)^{d} | | | | | | | | | | |
| 15 | Banner Maxx+ | 0.38 | 5.5 | b-d | 5.5 | c-f | 5 | g-i | 5.5 | g-i | 6 | gh |
| | | (0.12) | | | | | | | | | | |
| | Canola Oil Bio- | 1.4 | | | | | | | | | | |
| | Adjuvant “B” | (0.45)^{d} | | | | | | | | | | |
| 16 | Banner Maxx+ | 0.38 | 6 | b | 5.75 | c-e | 5.75 | d-g | 5.75 | f-i | 6 | gh |
| | | (0.12) | | | | | | | | | | |
| | Methylated | 1.1 | | | | | | | | | | |
| | Canola Oil Bio- | (0.35) | | | | | | | | | | |
| | Adjuvant “B” | | | | | | | | | | | |
| 17 | Banner Maxx | 0.38 | 5.25 | b-e | 5 | e-g | 5.25 | f-h | 5 | i | 5 | i |
| | | (0.12) | | | | | | | | | | |
| 18 | Banner Maxx | 1 | 7 | a | 7 | b | 6.75 | a-c | 7.5 | ab | 7 | c-e |
| | | (0.32) | | | | | | | | | | |
| 19 | Emerald+ | 0.07 | 5.5 | b-d | 6.25 | bc | 6.75 | a-c | 7.25 | a-c | 7.75 | ab |
| | | (0.02) | | | | | | | | | | |
| | Canola Oil Bio- | 5 | | | | | | | | | | |
| | Adjuvant “A” | (1.6) | | | | | | | | | | |
| 20 | Emerald+ | 0.07 | 4.75 | d-f | 5.25 | d-g | 5.75 | d-g | 5.75 | f-i | 7.25 | b-d |
| | | (0.02) | | | | | | | | | | |
| | Canola Oil Bio- | 1.4 | | | | | | | | | | |
| | Adjuvant “A” | (0.45)^{d} | | | | | | | | | | |
| 21 | Emerald+ | 0.07 | 5.5 | b-d | 6 | cd | 6.5 | a-d | 7 | a-d | 7.25 | b-d |
| | | (0.02) | | | | | | | | | | |
| | Canola Oil Bio- | 1.4 | | | | | | | | | | |
| | Adjuvant “B” | (0.45)^{d} | | | | | | | | | | |
| 22 | Emerald+ | 0.07 | 5.75 | bc | 6.25 | bc | 6.5 | a-d | 6.75 | b-e | 7.75 | ab |
| | | (0.02) | | | | | | | | | | |
| | Methylated | 1.1 | | | | | | | | | | |
| | Canola Oil Bio- | (0.35) | | | | | | | | | | |
| | Adjuvant “B” | | | | | | | | | | | |
| 23 | Emerald | 0.07 | 4.75 | d-f | 4.5 | gh | 5.25 | f-h | 5.25 | hi | 6.25 | f-h |
| | | (0.02) | | | | | | | | | | |
| 24 | Emerald | 0.13 | 6 | b | 6.25 | bc | 7 | ab | 7 | a-d | 7 | c-e |
| | | (0.04) | | | | | | | | | | |
| 25 | Canola Oil Bio- | 1 | 4.75 | d-f | 3.25 | i | 3.25 | k | 3 | j | 2.25 | k |
| | Adjuvant “A” | (0.32) | | | | | | | | | | |
| 26 | Canola Oil Bio- | 5 | 4.25 | f | 3.75 | hi | 3.5 | jk | 2.5 | j | 3.25 | j |
| | Adjuvant “A” | (1.6) | | | | | | | | | | |
| 27 | Canola Oil Bio- | 1 | 4.25 | f | 3.5 | i | 3.5 | jk | 2.5 | j | 3 | j |
| | Adjuvant “B” | (0.32) | | | | | | | | | | |
| 28 | Methylated | 1.1 | 4.75 | d-f | 3.25 | i | 3.5 | jk | 2.5 | j | 2.75 | jk |
| | Canola Oil Bio- | (0.35) | | | | | | | | | | |
| | Adjuvant “B” | | | | | | | | | | | |
| 29 | Untreated | | 4.5 | ef | 3.5 | i | 3.25 | k | 2.5 | 1 | 2.75 | jk |
| | Control | | | | | | | | | | | |
| 30 | Interface+ | 1 | 5 | c-f | 4.75 | fg | 4.25 | ij | 5.75 | f-i | 7 | c-e |
| | | (0.32) | | | | | | | | | | |
| | Canola Oil Bio- | 0.7 | | | | | | | | | | |
| | Adjuvant “B” | (0.22) | | | | | | | | | | |
| 31 | Canola Oil Bio- | 0.7 | 4.5 | ef | 3.25 | i | 3.25 | k | 2.75 | 1 | 3.25 | l |
| | Adjuvant “B” | (0.22) | | | | | | | | | | |

^{a}Means (of 4 replicate plots) followed by the same letter are not significantly different from each other (P = 0.05 LSD).
^{b}Rate: fl. oz./1000 sq. ft. (ml/m²), unless stated in dry ounces (oz), every 14 days.
^{c}Turfgrass quality rating scale: 1 (worst)-9 (best), 7 = acceptable.
^{e}Equals 1% v/v at spray volume of 48 GPA used in this study.

TABLE 22
Dew Ratings and Dollar Spot Fuzz Ratings in Fungicide/Bio-Adjuvant Fairway
Dollar Spot Study, 2016

| | | | | | | | | Sep. 22, 2016 | |
|---|---|---|---|---|---|---|---|---|---|
| | | | | Aug. 23, 2016 | | Sep. 22, 2016 | | Mean | |
| Trt. | | | | Mean | LSD | Mean | LSD | (Overnight | |
| No. | Treatment Name | Rate^{b} | | (Des)^{c} | 5% | (Dew)^{c} | 5% | Fungal Fuzzing)^{c} | [symbol] |
| 1 | 26 GT+ | 1.5 | (0.48) | 3.25 | f | 2.5 | f | 2.25 | |
| | Canola Oil Bio- | 5 | (1.6) | | | | | | |
| | Adjuvant “A” | | | | | | | | |
| 2 | 26 GT+ | 1.5 | (0.48) | 5 | a | 3.5 | c-e | 2.5 | |
| | Canola Oil Bio- | 1.4 | (0.45)^{d} | | | | | | |
| | Adjuvant “A” | | | | | | | | |
| 3 | 26 GT+ | 1.5 | (0.48) | 4 | c-e | 2.75 | ef | 2.25 | |
| | Canola Oil Bio- | 1.4 | (0.45)^{d} | | | | | | |
| | Adjuvant “B” | | | | | | | | |
| 4 | 26 GT+ | 1.5 | (0.48) | 4.25 | b-d | 3.5 | c-e | 2.5 | |
| | Methylated | 1.1 | (0.35) | | | | | | |
| | Canola Oil Bio- | | | | | | | | |
| | Adjuvant “B” | | | | | | | | |
| 5 | 26 GT | 1.5 | (0.48) | 5 | a | 4.25 | a-c | 2 | |
| 6 | 26 GT | 4 | (1.28) | 5 | a | 3.75 | b-d | 1 | |
| 7 | Interface+ | 1 | (0.32) | 3.25 | f | 2.5 | f | 1.75 | |
| | Canola Oil Bio- | 5 | (1.6) | | | | | | |
| | Adjuvant “A” | | | | | | | | |
| 8 | Interface+ | 1 | (0.32) | 4.75 | ab | 4 | bc | 2 | |
| | Canola Oil Bio- | 1.4 | (0.45)^{d} | | | | | | |
| | Adjuvant “A” | | | | | | | | |
| 9 | Interface+ | 1 | (0.32) | 4.5 | a-c | 2.75 | ef | 1.25 | |
| | Canola Oil Bio- | 1.4 | (0.45)^{d} | | | | | | |
| | Adjuvant “B” | | | | | | | | |
| 10 | Interface+ | 1 | (0.32) | 4 | c-e | 4.5 | ab | 1.5 | |
| | Methylated | 1.1 | (0.35) | | | | | | |
| | Canola Oil Bio- | | | | | | | | |
| | Adjuvant “B” | | | | | | | | |
| 11 | Interface | 1 | (0.32) | 5 | a | 5 | a | 0.75 | |
| 12 | Interface | 3 | (0.96) | 5 | a | 4 | bc | 0 | |
| 13 | Banner Maxx+ | 0.38 | (0.12) | 3.5 | ef | 2.25 | f | 2 | |
| | Canola Oil Bio- | 5 | (1.6) | | | | | | |
| | Adjuvant “A” | | | | | | | | |
| 14 | Banner Maxx+ | 0.38 | (0.12) | 4.5 | a-c | 3.75 | b-d | 1.5 | |
| | Canola Oil Bio- | 1.4 | (0.45)^{d} | | | | | | |
| | Adjuvant “A” | | | | | | | | |
| 15 | Banner Maxx+ | 0.38 | (0.12) | 4.25 | b-d | 3 | d-f | 1 | |
| | Canola Oil Bio- | 1.4 | (0.45)^{d} | | | | | | |
| | Adjuvant “B” | | | | | | | | |
| 16 | Banner Maxx+ | 0.38 | (0.12) | 3.75 | d-f | 3.75 | b-d | 0.75 | |
| | Methylated | 1.1 | (0.35) | | | | | | |
| | Canola Oil Bio- | | | | | | | | |
| | Adjuvant “B” | | | | | | | | |
| 17 | Banner Maxx | 0.38 | (0.12) | 5 | a | 5 | a | 0.25 | |
| 18 | Banner Maxx | 1 | (0.32) | 4.75 | ab | 4 | be | 0 | |
| 19 | Emerald+ | 0.07 | (0.02) | 3.5 | ef | 2.75 | ef | 2 | |
| | Canola Oil Bio- | 5 | (1.6) | | | | | | |
| | Adjuvant “A” | | | | | | | | |
| 20 | Emerald+ | 0.07 | (0.02) | 4.75 | ab | 4.5 | ab | 3 | |
| | Canola Oil Bio- | 1.4 | (0.45)^{d} | | | | | | |
| | Adjuvant “A” | | | | | | | | |
| 21 | Emerald+ | 0.07 | (0.02) | 4.75 | ab | 3.75 | b-d | 1.5 | |
| | Canola Oil Bio- | 1.4 | (0.45)^{d} | | | | | | |
| | Adjuvant “B” | | | | | | | | |
| 22 | Emerald+ | 0.07 | (0.02) | 4 | c-e | 4.25 | a-c | 0.75 | |
| | Methylated | 1.1 | (0.35) | | | | | | |
| | Canola Oil Bio- | | | | | | | | |
| | Adjuvant “B” | | | | | | | | |
| 23 | Emerald | 0.07 | (0.02) | 5 | a | 5 | a | 2.5 | |
| 24 | Emerald | 0.13 | (0.04) | 5 | a | 5 | a | 0.5 | |
| 25 | Canola Oil Bio- | 1 | (0.32) | 4.75 | ab | 5 | a | 5 | |
| | Adjuvant “A” | | | | | | | | |
| 26 | Canola Oil Bio- | 5 | (1.6) | 3.5 | ef | 4 | be | 5 | |
| | Adjuvant “A” | | | | | | | | |
| 27 | Canola Oil Bio- | 1 | (0.32) | 4.25 | b-d | 4.5 | ab | 5 | |
| | Adjuvant “B” | | | | | | | | |
| 28 | Methylated | 1.1 | (0.35) | 3.75 | d-f | 5 | a | 4.75 | |
| | Canola Oil Bio- | | | | | | | | |
| | Adjuvant “B” | | | | | | | | |
| 29 | Untreated Control | | | 5 | a | 5 | a | 4 | |
| 30 | Interface+ | 1 | (0.32) | 4 | c-e | 4 | bc | 1.75 | |
| | Canola Oil Bio- | 0.5 | (0.16) | | | | | | |
| | Adjuvant “B” | | | | | | | | |
| 31 | Canola Oil Bio- | 0.5 | (0.16) | 4 | c-e | 4 | bc | 4.75 | |

Adjuvant “B”

^{a}Mean of 4 replicate plots. Means followed by the same letter are not significantly different from each other (P = 0.05, LSD).
^{b}Rate: fl. oz. /1000 sq. ft. unless stated in dry ounces (oz), every 14 days.
^{c}Dew and dollar spot fuzz rating scale: 1 = least, 5 = mos
^{d}Equals 1% v/v at spray volume of 48 GPA used in this study. [symbol]
indicates data missing or illegible when filed

### Example 15

### Fertility Effects on a Putting Green Turfgrass Treated with Canola Oil Bio-Adjuvant/Fertilizer Combinations, 2016

This fertility study was established on an irrigated putting green which was infected with dollar spot disease on the same research center as in the previous examples. The study was established in four replications of a randomized block design utilizing 2 ft.×21 ft. plots with 6 inch alleys. Treatments were initially applied on Sep. 13, 2016 with the same sprayer and under the same conditions described in Example 1. Turfgrass quality ratings and biomass ratings were performed as described in Example 1. The plots were trimmed on September 19, October 8, and Oct. 24, 2016 and clippings were also collected as described in Example 1.

Treatments were re-applied on Sep. 28, 2016 and Oct. 11, 2016. Turfgrass visual growth and quality ratings were taken periodically, along with turfgrass color ratings as taken with a Spectrum Technologies, Inc. TCM 500 NDVI Color Meter and a Spectrum Technologies, Inc. FieldScout CM 1000 Chlorophyll Meter. The study was irrigated as needed to prevent wilt. No background fertility was applied to the study area. The area was sprayed with 26GT fungicide on Sep. 27, 2016 to control dollar spot disease.

As the data in Table 23 indicates, most treatments significantly improved the turfgrass quality, compared to the untreated control, at 6 days after the initial treatment (Sep. 19, 2016). The exceptions were the low rate bio-adjuvant alone treatment (treatment #1) and the low rate urea alone treatment (treatment #5). The Oct. 1, 2016 rating was taken only 3 days after the second treatment application, when the green turfgrass pigment was still heavily present. At the time of this rating, all treatments, especially those with bio-adjuvant, had produced significantly better turfgrass quality than the untreated control. While even the lowest urea rate treatment (treatment #5) produced an acceptable turfgrass quality throughout this study, the addition of a low rate of bio-adjuvant (treatment #1) produced a significantly better turfgrass quality, compared to the low-rate urea alone (treatment 3). In fact, the low rate bio-adjuvant/urea combination (treatment #3) produced a significantly better turfgrass quality after the initial rating, than did the high rate urea treatment (treatment #4). This illustrates the efficacy of the bio-adjuvant in allowing for a reduction in fertilizer application rates, without a loss of turfgrass quality. The improved turfgrass quality in the bio-adjuvant treatments is attributable to the increased greenness, as well as the acceleration of new growth (versus the untreated control), which is evident in Table 24. As expected, the untreated control declined in quality throughout the course of the study.

Table 24 illustrates the visual growth acceleration that results from the application of the bio-adjuvant, whether alone, or in combination with urea. The effect is most dramatic at the high (1% v/v) application rate of bio-adjuvant. Even the lowest rate combination treatment (treatment #3), though, produced significantly more visual growth on two of three rating dates than the high rate urea alone application (treatment #4).

The turfgrass color (chlorophyll) rating of Oct. 25, 2016 (Table 25) suggests that chlorophyll levels can be increased significantly through the application of either urea or the bio-adjuvant, or both. This suggests that overall plant health is improved through bio-adjuvant application. A number of urea or bio-adjuvant treatments and urea/bio-adjuvant combinations produced significantly greener turf than the untreated control on earlier rating dates also.

Dew reduction (Table 25) is directly related to the amount of bio-adjuvant applied, specifically, the amount of canola oil in the treatment. Dew reduction is relevant to disease control because it can translate into reduced foliar disease pressure, and reduced frost accumulation. Significant dew reductions, versus the untreated control, were observed in all bio-adjuvant treatments on Sep. 15, 2016.

As the clipping data in Table 26 indicates, urea by itself, at either rate, did not promote significantly more clippings than the untreated control at six days after the initial application conducted on Sep. 13, 2016. However, when urea was combined with the bio-adjuvant, significantly more growth (clippings) had occurred in most combination treatments and in the high rate adjuvant treatment than in the untreated control. These observations are consistent with our results in previous bio-adjuvant/fertilizer studies. At the time of the Oct. 8, 2016 clipping collection, all treatments except the low rate urea treatment (treatment #5) and the low rate bio-adjuvant treatment (treatment #1), had produced significantly more clippings than the untreated control. By the time of the Oct. 24, 2016 clipping collection, all treatments except the low rate urea treatment (treatment 5) had produced significantly more clippings than the untreated control. Surprisingly, analysis of the cumulative 6-week clipping totals indicates that the fertilizer application rates can be reduced by 50% (treatments #3 and #6 compared to treatment #4), if the bio-adjuvant is combined at 0.5% to 1% v/v with the fertilizer at either rate. Alternatively, application of a full rate of bio-adjuvant alone (treatment #7) on a 14-day schedule can substitute for a 0.1 lb N/1000 sq. ft. application of urea (treatment #4) applied on a 14-day schedule in terms of visual turf growth (Table 23), turfgrass quality (Table 24), and total clipping production (Table 26).

TABLE 23
Visual Turfgrass Quality Ratings in Bio-Adjuvant/Fertility Study, 2016

| | | | Sept. 19 | | Oct. 1 | | Oct. 6 | |
|---|---|---|---|---|---|---|---|---|
| | | | (6 DAT^{c}) | | (3 DAT^{c}) | | (8 DAT^{c}) | |
| Trt. | | | MEAN^{b} | LSD^{a} | MEAN^{b} | LSD^{a} | MEAN^{b} | LSD^{a} |
| No. | Treatment Name | Rate^{f}/14 days | Quality | (.05) | Quality | (.05) | Quality | (.05) |
| 1 | Canola Oil | 0.5% V/V ^{d} | 7.0 | a-c | 7.8 | c | 7.0 | cd |
| | Bio-Adjuvant “B”^{c} | | | | | | | |
| 2 | Canola Oil | 0.5% V/V^{d} + | 7.3 | ab | 8.3 | b | 8.0 | b |
| | Bio-Adjuvant “B^{c}” + | 0.1 lb N/1000 sq. ft. | | | | | | |
| | Urea (46-0-0) | | | | | | | |
| 3 | Canola Oil | 0.5% V/V^{d} + | 7.5 | a | 8.0 | bc | 8.0 | b |
| | Bio-Adjuvant “B^{c}” + | 0.05 lb. N/1000 sq. ft. | | | | | | |
| | Urea (46-0-0) | | | | | | | |
| 4 | Urea (46-0-0) | 0.1 lb N/1000 sq. ft. | 7.3 | ab | 7.0 | d | 7.3 | cd |
| 5 | Urea (46-0-0) | 0.05 lb N/1000 sq. ft. | 6.8 | bc | 7.0 | d | 6.8 | d |
| 6 | Canola Oil | 1% V/V^{f} + | 7.5 | a | 7.8 | c | 7.5 | bc |
| | Bio-Adjuvant “B^{c}” + | 0.05 lb N/1000 sq. ft. | | | | | | |
| | Urea (46-0-0) | | | | | | | |
| 7 | Canola Oil | 1% V/V^{f} | 7.3 | ab | 8.0 | bc | 8.0 | b |
| | Bio-Adjuvant “B^{c}” | | | | | | | |
| 8 | Canola Oil | 1% V/V^{f} + | 7.5 | a | 9.0 | a | 8.8 | a |
| | Bio-Adjuvant “B^{c}” + | 0.1 lb N/1000 sq. ft. | | | | | | |
| | Urea (46-0-0) | | | | | | | |
| 9 | Untreated Control | | 6.5 | c | 6.3 | e | 6.0 | e |

^{a}Means (of 4 replicate plots) followed by the same letter are not significantly different (P = .05, LSD).
^{b}Visual turfgrass quality rating scale: 1-9 (1 = worst, 9 = best, 7 = acceptable).
^{c}Days after treatment.
^{d}Volume to volume (Same as 0.7 fl oz/1000 sq. ft.).
^{e}Food-grade canola oil + Foursome turfgrass pigment + Silwet L-77 surfactant (46.5%: 33%: 20.5%).
^{f}Volume to volume (same as 1.4 fl oz/1000 sq. ft.).

TABLE 24
Visual Turfgrass Growth Ratings in Bio-Adjuvant/Fertility Study, 2016

| | | | Sept. 19 | | Sept. 25 | | Oct. 6 | |
|---|---|---|---|---|---|---|---|---|
| Trt. | | | MEAN^{b} | LSD^{a} | MEAN^{b} | LSD^{a} | MEAN^{b} | LSD^{a} |
| No. | Treatment Name | Rate/14 days | Growth | (.05) | Growth | (.05) | Growth | (.05) |
| 1 | Canola Oil | 0.5% V/V^{c} | 2.8 | cd | 3.0 | bc | 2.3 | e |
| | Bio-Adjuvant “B”^{d} | | | | | | | |
| 2 | Canola Oil | 0.5% V/V + | 3.3 | a-c | 4.0 | ab | 3.8 | ab |
| | Bio-Adjuvant “B^{d}” + | 0.1 lb N/1000 sq. ft. | | | | | | |
| | Urea (46-0-0) | | | | | | | |
| 3 | Canola Oil | 0.5% V/V + | 3.3 | a-c | 3.8 | a-c | 3.8 | ab |
| | Bio-Adjuvant “B^{d}” + | 0.05 lb. N/1000 sq. ft. | | | | | | |
| | Urea (46-0-0) | | | | | | | |
| 4 | Urea (46-0-0) | 0.1 lb N/1000 sq. ft. | 2.5 | de | 3.8 | a-c | 2.5 | de |
| 5 | Urea (46-0-0) | 0.05 lb N/1000 sq. ft. | 2.8 | cd | 3.3 | bc | 2.3 | e |
| 6 | Canola Oil | 1% V/V^{e} + | 3.8 | a | 4.0 | ab | 3.0 | cd |
| | Bio-Adjuvant “B^{d}” + | 0.05 lb N/1000 sq. ft. | | | | | | |
| | Urea (46-0-0) | | | | | | | |
| 7 | Canola Oil | 1% V/V^{e} | 3.0 | b-d | 4.5 | a | 3.3 | bc |
| | Bio-Adjuvant “B^{d}” | | | | | | | |
| 8 | Canola Oil | 1% V/V^{e} + | 3.5 | ab | 4.5 | a | 4.0 | a |
| | Bio-Adjuvant “B^{d}” + | 0.1 lb N/1000 sq. ft. | | | | | | |
| | Urea (46-0-0) | | | | | | | |
| 9 | Untreated Control | — | 2.0 | e | 2.8 | c | 2.3 | e |

^{a}Means (of 4 replicate plots) followed by the same letter are not significantly different (P = .05, LSD).
^{b}Visual turfgrass growth scale: 1-5 (1 = least, 5 = most).
^{c}Volume to volume (same as 0.7 fl oz/1000 sq. ft.).
^{d}Food-grade canola oil + Foursome turfgrass pigment + Silwet L-77 surfactant (46.5%: 33%: 20.5).
^{e}Volume to volume (same as 1.4 fl oz/1000 sq. ft.).

TABLE 25
Turfgrass Color (Greenness) and Dew Ratings in Bio-Adjuvant/Fertility Study, 2016.

| | | | Sept. 16 | | Oct. 6 | | Oct. 25 | | Sept. 15 | |
|---|---|---|---|---|---|---|---|---|---|---|
| Trt. | | | MEAN | LSD^{a} | MEAN | LSD^{a} | MEAN | LSD^{a} | Mean^{f} | LSD^{a} |
| No. | Treatment Name | Rate/14 days | (Color)^{b} | (.05) | (Color)^{c} | (.05) | (Color)^{c} | (.05) | (Dew) | (.05) |
| 1 | Canola Oil | 0.5% V/V^{d} | 0.757 | ab | 356 | bc | 260.8 | c | 4.0 | b |
| | Bio-Adjuvant | | | | | | | | | |
| | “B”^{e} | | | | | | | | | |
| 2 | Canola Oil | 0.5% V/V + 0.1 lb | 0.763 | a | 375.8 | a | 279.3 | a | 4.0 | b |
| | Bio-Adjuvant “B” + | N/1000 sq ft. | | | | | | | | |
| | Urea (46-0-0) | | | | | | | | | |
| 3 | Canola Oil | 0.5% V/V + 0.05 lb. | 0.757 | ab | 363 | a-c | 270.5 | b | 4.0 | b |
| | Bio-Adjuvant “B” + | N/1000 sq. ft. | | | | | | | | |
| | Urea (46-0-0) | | | | | | | | | |
| 4 | Urea (46-0-0) | 0.1 lb N/1000 sq. ft. | 0.761 | a | 352.5 | bc | 272.3 | ab | 5.0 | a |
| 5 | Urea (46-0-0) | 0.05 lb N/1000 sq. ft. | 0.755 | ab | 352.3 | bc | 261 | c | 5.0 | a |
| 6 | Canola Oil | 1% V/V + | 0.760 | ab | 365.5 | ab | 267.3 | bc | 3.0 | c |
| | Bio-Adjuvant “B” + | 0.05 lb N/1000 sq. ft. | | | | | | | | |
| | Urea (46-0-0) | | | | | | | | | |
| 7 | Canola Oil | 1% V/V | 0.739 | c | 356.5 | bc | 262.5 | c | 3.0 | c |
| | Bio-Adjuvant “B” | | | | | | | | | |
| 8 | Canola Oil | 1% VN + | 0.762 | a | 376.3 | a | 279.8 | a | 3.0 | c |
| | Bio-Adjuvant “B” + | 0.1 lb N/1000 sq. ft. | | | | | | | | |
| | Urea (46-0-0) | | | | | | | | | |
| 9 | Untreated Control | — | 0.745 | bc | 349.5 | c | 250 | d | 5.0 | a |

^{a}Means (of four replicate plots) followed by the same letter are not significantly different (P = .05, LSD).
^{b}NDVI (normal distribution vegetatioin index) color (greenness) readings determined with a Spectrum Technologies, Inc. FieldScout TCM 500 NDVI Turf Color Meter.
^{c}Turfgrass color (greenness) readings determined with a Spectrum Technologies, Inc. FieldScout CM 1000 Chlorophyll Meter.
^{d}Volume to volume (same as 0.7 fl oz/1000 sq. ft.).
^{e}Food-grade canola oil + Foursome turfgrass pigment + Silwet L-77 surfactant (46.5%: 33%: 20.5%)
^{f}Dew visual rating scale: 1 = least, -5 = most

TABLE 26
Dried Clipping Weights (gms) on Various Collection Dates in Bio-Adjuvant/Fertility Study, 2016.

| | | | | | | | | | All Clippings | |
|---|---|---|---|---|---|---|---|---|---|---|
| | | | | | | | | | (Dried) | |
| | | | | | | | | | (Sept 19- | |
| | | | Sept. 19 | | Oct. 8 | | Oct. 24 | | Oct. 24) | |
| Application Interval-14 Days | | | Mean^{b} | | Mean^{b} | | Mean^{b} | | Mean^{b} | |
| Trt. | Treatment | | Clipping | LSD^{a} | Clipping | LSD^{a} | Clipping | LSD^{a} | Total | LSD^{a} |
| No. | Name | Rate | Weight | (0.1) | Weight | (0.1) | Weight | (0.1) | Clippings | (0.1) |
| 1 | Bio-Adjuvant | 0.5% V/V^{e} | 70^{c} | bc | 59.5^{c} | cd | 48.3^{c} | de | 177.8 | d-f |
| | “B^{d}” | | | | | | | | | |
| 2 | Bio-Adjuvant | 0.5% V/V + | 71.3 | a-c | 65.8 | b | 60 | a | 197.0 | b |
| | “B” + Urea | 0.1 lb N/1000 sq. ft. | | | | | | | | |
| 3 | Bio-Adjuvant | 0.5% V/V + | 72.8 | ab | 62.5 | bc | 53 | c | 188.3 | c |
| | “B” + Urea | 0.05 lb. N/1000 sq. ft. | | | | | | | | |
| 4 | Urea | 0.1 lb N/1000 sq. ft. | 71.5 | a-c | 62.5 | bc | 55.8 | b | 189.8 | bc |
| 5 | Urea | 0.05 lb N/1000 sq. ft. | 71.3 | a-c | 59.5 | cd | 46.5 | ef | 177.3 | ef |
| 6 | Adjuvant | 1% V/V + | 72.5 | ab | 62 | bc | 50.8 | cd | 185.3 | c-e |
| | “B” + Urea | 0.05 lb N/1000 sq. ft. | | | | | | | | |
| 7 | Bio-Adjuvant | 1% V/V | 73.5 | a | 62.5 | bc | 49.5 | d | 185.5 | cd |
| | “B” | | | | | | | | | |
| 8 | Bio-Adjuvant | 1% V/V + | 74.3 | a | 70.3 | a | 61.3 | a | 205.8 | a |
| | “B” + Urea | 0.1 lb N/1000 sq. ft. | | | | | | | | |
| 9 | Untreated | — | 69 | c | 58 | d | 45.5 | f | 172.5 | f |
| | Control | | | | | | | | | |

^{a}Means followed by the same letter are not significantly different (P = 0.1, LSD).
^{b}Mean of four replicate plots.
^{c}Dried clipping weights (gms).
^{d}Food-grade canola oil + Foursome turfgrass pigment + Silwet L-77 surfactant (46.5%: 33%: 20.5%)
^{e}volume to volume (same as 0.7 fl oz/1000 sq. ft.

### Example 16 (Prophetic)

Additional testing will be performed on other plant oil concentrates including various vegetable oils, such as soybean oil. It is expected that the results will be at least comparable to the results described herein.

### Example 17 (Prophetic)

Future research of crop treatment concentrates and products using canola oil as the plant oil in the biorational treatment concentrate and product will be performed in various formulations with commercially available active ingredients for a variety of uses. This research will include optimization of the proportions of the various components in the biorational treatment concentrate and product, such as, for example, canola oil, pigment and surfactant. Optimization of the amount of crop treatment concentrate applied per 1000 sq. ft. (93 m²) of a target crop, such as turfgrass, will also be performed.

### Example 18 (Prophetic)

Additional testing will include using different types of delivery, including applying the biorational treatment concentrate alone or as part of a crop treatment product foliarly or in diluted form, by drenching the soil column of the target crop, which may include agricultural crops, such as corn and wheat. Such testing may show that it is possible that the frequency or rate of application can be reduced as compared to current practices for various commercially available active ingredients, such as UAN 28-0-0 brand fertilizer. This fertilizer is typically spoon-fed on a weekly/biweekly basis through irrigation, such as with a center pivot irrigation system.

The various embodiments described herein provide a new paradigm in crop maintenance, such as turfgrass maintenance. The biorational concentrates and products described herein provide a number of benefits, including, but not limited to, increased plant biomass, improved active ingredient efficacy, such as improved fungicide and fertilizer efficacy, canopy moisture, dew and frost suppression and dormancy breaking in cultivated crops, such as turfgrasses.

In one embodiment, a canola oil-containing product or a canola oil concentrate, when applied to turfgrass together with an active ingredient, such as a fungicide, allows for significantly reduced amounts of fungicide to be used (e.g., up to 75%). Such results support the EPA long-term goals of reducing nitrogen fertilizer and pesticide inputs into the environment. It is likely that the immediate biomass increase surge (visibly) and dry weight increase is reproducible in plant species other than turfgrass. As such, it may be possible to increase crop yields without additional inputs of fertilizer, pesticides, and the like. Reduced fertilizer inputs can protect ground water and may reduce the cost of turfgrass maintenance and crop production in general. Reduced fungicide inputs can reduce the public and environmental exposure to pesticides while also reducing the cost of turfgrass maintenance and crop production. Improved fungicide efficacy can also help turf managers remain within the tight seasonal use limits which the EPA has imposed on various fungicides, such as chlorothalonil and tebuconazole.

In one embodiment, when the biorational concentrate is used as a bio-adjuvant with a conventional active ingredient, such as fertilizer, and applied to turfgrass in a single application, a biomass increase surge occurs. In some embodiments, the biomass increase surge, which may be visible within 24 hours (such as within 22 hrs, 20 hrs or lower, such as down to 18 hrs), appears to be directly correlated, at least in part, to the amount of biorational concentrate used. The biomass increase surge is also long-lived (i.e., lasts at least 1 week, up to 4 weeks, and may last up to 6 to 8 weeks, or more such as up to four to five months following a treatment (including under snow), such as a late Fall treatment to dormant turf, depending on many factors, including the precise formulation used, biomass increase rate of the target crop, rate of application, number of applications, time of year applied, and the like).

In one embodiment, additional benefits may include, but are not limited to, an accelerated rate of turfgrass biomass increase (such as an increase of at least 18% or more, such as at least 35% or more, such as up to 60%, based on dry weight (See, e.g., Table 3) as compared to use of a conventional active ingredient alone and/or improved quality of turfgrass (as is evidenced by color intensity, growth rate and density) as compared to a conventional active ingredient. Each of these benefits can also be present for weeks, such as up to 4 weeks, 5 weeks, 6 weeks or more, such as up to 3-4 months, following a single application, with intensity and duration varying, depending on at least the various factors noted above.

In some embodiments, a reduced amount of fertilizer, as compared with the recommended label amount, can be used. When applied in formulation with fertilizers, in one embodiment, fertilizer rates are reduced significantly (i.e., such as up to 50% or more, such as up to 75%) and/or applications of fertilizer only can possibly be alternated with applications of the crop treatment concentrates and products described herein, with no apparent loss of density, biomass increase rate, or turfgrass quality. In one embodiment, and surprisingly, when the crop treatment concentrate or product is delivered to dormant, non-growing turfgrass, a biomass increase surge can occur. In one embodiment, the biomass increase rate is evident long after the concentrate or product is applied, such as up to 4 months or 5 months later, even if the turfgrass is snow covered for part or all of the dormancy period.

In one embodiment, a canola oil concentrate is formulated and sold as a stand-alone treatment product in the turfgrass market (with turf dye) and outside of the turfgrass market (optionally, without turf pigment) as a tank-mix partner for fungicides, plant growth regulators, fertilizers, etc. Use of canola oil has the additional benefit of being economical.

In one embodiment, when the biorational treatment concentrate is used as a bio-adjuvant in formulation with a fungicide and applied to turfgrass, various off-label uses are possible. In one embodiment, the amount and/or rate of fungicide used can be reduced, such as by up to 75%, while still providing a comparable level of disease control typically achieved with the full label amount and/or rate. In one embodiment, the biorational treatment concentrate allows the fungicide to be used off-label by causing the fungicide to adequately control diseases that it would otherwise not adequately control.

In other embodiments, the biorational treatment concentrate is used as a biorational ingredient, such as a biostimulant, as discussed herein.

In various embodiments, the crop treatment concentrates and products discussed herein, exhibit no phytotoxicity or other adverse crop effects, including in hot conditions, such as temperatures over 90° F. (36.7° C.). In one embodiment, the biorational concentrate or product causes no phytotoxicity. This includes, but is not limited to, canola oil, which may be applied, in some embodiments, in the summer months or otherwise in warm climates.

In various embodiments, biomass increase stimulation is also useful for advancing dormancy break and alleviating winter desiccation in crops, such as turfgrasses, in the late winter/early spring, when soils are still cold and turfgrasses are not yet growing.

In one embodiment, a canola oil concentrate or product, with or without fertilizer, stimulates late winter/early spring turfgrass biomass increase, thus pushing the turf out of the typical late winter dessication (browning) and dormancy that is esthetically undesirable on golf courses. Such an advantage is also likely useful in other over-wintering crops, such as winter wheat. Additionally, in one embodiment, late fall applications of a canola oil-containing treatment concentrate or product can promote significant (e.g., up to an additional 25% or more) winter turfgrass biomass increase under snow cover. (In various embodiments, the additional biomass increase may be from about 1% to about 35% mean value). The same effect may be possible in winter wheat cultivation, giving fall-treated plants a head start in the spring, without the environmental impact of late fall fertility or the need to apply early spring fertility when fields are wet.

In one embodiment, a composition is provided comprising an effective treatment amount of a biorational treatment concentrate comprising one or more plant oils (e.g., canola oil, neem oil and combinations thereof) and/or glycerol in combination with a carrier (e.g., water), and one or more colorants and/or one or more active ingredients, wherein the composition is formulated to treat a target crop (e.g., grass, trees, bushes and flowers).

In one embodiment, the biorational treatment product further comprises a surfactant.

In one embodiment, the grass is turfgrass and the pigment is a copper phthalocyanine or a chlorinated copper phthalocyanine.

In one embodiment, the concentrate, composition or biorational treatment product contains at least some methylated plant oil, such as methylated canola oil. In one embodiment, only methylated canola oil is used as the plant oil. In embodiments in which surfactant is used in the concentrate or composition, the amount is no more than 0.5 vol % of surfactant, such as no more than 0.4 vol %, such as no more than 0.3 vol %, such as no more than 0.2 vol %, such as no more than 0.1 vol %.

In one embodiment, the composition comprises from about 10 to about 95 vol % canola oil (such as from about 40 to about 95 vol %), about 1 to about 90 vol % pigment (such as from about 4.2 to about 5 vol %) and about 0.1 to about 25 vol % surfactant (such as from about 2.5 to about 3.3 vol %). In one embodiment, the composition contains from about 40 to about 95 vol %, such as from about 40 to about 95 vol % (such as from about 40 to about 93 vol %), about 1 to about 50 vol % pigment (such as about 3 to about 50 vol %), and about 0.1% to about 25% surfactant. In one embodiment, the composition contains from about 58 to about 93% canola oil, about 3.7 to about 41.7% pigment and about 0.25 to about 20.5% surfactant. In one embodiment, the composition comprises a canola oil, pigment and surfactant in a 1% v/v carrier solution. In one embodiment, a ratio of oil:pigment is at least or no more than 1:1, together with a surfactant amount of from about 0.1 to about 0.9, such as from about 0.1 to about 0.7, such as from about 0.3 to about 0.6, such as at least about 0.5.

In one embodiment, the one or more plant oils is canola oil, the one or more colorants is a pigment and the concentrate further comprises a surfactant. In one embodiment, the concentrate contains about 10 to about 95 vol % canola oil (such as from about 40 to about 95 vol %), about 1 to about 90 vol % pigment (such as from about 4.2 to about 5 vol %) and about 0.1 to about 25 vol % surfactant (such as from about 2.5 to about 3.3 vol %). In one embodiment, the concentrate contains from about 40 to about 95 vol % canola oil (such as from about 40 to about 93 vol %), about 1 to about 50 vol % pigment (such as about 3 to about 50 vol %), and about 0.1% to about 25 vol % surfactant. In one embodiment, the concentrate contains from about 58 to about 93 vol % canola oil, about 3.7 to about 41.7 vol % pigment and about 0.25 to about 20.5 vol % surfactant.

In various embodiments, the biorational treatment concentrate is a biorational ingredient adapted to control, prevent and/or eliminate diseases and/or canopy wetness and/or repel, control and/or eliminate target pests in the target crop. The biorational treatment concentrate can be used as a bio-adjuvant and formulated with an off-label amount of an active ingredient. In one embodiment, the active ingredient is present in an amount of up to 75% less than an amount present when no bio-adjuvant is present. In one embodiment, the off-label amount comprises up to 75% less than a full label amount.

The active ingredient (e.g., fertilizer, fungicide or combination thereof) can, in various embodiments, be adapted to treat different adverse target crop conditions, as compared to adverse target crop conditions treatable when no bio-adjuvant is present.

In one embodiment, the active ingredient is selected from one or more fertilizers, fungicides, pesticides, frost prevention aids, plant defense boosters, and combinations thereof.

In one embodiment, the fertilizer comprises a urea fertilizer. The fungicide can comprise, for example, one or more fungicides selected from a systemic carboxamide, a local penetrant, a succinate dehydrogenase inhibitor (SDHI) (e.g., boscolid), a sterol biosynthesis inhibitor (SBIs), a sterol biosynthesis inhibitor (SBIs), and combinations thereof. In one embodiment, the systemic carboxamide is a strobilurin selected from pyraclostrobin and trifloxystrobin and the SBI is a demethylation inhibitor (DMI) selected from propaconazole, tebuconazole and imidazoles, a dicarboximide or a chloronitrile.

In one embodiment, the active ingredient is selected from one or more herbicides, plant growth regulators, phosphites, insecticides, nematicides, and combinations thereof.

In one embodiment, the active ingredient may be selected from one or more molluscicides, rotenticides, antidessicants, dessicants, antitranspirants, inoculants, UV protectants, antioxidants, leaf polishes, pigmentation stimulants, pigmentation inhibitor,s animal repellents, bird repellents, arthropod repellents, moisture retention aids, humic acids, humates, lignins, lignates, bitter flavorants, irritants, malodorous ingredients, defoliants, chemosterilants, plant defense boosters, stress reduction compounds, and combinations thereof.

The biorational treatment concentrate can, in various embodiments, be adapted to control, prevent and/or eliminate diseases and/or canopy wetness and/or frost and/or repel, control and/or eliminate target pests in the target crop. In one embodiment, the bio-active treatment concentrate is a biostimulant and the treatment stimulates crop qualities, maintains crop qualities, enhances crop qualities (e.g., growth, density, and color intensity), regulates crop biomass or rooting increase and/or controls diseases.

In one embodiment, a method of treating a target crop is also provided, comprising delivering an effective treatment amount of a biorational treatment concentrate to a target crop, wherein the biorational treatment concentrate comprises one or more types of plant oils and/or glycerol; and a colorant and/or an active ingredient, wherein the composition is formulated to treat a target crop.

In one embodiment, prior to the delivering step, the biorational treatment concentrate is combined with a carrier to produce a biorational treatment product.

In one embodiment, the biorational treatment concentrate is applied to the target crop in the carrier at a rate of from about 1 ounce (oz.) (0.03 L) to about 35 oz. (1.04 L) per 1000 square feet (sq. ft.) (92.9 m²). In one embodiment, the treatment controls, prevents and/or eliminates diseases (e.g., dollar spot) and/or canopy wetness (e.g., dew) and/or frost and/or repels, controls and/or eliminates pests and/or stimulates, maintains, enhances and regulates crop qualities.

In one embodiment, the biorational treatment concentrate is a bio-adjuvant w combined with an off-label amount of an active ingredient to produce a product. In one embodiment, the off-label amount is a below-label amount and the method further comprises using the product to treat an off-label disease.

In one embodiment, the target crop experiences biomass increase during a growing season and biorational treatment concentrate is applied before the growing season.

The biorational treatment concentrate can be applied at various temperatures, including, for example, at temperatures ranging from about 32° F. (0° C.) to about 98° F. (36.7° C.).

In one embodiment, the biorational treatment concentrate is a dollar spot controller or a fertilizer and the target crop exhibits visual improvement within 24 hours. In one embodiment, the treatment is effective for up to five months.

In one embodiment a product is provided comprising a biorational treatment concentrate containing about 90 to about 99 vol % of one or more plant oils (e.g., neem oil, canola oil or a combination thereof) and/or glycerol and about 1 to about 9 vol % of one or more colorants.

In one embodiment, the one or more plant oils is canola oil, the one or more colorants is a pigment and the concentrate further comprises a surfactant. In one embodiment, the concentrate contains about 1 to about 95 vol % canola oil (such as about 40 to about 93 vol %), about 1 to about 90% pigment (such as from about 4.2 to about 5 vol %) and about 0.1 to about 25 vol % surfactant (such as from about 2.5 to about 3.3 vol %) In one embodiment, the concentrate contains from about 40 to about 95 vol % canola oil (such as from about 40 to about 93 vol %), about 1 to about 50 vol % pigment (such as about 3 to about 50 vol %), and about 0.1% to about 25% surfactant. In one embodiment, the concentrate contains from about 58 to about 93% canola oil, about 3.7 to about 41.7% pigment and about 0.25 to about 20.5% surfactant.

As the various examples show, visual biomass ratings indicated an unexpected, statistically significant biomass increase (increased or accelerated individual plant gro0077.th rate and overall plant density improvement) when the canola oil concentrate was used as a bio-adjuvant with the tested fungicides other than Enclave and Daconil Weatherstik. This observation was supported with statistically significant clipping (biomass) dry weight increases when the tank-mixes included Daconil Action, Insignia SC, and Torque. This biomass increase appears also to be due to improved disease control.

Although specific embodiments have been illustrated and described herein, any arrangement that achieve the same purpose, structure, or function may be substituted for the specific embodiments shown. For example, although the various embodiments have been described for use in turfgrass, it is also expected that the increased biomass and improved active ingredient efficacy observed following treatment can be duplicated in other agricultural and horticultural crops, especially other grasses (monocots), such as corn and wheat, as well as ornamental crops, and so forth. As such, it may be possible to increase crop production with use of the various biorational treatment products described herein, without increasing fertilizer and pesticide input. Additionally, although the various embodiments included use of pigments, use of paints and/or dyes are also expected to provide at least comparable results. This application is intended to cover any adaptations or variations of the embodiments of the invention described herein, and these and other embodiments are within the scope of the following claims and their equivalents.

What is claimed is:

1. A product comprising:
a biorational treatment concentrate containing about 10 to about 95 vol % of one or more plant oils and/or glycerol and about 1 to about 90 vol % of one or more colorants.

2. The product of claim 1 wherein the one or more plant oils comprises neem oil, canola oil, or a combination thereof, the one or more colorants is a pigment and the concentrate further comprises a surfactant, wherein the concentrate contains about 40 to about 95 vol % canola oil, about 3 to about 50 vol % pigment and about 0.1 to about 25 vol % surfactant.

3. The product of claim 2 wherein the one or more plant oils comprises canola oil.

4. The product of claim 3 wherein at least a portion up to all of the canola oil is methylated canola oil and the concentrate contains no more than 0.5 vol % surfactant.

5. A composition comprising:
an effective treatment amount of a biorational treatment concentrate comprising one or more plant oils and/or glycerol in combination with a carrier, and one or more colorants and/or one or more active ingredients, wherein the composition is formulated to treat a target crop.

6. The composition of claim 5 wherein the plant oil is selected from canola oil, neem oil and combinations thereof.

7. The composition of claim 5 wherein the one or more plant oils comprise canola oil and the target crop is selected from grass, trees, bushes and flowers.

8. The composition of claim 7 wherein at least a portion up to all of the canola oil is methylated canola oil and the concentrate contains no more than 0.5 vol % surfactant.

9. The composition of claim 7 wherein the biorational treatment product further comprises a surfactant and the carrier is water.

10. The composition of claim 9 wherein the grass is turfgrass and the pigment is a copper phthalocyanine or a chlorinated copper phthalocyanine.

11. The composition of claim 9 comprising about 40 to about 95 vol % canola oil, about 1 to about 50 vol % pigment and about 0.1 to about 25 vol % surfactant.

12. The composition of claim 5 wherein the biorational treatment concentrate is a biorational ingredient adapted to repel, control, prevent and/or eliminate target pests and/or canopy wetness and/or frost in the target crop.

13. The composition of claim 5 wherein the biorational treatment concentrate is a bio-adjuvant formulated with an off-label amount of an active ingredient.

14. The composition of claim 13 wherein the off-label amount comprises up to 75% less than a full label amount.

15. The composition of claim 13 wherein the active ingredient is adapted to treat different adverse target crop conditions as compared to adverse target crop conditions treatable when no bio-adjuvant is present.

16. The composition of claim 15 wherein the active ingredient is selected from one or more fertilizers, fungicides, pesticides, frost prevention aids, plant defense boosters, and combinations thereof.

17. The composition of claim 16 wherein the fungicide is one or more fungicides selected from a systemic carboxamide, a local penetrant, a succinate dehydrogenase inhibitor (SDHI), a sterol biosynthesis inhibitor (SBIs), and combinations thereof.

18. The composition of claim 17 wherein the systemic carboxamide is a strobilurin selected from pyraclostrobin and trifloxystrobin and the SBI is a demethylation inhibitor (DMI) selected from propaconazole, tebuconazole and imidazoles, a dicarboximide or a chloronitrile.

19. The composition of claim 18 wherein the fertilizer comprises a urea fertilizer.

20. The composition of claim 19 wherein the bio-active treatment concentrate is a biostimulant and the treatment stimulates crop qualities, maintains crop qualities, enhances crop qualities, regulates crop biomass and rooting increase and/or controls diseases.

21. The composition of claim 20 wherein the crop qualities include growth rate, density, rooting, and color intensity.

22. The composition of claim 15 wherein the active ingredient is selected from one or more herbicides, plant growth regulators, phosphites, insecticides, nematicides, and combinations thereof.

23. A method of treating a target crop comprising:
delivering an effective treatment amount of a biorational treatment concentrate comprising one or more plant oils and/or glycerol in combination with a carrier, and one or more colorants and/or one or more active ingredients, wherein the composition is formulated to treat a target crop.

24. The method of claim 23 wherein, prior to the delivering step, the biorational treatment concentrate is combined with a carrier to produce a biorational treatment product.

25. The method of any claim 24 wherein the treatment controls, prevents and/or eliminates diseases and/or canopy wetness and/or frost and/or repels, controls and/or eliminates pests and/or stimulates, maintains, enhances and regulates crop qualities.

26. The method of claim 25 wherein the disease is dollar spot and the canopy moisture is dew.

27. The method of claim 23 wherein the biorational treatment concentrate is applied to the target crop in the carrier at a rate of from about 0.01 ounce (oz.) (0.003 L) to about 35 oz. (1.04 L) per 1000 square feet (sq. ft.) (92.9 m²).

28. The method of claim 23 wherein the biorational treatment concentrate wherein the concentrate is a bio-adjuvant which is combined with an off-label amount of an active ingredient to produce a product.

29. The method of claim 28 wherein the off-label amount is a below-label amount and the method further comprises using the product to treat an off-label disease.

30. The method of claim 29 wherein the active ingredient is a fertilizer, a fungicide or a combination thereof.

31. The method of claim 23 wherein the target crop experiences growth during a growing season and the biorational treatment concentrate is applied before the growing season.

32. The method of claim 23 wherein the biorational treatment concentrate is applied at temperatures ranging from about 32° F. (0° C.) to about 98° F. (36.7° C.).

33. The method of claim 23 wherein the biorational treatment concentrate is a dollar spot controller or a fertilizer and the target crop exhibits visual improvement within 24 hours.

34. The method of claim 23 wherein the treatment is effective for up to five months.
